(19) United States
(12) Patent Application Publication
(10) Pub. No.: US 2025/0261123 A1
(43) Pub. Date: Aug. 14, 2025

(54) METHOD AND APPARATUS FOR TRANSMISSION AND RECEPTION OF DOWNLINK CONTROL CHANNEL FOR POWER CONTROL IN NETWORK COOPERATIVE COMMUNICATION SYSTEMS

(71) Applicant: Samsung Electronics Co., Ltd., Suwon-si (KR)

(72) Inventors: Youngrok JANG, Suwon-si (KR); Seongmok LIM, Suwon-si (KR); Hyoungju JI, Suwon-si (KR)

(21) Appl. No.: 19/047,143

(22) Filed: Feb. 6, 2025

(30) Foreign Application Priority Data
Feb. 8, 2024 (KR) 10-2024-0019663
Mar. 29, 2024 (KR) 10-2024-0043506

(51) Int. Cl. H04W 52/14; H04W 52/08

(52) U.S. Cl. CPC H04W 52/143; H04W 52/08

(57) ABSTRACT

A method performed by a terminal in a wireless communication system is provided. The method includes receiving, from a base station, first information indicating a starting bit position of a block within downlink control information (DCI) for a transmission of a group of transmit power control (TPC) commands for a sounding reference signal (SRS), the first information indicating one of integers from 1 to 45, receiving, from the base station, the DCI, identifying a TPC command in the block corresponding to the starting bit position, determining a transmission power for the SRS based on the identified TPC command, and transmitting, to the base station, the SRS based on the transmission power.

### CROSS-REFERENCE TO RELATED APPLICATION(S)

This application is based on and claims priority under 35 U.S.C. § 119 (a) of a Korean patent application number 10-2024-0019663, filed on Feb. 8, 2024, in the Korean Intellectual Property Office, and of a Korean patent application number 10-2024-0043506, filed on Mar. 29, 2024, in the Korean Intellectual Property Office, the disclosure each of which is incorporated by reference herein in its entirety.

### BACKGROUND

### 1. Field

The disclosure relates to operations of a terminal and a base station in a wireless communication system. More particularly, the disclosure relates to a method for transmission and reception of a downlink control channel for power control in network cooperative communication systems and an apparatus capable of performing the same.

### 2. Description of Related Art

5th generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as millimeter wave (mmWave) including 28 GHz and 39 GHZ. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical (PHY) layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method capable of effectively providing services in a mobile communication system.

Another aspect of the disclosure is to provide a method and device for determining parameters associated with determining uplink transmission power in a wireless communication system.

Another aspect of the disclosure is to provide a method and device for interpreting information in downlink control information (DCI) in a wireless communication system.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving, from a base station, first information indicating a starting bit position of a block within downlink control information (DCI) for a transmission of a group of transmit power control (TPC) commands for a sounding reference signal (SRS), the first information indicating one of integers from 1 to 45, receiving, from the base station, the DCI, identifying a TPC command in the block corresponding to the starting bit position, determining a transmission power for the SRS based on the identified TPC command, and transmitting, to the base station, the SRS based on the transmission power.

In accordance with another aspect of the disclosure, a method performed by a base station in a wireless communication system is provided. The method includes transmitting, to a terminal, first information indicating a starting bit position of a block within downlink control information (DCI) for a transmission of a group of transmit power control (TPC) commands for a sounding reference signal (SRS), the first information indicating one of integers from 1 to 45, transmitting, to the terminal, the DCI, and receiving, from the terminal, the SRS based on a transmission power, wherein the transmission power for the SRS is based on a TPC command in the block corresponding to the starting bit position.

In accordance with another aspect of the disclosure, a terminal in a wireless communication system is provided. The terminal includes a transceiver and a controller operably connected to the transceiver and configured to receive, from a base station, first information indicating a starting bit position of a block within downlink control information (DCI) for a transmission of a group of transmit power control (TPC) commands for a sounding reference signal (SRS), the first information indicating one of integers from 1 to 45, receive, from the base station, the DCI, identify a TPC command in the block corresponding to the starting bit position, determine a transmission power for the SRS based on the identified TPC command, and transmit, to the base station, the SRS based on the transmission power.

In accordance with another aspect of the disclosure, a base station in a wireless communication system is provided. The base station includes a transceiver and a controller operably connected to the transceiver and configured to transmit, to a terminal, first information indicating a starting bit position of a block within downlink control information (DCI) for a transmission of a group of transmit power control (TPC) commands for a sounding reference signal (SRS), the first information indicating one of integers from 1 to 45, transmit, to the terminal, the DCI, and receive, from the terminal, the SRS based on a transmission power, wherein the transmission power for the SRS is based on a TPC command in the block corresponding to the starting bit position.

According to an embodiment of the disclosure, it is possible to effectively provide services in a mobile communication system.

According to an embodiment of the disclosure, when the number of bits of DCI format 2_3 is extended, it is possible to determine how to interpret the DCI format 2_3 field.

Further, according to an embodiment of the disclosure, it is possible to configure and/or determine parameters required for determining uplink transmission power, and to efficiently determine uplink transmission power.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of a bandwidth part configuration in a wireless communication system according to an embodiment of the disclosure;

FIG. 4 illustrates radio protocol structures of a base station and a UE in single cell, carrier aggregation, and dual connectivity situations in a wireless communication system according to an embodiment of the disclosure;

FIG. 5 illustrates a beam application time which may be considered in a case where a unified transmission configuration indication (TCI) scheme is used in a wireless communication system according to an embodiment of the disclosure;

FIG. 6 illustrates another medium access control-control element (MAC-CE) structure for activation and indication of a joint TCI state or a separate downlink (DL) or uplink (UL) TCI state in a wireless communication system according to an embodiment of the disclosure;

FIG. 7 illustrates an example of a control resource set configuration of a downlink control channel in a wireless communication system according to an embodiment of the disclosure;

FIG. 8 illustrates a structure of a downlink control channel in a wireless communication system according to an embodiment of the disclosure;

FIG. 9 is a diagram illustrating an example of SRS carrier switching according to an embodiment of the disclosure;

FIG. 10 illustrates a process for beam configuration and activation of a physical downlink shared channel (PDSCH) according to an embodiment of the disclosure;

FIG. 11 is a diagram illustrating an example of antenna port configuration and resource allocation for cooperative communication in the wireless communication system according to an embodiment of the disclosure;

FIG. 12 is a diagram illustrating an example of a downlink control information (DCI) configuration for cooperative communication in the wireless communication system according to an embodiment of the disclosure;

FIG. 13 is a diagram illustrating an enhanced PDSCH TCI state activation/deactivation MAC-CE structure according to an embodiment of the disclosure;

FIG. 14 is a diagram illustrating an example of operations of a base station and a UE operating in multi-transmission and reception point (TRP), including a TRP supporting only an uplink reception function, according to an embodiment of the disclosure;

FIG. 15 is a diagram illustrating a method for calculating and updating a path loss difference value according to an embodiment of the disclosure;

FIG. 16 is a diagram illustrating a method for calculating and updating a path loss difference value according to an embodiment of the disclosure;

FIG. 17 is a diagram illustrating an operation of a UE for uplink the transmission power control according to an embodiment of the disclosure;

FIG. 18 is a diagram illustrating an operation of a base station for uplink the transmission power control according to an embodiment of the disclosure;

FIG. 19 is a diagram illustrating a case where DCI format 2_3 is interpreted as typeA, according to an embodiment of the disclosure;

FIGS. 20A, 20B, and 20C are diagrams illustrating a method for interpreting corresponding DCI according to higher layer signaling configured for a UE in case where the DCI format 2_3 is interpreted as the typeA, according to various embodiments of the disclosure;

FIG. 21 is a diagram illustrating a case where the DCI format 2_3 is interpreted as typeB, according to an embodiment of the disclosure;

FIG. 22 is a diagram illustrating the method for interpreting corresponding DCI according to higher layer signaling configured for a UE in case where the DCI format 2_3 is interpreted as the typeB, according to an embodiment of the disclosure;

FIG. 23A is a diagram illustrating examples in which a closed loop power control index field may be included within the DCI format 2_3, according to an embodiment of the disclosure;

FIG. 23B is a diagram illustrating examples in which the closed loop power control index field may be included within the DCI format 2_3, according to an embodiment of the disclosure;

FIG. 24 is a diagram illustrating an operation of a UE for the transmission power control of SRS, according to an embodiment of the disclosure;

FIG. 25 is a diagram illustrating an operation of a base station for the transmission power control of SRS, according to an embodiment of the disclosure;

FIG. 26 is a diagram illustrating a structure of the UE in the wireless communication system according to an embodiment of the disclosure; and

FIG. 27 is a diagram illustrating a structure of the base station in the wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Further, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink” refers to a radio link via which a base station transmits a signal to a terminal, and an “uplink” refers to a radio link via which a terminal transmits a signal to a base station.

In the following description of embodiments of the disclosure, a 5G system will be described by way of example, but the embodiments of the disclosure may also be applied to other communication systems having similar technical backgrounds or channel types. Examples of such communication systems may include long-term evolution (LTE) or LTE-advanced (LTE-A) mobile communication systems and mobile communication technologies developed beyond 5G. In addition, based on determinations by those skilled in the art, the disclosure may also be applied to other communication systems through some modifications without significantly departing from the scope of the disclosure. The contents of the disclosure may be applied to frequency division duplex (FDD) and time division duplex (TDD) systems.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Further, the “unit” in the embodiments may include one or more processors.

A wireless communication system has developed into a broadband wireless communication system that provides a high-speed and high-quality packet data service according to communication standards such as high-speed packet access (HSPA) of 3rd generation partnership project (3GPP), long-term evolution (LTE) or evolved universal terrestrial radio access (E-UTRA), LTE-advanced (LTE-A), LTE-Pro, high rate packet data (HRPD) of 3GPP2, ultra mobile broadband (UMB), and 802.16e of IEEE beyond the initially provided voice-based service.

An LTE system, which is a representative example of the broadband wireless communication system, employs an orthogonal frequency division multiplexing (OFDM) scheme for a downlink (DL), and employs a single carrier frequency division multiple access (SC-FDMA) scheme for an uplink (UL). The uplink is a radio link through which a user equipment (UE) (or a mobile station (MS)) transmits data or a control signal to a base station (BS) (or an eNode B), and the downlink is a radio link through which the BS transmits data or a control signal to the UE. In the multiple access schemes as described above, time-frequency resources for carrying data or control information are allocated and operated in a manner to prevent overlapping of the resources, that is, to establish the orthogonality, between users, so as to identify data or control information of each user.

A post-LTE communication system, that is, a 5G communication system, should be able to freely reflect various requirements of a user and a service provider, and thus it is required to support a service which satisfies the various requirements. Services which are considered for the 5G communication system include enhanced Mobile Broadband (eMBB), massive Machine Type Communication (mMTC), and Ultra Reliability Low Latency Communication (URLLC).

The eMBB aims to provide a data transmission rate which is improved so as to surpass the data transmission speed supported by conventional LTE, LTE-A, or LTE-Pro. For example, in the 5G communication system, the eMBB should provide a peak downlink data rate of 20 Gbps and a peak uplink data rate of 10 Gbps from the viewpoint of one base station. Further, the 5G communication system should provide not only the peak data rate but also an increased user-perceived data rate. In order to satisfy such requirements, improvement of various transmission/reception technologies, including a further improved multiple-input multiple-output (MIMO) transmission technology, is needed. Further, while the current LTE system uses transmission bandwidths from a bandwidth of 2 GHz to a maximum bandwidth of 20 MHz to transmit signals, the 5G communication system uses a frequency bandwidth wider than 20 MHz in frequency bands of 3 to 6 GHz or higher than or equal to 6 GHZ, whereby the data transmission rate required by the 5G communication system can be satisfied.

Also, in order to support an application service such as the Internet of Things (IoT), mMTC is considered in the 5G communication system. The mMTC is required to support access of a multitude of UEs within a cell, improve coverage of the UE, increase a battery lifetime, and reduce the costs of the UE in order to efficiently provide IoT. IoT is attached to various sensors and devices to provide communication, and thus should support a large number of UEs (for example, 1,000,000 UEs/km2) within the cell. Since the UE supporting the mMTC is highly likely to be located in a shaded area, such as a basement of a building, which a cell cannot cover due to service characteristics, the mMTC may require wider coverage than other services provided by the 5G communication system. The UE supporting the mMTC needs to be produced at low cost and it is difficult to frequently exchange a battery thereof, so that a very long battery lifetime, for example, 10 to 15 years, may be required.

Last, the URLLC is a cellular-based wireless communication service used for a particular (mission-critical) purpose. For example, services used for remote control of robots or machinery, industrial automation, unmanned aerial vehicles, remote health care, and emergency alerts may be considered. Accordingly, communication provided by the URLLC should provide very low latency and very high reliability. For example, services supporting the URLLC should satisfy a radio access delay time (air interface latency) shorter than 0.5 milliseconds and also have a requirement of a packet error rate equal to or smaller than 10-5. Accordingly, for services supporting the URLLC, the 5G system should provide a Transmit Time Interval (TTI) smaller than that of other systems and also has a design requirement of allocating a wide array of resources in a frequency band in order to guarantee reliability of a communication link.

Three services of 5G, namely eMBB, URLLC, and mMTC, may be multiplexed and transmitted in one system. At this time, in order to meet the different requirements of the respective services, different transmission/reception schemes and transmission/reception parameters may be used for the services. Of course, 5G is not limited to the above-described three services.

In the following description, the term “a/b” may be understood as at least one of a and b.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

### [NR Time-Frequency Resources]

Hereinafter, a frame structure of a 5G system is described in more detail with reference to the drawings.

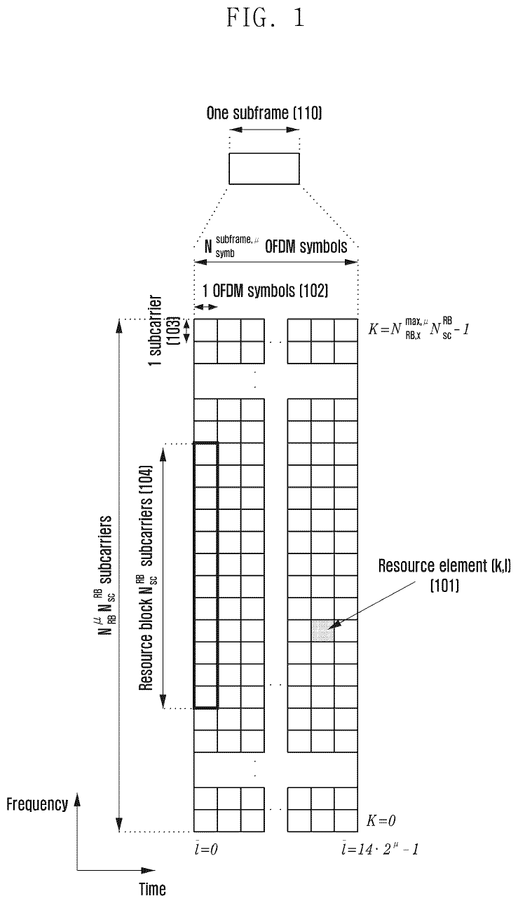

FIG. 1 illustrates a basic structure of a time-frequency domain which is a radio resource domain in which data or a control channel is transmitted in a 5G system according to an embodiment of the disclosure.

Referring to FIG. 1, a horizontal axis indicates a time domain and a vertical axis indicates a frequency domain. The basic unit of resources in the time and frequency domain is a resource element (RE) 101 and may be defined as 1 orthogonal frequency division multiplexing (OFDM) symbol 102 in the time axis and 1 subcarrier 103 in the frequency axis. In the frequency domain, N_{SC}^{RB} (for example, 12) successive REs may correspond to one Resource Block (RB) 104. In the time domain, one subframe 110 may include multiple OFDM symbols 102. For example, the length of one subframe may be 1 ms.

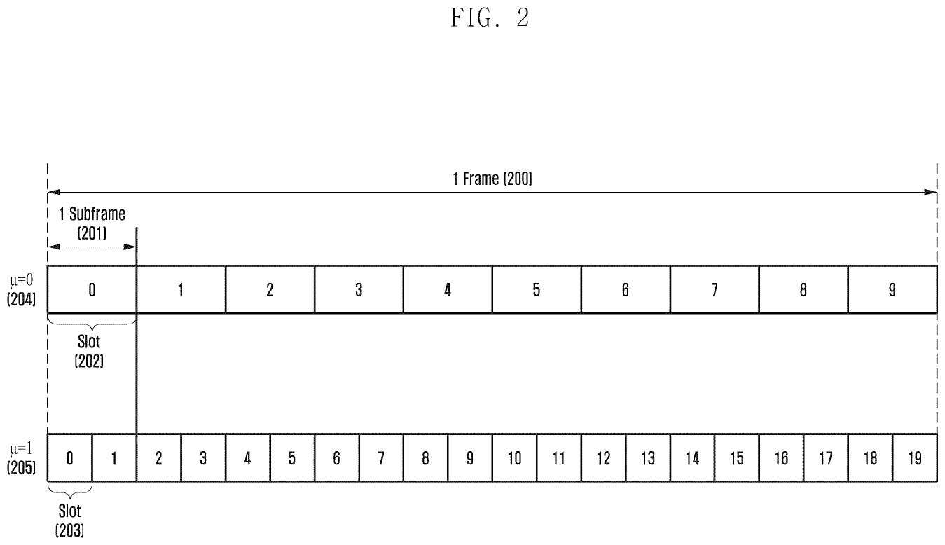

FIG. 2 illustrates frame, subframe, and slot structures in a wireless communication system according to an embodiment of the disclosure.

Referring to FIG. 2, an example of the structure of a frame 200, a subframe 201, and a slot 202, 203 is illustrated. 1 frame 200 may be defined as 10 ms. 1 subframe 201 may be defined as 1 ms, and accordingly one frame 200 may include a total of 10 subframes 201. 1 slot 202 or 203 may be defined as 14 OFDM symbols (that is, the number symbols N_{symb}^{slot}) per slot=14). 1 subframe 201 may include one or a plurality of slots 202 and 203, and the number of slots 202 or 203 per subframe 201 may vary depending on a configuration value u 204 or 205 for subcarrier spacing. In the example of FIG. 2 illustrates the case in which the subcarrier spacing configuration value μ=0 204 and the case in which the subcarrier spacing configuration value μ=1 205. 1 subframe 201 may include one slot 202 in the case of μ=0 204, and 1 subframe 201 may include 2 slots 203 in the case of μ=1 205. That is, the number (Nₛₗₒₜ^{subframe,μ}) of slots per subframe may vary depending on the configuration value (μ) for subcarrier spacing, and accordingly the number (Nₛₗₒₜ^{frame,μ}) of slots per frame may vary. The number (Nₛₗₒₜ^{subframe,μ}) and the number (Nₛₗₒₜ^{frame,μ}) according to the subcarrier spacing configuration value (μ) may be defined as shown in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Subsequently, a configuration of a bandwidth part (BWP) in a 5G system is described in detail with reference to the drawings.

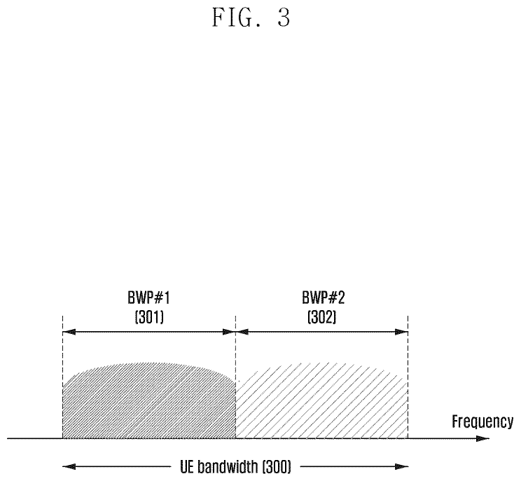

FIG. 3 illustrates an example of a configuration for a BWP in a wireless communication system according to an embodiment of the disclosure.

Referring to FIG. 3, a UE bandwidth 300 is configured as two bandwidth parts, that is, BWP #1 301 and BWP #2 302. The BS may configure one or a plurality of BWPs in the UE, and the following information of Table 2 may be configured to each BWP.

TABLE 2

| BWP ::= | SEQUENCE { |
|---|---|
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, n1, |
| n2, n3, n4, n5}, | |
| (subcarrier spacing) | |
| cyclicPrefix | ENUMERATED { |

```
extended }
    (cyclic prefix)
  }
```

Of course, the disclosure is not limited to the example, and various parameters related to a BWP as well as the configuration information may be configured in the UE. The information may be transmitted from to the UE by the BS through higher-layer signaling, for example, radio resource control (RRC) signaling. Among one or a plurality of configured BWPs, at least one BSP may be activated. Information indicating whether to activate the configured BWPs may be semi-statically transferred from the BS to the UE through RRC signaling or may be dynamically transferred through Downlink Control Information (DCI).

According to an embodiment of the disclosure, the UE before the Radio Resource Control (RRC) connection may receive a configuration of an initial BWP for initial access from the BS through a master information block (MIB). More specifically, the UE may receive configuration information for a control resource set (CORESET) and a search space in which a physical downlink control channel (PDCCH) for receiving system information (remaining system information (RMSI) or system information block 1 (SIB1)) required for initial access through the MIB can be transmitted in an initial access step. The control resource set and the search space configured as the MIB may be considered as an identity (ID) 0. The BS may inform the UE of configuration information such as frequency allocation information for control resource set #0, time allocation information, numerology, and the like through the MIB. Further, the BS may inform the UE of configuration information for a monitoring period and a monitoring occasion of control resource set #0, that is, configuration information for search space #0 through the MIB. The UE may consider a frequency region configured as control resource set #0 acquired from the MIB as an initial bandwidth part for initial access. At this time, the ID of the initial BWP may be considered as 0.

The configuration for the BWP supported by the 5G system may be used for various purposes.

According to an embodiment of the disclosure, when a bandwidth supported by the UE is narrower than a system bandwidth, it may be supported through the BWP configuration. For example, the BS may configure a frequency location (configuration information 2) of the BWP in the UE, and thus the UE may transmit and receive data at a specific frequency location within the system bandwidth.

Further, according to an embodiment of the disclosure, in order to support different numerologies, the BS may configure a plurality of BWPs in the UE. For example, in order to support the UE to perform data transmission and reception using both subcarrier spacing of 15 kHz and subcarrier spacing of 30 kHz, two BWPs may be configured as subcarrier spacings of 15 kHz and 30 kHz, respectively. Different BWPs may be frequency division-multiplexed, and when data is to be transmitted and received at specific subcarrier spacing, BWPs configured at the corresponding subcarrier spacing may be activated.

According to an embodiment of the disclosure, in order to reduce power consumption of the UE, the BS may configure BWPs having different sizes of bandwidths in the UE. For example, when the UE supports a very large bandwidth, for example, 100 MHz but always transmits and receives data through the bandwidth, very high power consumption may be generated. Particularly, monitoring an unnecessary downlink control channel through a large bandwidth of 100 MHz in the state in which there is no traffic is very inefficient from the aspect of power consumption. In order to reduce power consumption of the UE, the BS may configure a BWP having a relatively narrow bandwidth, for example, a bandwidth of 200 MHz. The UE may perform a monitoring operation in the bandwidth part of 200 MHz in the state in which there is no traffic, and if data is generated, may transmit and receive data through the bandwidth part of 100 MHz according to an instruction from the BS.

In a method of configuring the BWP, UEs before the RRC connection may receive configuration information for an initial bandwidth part through a master information block (MIB) in an initial access step. More specifically, the UE may receive a configuration of a control resource set (CORESET) for a downlink control channel in which downlink control information (DCI) for scheduling a system information block (SIB) can be transmitted from an MIB of a physical broadcast channel (PBCH). A bandwidth of the control resource set configured as the MIB may be considered as an initial bandwidth part, and the UE may receive a physical downlink shared channel (PDSCH), in which the SIB is transmitted, through the configured initial bandwidth part. The initial BWP may be used not only for reception of the SIB but also other system information (OSI), paging, or random access.

### [BWP Change]

When one or more BWPs are configured in the UE, the BS may indicate a change (or switching or transition) in the BWPs to the UE through a BWP indicator field within the DCI. For example, in FIG. 3, when a currently activated BWP of the UE is BWP #1 301, the BS may indicate BWP #2 302 to the UE through a BWP indicator within DCI and the UE may make a BWP change to BWP #2 302 indicated by the received BWP indicator within DCI.

As described above, since the DCI-based BWP change may be indicated by the DCI for scheduling the PDSCH or the PUSCH, the UE should be able to receive or transmit the PDSCH or the PUSCH scheduled by the corresponding DCI in the changed BWP without any difficulty if the UE receives a BWP change request. To this end, the standard has defined requirements for a delay time (T_{BWP}) required for the BWP change, and, for example, may be defined as follows.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}Depends on UE capability.
Note 2:
If the BWP switch involves changing of SCS, the BWP switch delay is determined by the larger one between the SCS before BWP switch and the SCS after BWP switch.

The requirements for the BWP change delay time may support type 1 or type 2 according to a UE capability. The UE may report a supportable BWP delay time type to the BS.

When the UE receives DCI including a BWP change indicator in slot n according to the requirements for the BWP change delay time, the UE may complete a change to a new BWP indicated by the BWP change indicator at a time point that is not later than slot n+T_{BWP} and transmit and receive a data channel scheduled by the corresponding DCI in the changed new BWP. When the BS desires to schedule a data channel in the new BWP, the BS may determine time domain resource allocation for the data cannel in consideration of the BWP change delay time (T_{BWP}) of the UE. That is, when scheduling the data channel in the new BWP, the BS may schedule the corresponding data channel after the BWP change delay time in a method of determining the time domain resource allocation for the data channel. Accordingly, the UE may not expect that the DCI indicating the BWP change indicates a slot offset (K0 or K2) smaller than the BWP change delay time (T_{BWP}).

If the UE receives DCI (for example, DCI format 1_1 or 0_1) indicating the BWP change, the UE may perform no transmission or reception during a time interval from a third symbol of a slot for receiving the PDCCH including the corresponding DCI to a start point of the slot indicated by the slot offset (K0 or K2) indicated through a time domain resource allocation field within the corresponding DCI. For example, when the UE receives DCI indicating the BWP change in slot n and a slot offset value indicated by the corresponding DCI is K, the UE may perform no transmission or reception from the third symbol of slot n to a symbol before slot n+K (that is, the last symbol of slot n+K−1).

### [Regarding CA/DC]

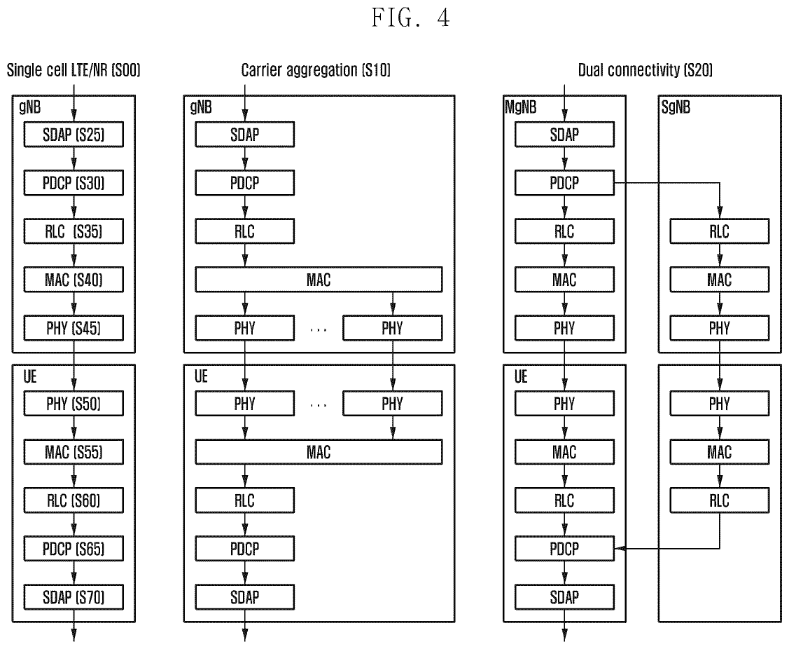

FIG. 4 illustrates a wireless protocol structure of the BS and the UE in single cell, carrier aggregation (CA), and dual connectivity (DC) according to an embodiment of the disclosure.

Referring to FIG. 4, a wireless protocol of a wireless communication system (for example, 5G or NR system) according to an embodiment of the disclosure includes an NR service data adaptation protocol (SDAP) S25 or S70, an NR packet data convergence protocol (PDCP) S30 or S65, an NR radio link control (RLC) S35 or S60, and an NR medium access control (MAC) S40 or S55 in each of the UE and the NR gNB.

Main functions of the NR SDAP S25 or S70 may include some of the following functions.
User data transmission function (transfer of user-plane data)
Function of mapping quality of service (QOS) flow and a data bearer for uplink and downlink (mapping between a QoS flow and a data radio bearer (DRB) for both DL and UL)
Function of marking a QoS flow ID for uplink and downlink (marking QoS flow ID in both DL and UL packets)
Function of mapping reflective QoS flow to a data bearer for uplink SDAP packet data units (PDUs) (reflective QoS flow to DRB mapping for the UL SDAP PDUs)

With respect to the SDAP layer device, the UE may receive a configuration as to whether to use a header of the SDAP layer device or a function of the SDAP layer device for each PDCP layer device, each bearer, or each logical channel through an RRC message. If the SDAP header is configured, a 1-bit indicator of non access stratum (NAS) reflective QoS of the SDAP header and a 1 bit-indicator of AS reflective QoS may indicate that the UE updates or reconfigures information on mapping of QoS flow and a data bearer in uplink and downlink. The SDAP header may include QoS flow ID information indicating the QoS. The QoS information may be used as data-processing-priority or scheduling information to support a seamless service.

Main functions of the NR PDCP S30 or S65 may include some of the following functions
Header compression and decompression function (header compression and decompression: robust header compression (ROHC) only)
User data transmission function (transfer of user data)
Sequential delivery function (in-sequence delivery of upper-layer PDUs)
Non-sequential delivery function (out-of-sequence delivery of upper-layer PDUs)
Reordering function (PDCP PDU reordering for reception)
Duplicate detection function (duplicate detection of lower-layer service data units (SDUs))
Retransmission function (retransmission of PDCP SDUs)
Ciphering and deciphering function (Ciphering and deciphering)
Timer-based SDU removal function (timer-based SDU discard in uplink)

The reordering function of the NR PDCP layer device is a function of sequentially reordering PDCP PDUs received from a lower layer on the basis of a PDCP sequence number (SN), and may include a function of sequentially transferring the reordered data to a higher layer The reordering function of the NR PDCP layer device may include a function of directly transmitting data regardless of the sequence, a function of recording PDCP PDUs lost due to the reordering, a function of reporting statuses of the lost PDCP PDUs to a transmitting side, and a function of making a request for retransmitting the lost PDCP PDUs.

Main functions of the NR RLC S35 or S60 may include some of the following functions.
Data transmission function (transfer of upper-layer PDUs)
Sequential delivery function (in-sequence delivery of upper-layer PDUs)
Non-sequential delivery function (out-of-sequence delivery of upper-layer PDUs)
Automatic repeat request (ARQ) function (error correction through ARQ)
Concatenation, segmentation, and reassembly function (concatenation, segmentation and reassembly of RLC SDUs)
Re-segmentation function (re-segmentation of RLC data PDUs)
Reordering function (reordering of RLC data PDUs)
Duplicate detection function (duplicate detection)
Error detection function (protocol error detection)
RLC SDU deletion function (RLC SDU discard)
RLC reestablishment function (RLC reestablishment)

The sequential delivery function (in-sequence delivery) of the NR RLC layer device is a function of sequentially transmitting RLC SDUs received from a lower layer to the higher layer. When one original RLC SDU is divided into a plurality of RLC SDUs and then received, the sequential delivery function (In-sequence delivery) of the NR RLC layer device may include a function of reassembling and transmitting the RLC SDUs, a function of reordering the received RLC PDUs on the basis of an RLC sequence number (SN) or a PDCP SN, a function of recording RLC PDUs lost due to the reordering, a function of reporting statuses of the lost RLC PDUs to a transmitting side, and a function of making a request for retransmitting the lost RLC PDUs. When there are lost RLC SDUs, the sequential delivery function (In-sequence delivery) of the NR RLC layer device may include a function of sequentially transferring only RLC SDUS preceding the lost RLC SDUs to the higher layer or a function of, if a predetermined timer expires even though there are lost RLC SDUs, sequentially transferring all RLC SDUs received before the timer starts to the higher layer. Alternatively, the sequential delivery function (In-sequence delivery) of the NR RLC layer device may include may include a function of, if a predetermined timer expires even though there are lost RLC SDUs, sequentially transferring all RLC SDUs received up to now to the higher layer. Further, the NR RLC device may process the RLC PDUs sequentially in the order of reception thereof (according to an arrival order regardless of a serial number or a sequence number) and may transfer the RLC PDUs to the PDCP device regardless of the sequence thereof (out-of-sequence delivery). In the case of segments, the NR RLC device may receive segments that are stored in the buffer or are to be received in the future, reconfigure the segments to be one RLC PDU, process the RLC PDU, and then transmit the same to the PDCP device. The NR RLC layer device may not include a concatenation function, and the function may be performed by the NR MAC layer, or may be replaced with a multiplexing function of the NR MAC layer.

The non-sequential function (Out-of-sequence delivery) of the NR RLC layer device is a function of transferring RLC SDUs received from a lower layer directly to a higher layer regardless of the sequence of the RLC SDUs, and may include, when one original RLC SDU is divided into a plurality of RLC SDUs and then received, a function of reassembling and transmitting the RLC PDUs and a function of storing RLC SNs or PDCP SNs of the received RLC PDUs, reordering the RLC PDUs, and recording lost RLC PDUS.

The NR MAC S40 or S55 may be connected to a plurality of NR RLC layer devices configured in one UE and main functions of the NR MAC may include some of the following functions.
Mapping function (Mapping between logical channels and transport channels)
Multiplexing and demultiplexing function (multiplexing/demultiplexing of MAC SDUS)
Scheduling information report function (scheduling information reporting)
Hybrid ARQ (HARQ) function (error correction through HARQ)
   Logical channel priority control function (priority handling between logical channels of one UE)
UE priority control function (priority handling between UEs by means of dynamic scheduling)
Multimedia broadcast multicast service (MBMS) service identification function (MBMS service identification)
Transport format selection function (transport format selection)
Padding function (padding)

The NR PHY layer S45 or S50 perform an operation for channel-coding and modulating higher-layer data to generate an OFDM symbol and transmitting the OFDM symbol through a radio channel or demodulating and channel-decoding the OFDM symbol received through the radio channel and transmitting the demodulated and channel-decoded OFDM symbol to the higher layer.

A detailed structure of the wireless protocol structure may be variously changed according to a carrier (or cell) operation scheme. For example, when the BS transmits data to the UE on the basis of a single carrier (or cell), the BS and the UE use a protocol structure having a single structure for each layer as indicated by reference numeral S00. On the other hand, when the BS transmits data to the UE on the basis of carrier aggregation (CA) using multiple carriers in a single TRP, the BS and the UE use a protocol structure in which layers up to RLC have a single structure but the PHY layer is multiplexed through the MAC layer as indicated by reference numeral S10. In another example, when the BS transmits data to the UE on the basis of dual connectivity (DC) using multiple carriers in multiple TRPs, the BS and the UE use a protocol structure in which layers up to RLC have a single structure but the PHY layer is multiplexed through the MAC layer as indicated by reference numeral S20.

### [Unified TCI State]

Hereinafter, a single TCI state indication and activation method based on a unified TCI method is described. The unified TCI method may refer to a method managing the transmission/reception beam management method, which is distinguished by the TCI state method used in the downlink reception of the UE and the spatial relation info method used in the uplink transmission in the existing Rel-15 and 16, by unifying them into the TCI state. Therefore, when the UE is indicated by the base station based on the unified TCI method, the UE may perform beam management by using the TCI state for uplink transmission as well. If the UE is configured with the TCI-State, which is the upper-layer signaling, with the tci-stateId-r17 which is the upper-layer signaling, from the base station, the UE may perform an operation based on the unified TCI method by using the corresponding TCI-State. The TCI-State may exist in two forms, a joint TCI state or a separate TCI state.

The first form is the joint TCI state, and the UE may be indicated with both the TCI states to be applied to uplink transmission and downlink reception through one TCI-State from the base station. If the UE is indicated with the TCI-State based on the joint TCI state, the UE may be indicated with a parameter to be used for downlink channel estimation using the reference signal (RS) corresponding to qcl-Type1 in the TCI-State based on the joint TCI state, and a parameter to be used as a downlink reception beam or a reception filter using the RS corresponding to qcl-Type2. If the UE is indicated with the TCI-State based on the joint TCI state, the UE may be indicated with a parameter to be used as an uplink transmission beam or a transmission filter using the RS corresponding to qcl-Type2 in the TCI-State based on the joint DL/UL TCI state. In this case, if the UE is indicated with the joint TCI state, the UE may apply the same beam to both uplink transmission and downlink reception.

The second form is the separate TCI state, and the UE may be individually indicated with the UL TCI state to be applied to uplink transmission and the DL TCI state to be applied to downlink reception from the base station. If the UE is indicated with the UL TCI state, the UE may be indicated with the parameter to be used as a uplink transmission beam or a transmission filter using the reference RS or source RS configured in the corresponding UL TCI state. If the UE is indicated with a UL TCI state, the UE may be indicated with the parameter to be used for downlink channel estimation using the RS corresponding to qcl-Type1 configured in the corresponding DL TCI state, and the parameter to be used as the downlink reception beam or the reception filter using the RS corresponding to qcl-Type2.

If the UE is indicated with both the DL TCI state and the UL TCI state, the UE may be indicated with the parameter to be used as an uplink transmission beam or a transmission filter using the reference RS or source RS configured in the corresponding UL TCI state, and may be indicated with the parameter to be used for downlink channel estimation using the RS corresponding to qcl-Type1 configured in the corresponding DL TCI state, and the parameter to be used as the downlink reception beam or the reception filter using the RS corresponding to qcl-Type2. In this case, if the reference RS or source RS configured in the DL TCI state and the UL TCI state with which the UE is indicated are different, the UE may individually apply beams to uplink transmission and downlink reception based on the indicated UL TCI state and DL TCI state, respectively.

The UE may be configured with up to 128 joint TCI states through upper-layer signaling from the base station for each bandwidth part within a specific cell, may be configured with up to 64 or 128 DL TCI states among the separate TCI states through upper-layer signaling for each bandwidth part within a specific cell based on the UE capability report, and the DL TCI state among the separate TCI states and the joint TCI state may use the same upper-layer signaling structure. As an example, if 128 joint TCI states are configured and 64 DL TCI states among the separate TCI states are configured, the 64 DL TCI states may be included in the 128 joint TCI states.

The UL TCI state among the separate TCI states may be configured up to 32 or 64 through upper-layer signaling for each specific bandwidth part in a specific cell based on the UE capability report, the UL TCI state among the separate TCI and the joint TCI state may also use the same upper-layer signaling structure as with the relationship between the DL TCI state and the joint TCI state among the separate TCI states, and the UL TCI state among the separate TCI may use different upper-layer signaling structures from the joint TCI state and the DL TCI state among the separate TCI states.

The use of different or identical upper-layer signaling structures may be defined in the specification, or may be distinguished by another upper-layer signaling configured by the base station based on the UE capability report including information on whether the UE may support one of the two usage modes.

The UE may receive indications related to transmission and reception beams in an unified TCI method by using one of the joint TCI state and separate TCI state configured by the base station. The UE may be configured by the base station through upper-layer signaling whether to use one of the joint TCI state and separate TCI state.

The UE may receive a transmission/reception beam-related indication by using one of the methods selected from the joint TCI state and the separate TCI state through upper-layer signaling, and in this case, there may be two methods of transmission/reception beam indications from the base station: a MAC-CE-based indication method, and a MAC-CE-based activation and DCI-based indication method.

If the UE receives the transmission/reception beam-related indication by using the joint TCI state method through upper-layer signaling, the UE may perform a transmission/reception beam application operation by receiving a MAC-CE indicating the joint TCI state from the base station, and the base station may schedule reception of the PDSCH including the MAC-CE through the PDCCH to the UE. If the MAC-CE includes one joint TCI state, the UE may determine the uplink transmission beam or transmission filter and the downlink reception beam or reception filter by using the indicated joint TCI state starting from 3 ms after the physical uplink control channel (PUCCH) transmission including HARQ-acknowledgment (ACK) information indicating success or failure of reception for the PDSCH including the MAC-CE, and if the MAC-CE includes two or more joint TCI states, the UE may identify that the multiple joint TCI states indicated by the MAC-CE correspond to each code point of the TCI state field of DCI format 1_1 or 1_2 and activate the indicated joint TCI state starting from 3 ms after the PUCCH transmission including HARQ-ACK information indicating success or failure of reception for the PDSCH including the MAC-CE. After that, the UE may receive DCI format 1_1 or 1_2 and apply one joint TCI state indicated by the TCI state field in the corresponding DCI to the uplink transmission and downlink reception beams. In this case, DCI format 1_1 or 1_2 may include downlink data channel scheduling information (with DL assignment) or may not include it (without DL assignment).

If the UE receives the transmission/reception beam-related indication by using the separate TCI state method through upper-layer signaling, the UE may perform a transmission/reception beam application operation by receiving a MAC-CE indicating the separate TCI state from the base station, and the base station may schedule reception of the PDSCH including the MAC-CE through the PDCCH to the UE. If the MAC-CE includes one separate TCI state set, the UE may determine the uplink transmission beam or transmission filter and the downlink reception beam or reception filter by using the separate TCI states in the indicated separate TCI state set starting from 3 ms after the PUCCH transmission including HARQ-ACK information indicating success or failure of reception for the PDSCH including the MAC-CE. In this case, the separate TCI state set may mean a single or multiple separate TCI states that one code point of a TCI state field in DCI format 1_1 or 1_2 may have, and one separate TCI state set may include one DL TCI state, one UL TCI state, or one DL TCI state and one UL TCI state. If the MAC-CE includes two or more separate TCI state sets, the UE may identify that the multiple separate TCI state sets indicated by MAC-CE correspond to each code point of the TCI state field of DCI format 1_1 or 1_2 and activate the indicated separate TCI state sets starting from 3 ms after the PUCCH transmission including HARQ-ACK information indicating success or failure of reception for the PDSCH including the MAC-CE. In this case, each code point of the TCI state field of DCI format 1_1 or 1_2 may indicate one DL TCI state, one UL TCI state, or one DL TCI state and one UL TCI state each. The UE may receive DCI format 1_1 or 1_2 and apply the separate TCI state set indicated by the TCI state field in the corresponding DCI to the uplink transmission and downlink reception beams. In this case, DCI format 1_1 or 1_2 may include downlink data channel scheduling information (with DL assignment) or may not include it (without DL assignment).

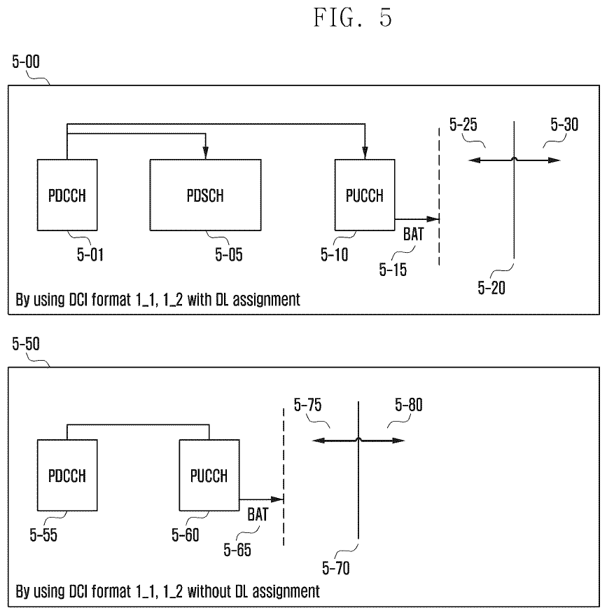

FIG. 5 is a drawing illustrating a beam application time that may be considered when using an unified TCI method in a wireless communication system according to an embodiment of the disclosure.

As described above, the UE may receive DCI format 1_1 or 1_2 including (with DL assignment) or not including (without DL assignment) downlink data channel scheduling information from the base station, and apply one joint TCI state or a separate TCI state set indicated by the TCI state field in the corresponding DCI to the uplink transmission and downlink reception beams. Referring to FIG. 5,
DCI format 1_1 or 1_2 with DL assignment 5-00: If the UE receives DCI format 1_1 or 1_2 including downlink data channel scheduling information from the base station and indicates one joint TCI state or a separate TCI state set based on the unified TCI method (5-01), the UE may receive a PDSCH scheduled based on the received DCI (5-05), and may transmit a PUCCH including HARQ-ACK indicating whether reception of the DCI and PDSCH is successful (5-10). In this case, the HARQ-ACK may include both the meaning of whether reception of the DCI and PDSCH is successful, and if at least one of the DCI and PDSCH is not received, the UE may transmit negative acknowledgement (NACK), and if reception of both is successful, the UE may transmit ACK.
DCI format 1_1 or 1_2 without DL assignment 5-50: If the UE receives DCI format 1_1 or 1_2 not including downlink data channel scheduling information from the base station and indicates one joint TCI state or a separate TCI state set based on the unified TCI method (5-55), the UE may assume at least one combination of the following for the corresponding DCI.
Cyclic redundancy check (CRC) scrambled by using configured scheduling radio network temporary identifier (CS-RNTI) is included.
All bits assigned to all fields used as Redundancy Version (RV) fields are 1.
All bits assigned to all fields used as Modulation and Coding Scheme (MCS) fields are 1.
All bits assigned to all fields used as New Data Indication (NDI) fields are 0.
In the case of Frequency Domain Resource Allocation (FDRA) Type 0, all bits assigned to the FDRA field are 0, in the case of FDRA Type 1, all bits assigned to the FDRA field are 1, and in the case of dynamicSwitch FDRA method, all bits assigned to the FDRA field are 0.

The UE may transmit a PUCCH including HARQ-ACK indicating whether the reception is successful for the DCI format 1_1 or 1_2 in which the above-described matters are assumed (5-60).
For both DCI format 1_1 or 1_2 with DL assignment 5-00 and without DL assignment 5-50, if a new TCI state indicated through DCIs 5-01 and 5-55 is the same as a TCI state that has already been indicated and applied to the uplink transmission and downlink reception beams, the UE may maintain the previously applied TCI state, and if the new TCI state is different from the previously indicated TCI state, the UE may determine the application time of the joint TCI state or the separate TCI state set that may be indicated from the TCI state field included in the DCI as the time after the first slots 5-20 and 5-70 after the time equivalent to beam application time (BAT) 5-15 and 5-65 after the PUCCH transmissions 5-30 and 5-80, and may use the previously indicated TCI-state is available up to (5-25, 5-75) the corresponding slots 5-20 and 5-70.
For both DCI format 1_1 or 1_2 with DL assignment 5-00 and without DL assignment 5-50, the BATs 5-15 and 5-65 may be configured by upper-layer signaling based on UE capability report information as a specific number of OFDM symbols, and the numerology for BAT and the first slot after BAT may be determined based on the smallest numerology among all cells to which a joint TCI state or a separate TCI state set indicated through DCI is applied.

The UE may apply one joint TCI state indicated through MAC-CE or DCI to reception for control resource sets connected to all UE-specific search spaces, reception for PDSCH scheduled through PDCCH transmitted from the corresponding control resource set and transmission for PUSCH, and transmission of all PUCCH resources.

When one separate TCI state set indicated through MAC-CE or DCI includes one DL TCI state, the UE may apply one separate TCI state set to reception for control resource sets connected to all UE-specific search spaces, reception for PDSCH scheduled through PDCCH transmitted from the corresponding control resource set, and may apply one separate TCI state set to all PUSCH and PUCCH resources based on the previously indicated UL TCI state.

When one separate TCI state set indicated through MAC-CE or DCI includes one UL TCI state, the UE may apply one separate TCI state set to all PUSCH and PUCCH resources, and apply one separate TCI state set to reception of control resource sets connected to all UE-specific search spaces based on the previously indicated DL TCI state and reception of PDSCH scheduled through PDCCH transmitted from the corresponding control resource set.

When one separate TCI state set indicated through MAC-CE or DCI includes one DL TCI state and one UL TCI state, the UE may apply the DL TCI state to the reception of control resource sets connected to all UE-specific search spaces, the reception of the PDSCH scheduled on the PDCCH transmitted from the corresponding control resource set, and apply the UL TCI state to all PUSCH and PUCCH resources.

### [Unified TCI State MAC-CE]

Hereinafter, a single TCI state indication and activation method based on a unified TCI method is described. The UE may interpret each code point of the TCI state field in DCI format 1_1 or 1_2 based on the information in the MAC-CE received from the base station after 3 slots in which the PDSCH is scheduled including the following MAC-CE from the base station and HARQ-ACK for the corresponding PDSCH is transmitted to the base station. That is, the UE may activate each entry of the MAC-CE received from the base station to each code point of the TCI state field in DCI format 1_1 or 1_2.

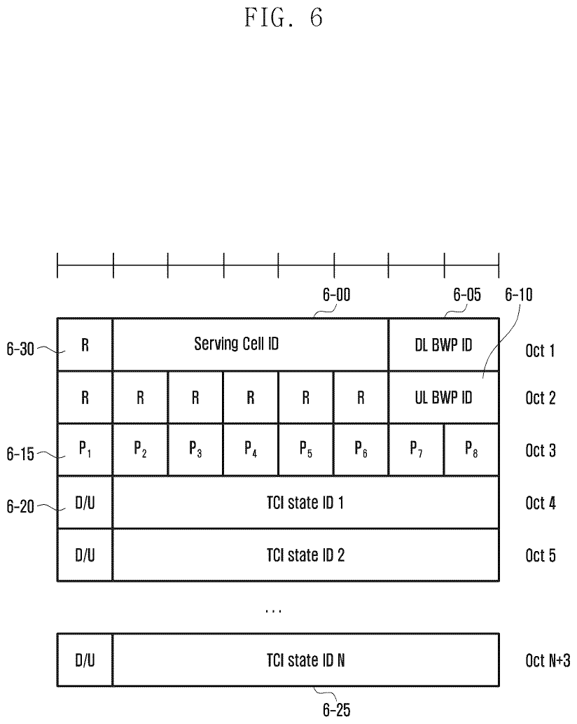

FIG. 6 is a drawing illustrating another MAC-CE structure for activating and indicating a joint TCI state, separate DL, or UL TCI state in a wireless communication system according to an embodiment of the disclosure.

Referring to FIG. 6, the meaning of each field in the corresponding MAC-CE structure may be as follows.
Serving Cell ID 6-00: This field may indicate which serving cell the MAC-CE is applied to. The length of this field may be 5 bits. If the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4, which are the upper-layer signaling lists, the corresponding MAC-CE may be applied to all serving cells included in one or more of the lists simultaneousU-TCI-UpdateList1, simultaneousU-TCI-UpdateList2, simultaneousU-TCI-UpdateList3, or simultaneousU-TCI-UpdateList4, that include the serving cell indicated by this field.
DL BWP ID 6-05: This field may indicate which DL BWP the corresponding MAC-CE applies to, and the meaning of each code point in this field may correspond to each code point of the bandwidth part indicator in the DCI. The length of this field may be 2 bits.
UL BWP ID 6-10: This field may indicate which UL BWP the corresponding MAC-CE applies to, and the meaning of each code point in this field may correspond to each code point of the bandwidth part indicator in the DCI. The length of this field may be 2 bits.
Pᵢ 6-15: This field may indicate whether each code point in the TCI state field in DCI format 1_1 or 1_2 has multiple TCI states or a single TCI state. If the value of Pᵢ is 1, it means that the corresponding i^{th} code point has multiple TCI states, which may mean that the corresponding code point may include a separate DL TCI state and a separate UL TCI state. If the value of Pᵢ is 0, it means that the corresponding i^{th} code point has a single TCI state, which may mean that the corresponding code point may include one of a joint TCI state, a separate DCI TCI state, or a separate UL TCI state.
D/U 6-20: This field may indicate whether the TCI state ID field in the same octet is a joint TCI state, a separate DL TCI state, or a separate UL TCI state. If this field is 1, the TCI state ID field in the same octet may be a joint TCI state or a separate DL TCI state, and if this field is 0, the TCI state ID field in the same octet may be a separate UL TCI state.
TCI state ID 6-25: This field may indicate a TCI state that may be determined by the upper-layer signaling TCI-StateId. If the D/U field is configured to 1, this field may be used to express a TCI-StateId that may be expressed in 7 bits. If the D/U field is configured to 0, the most significant bit (MSB) of this field may be considered as a reserved bit, and the remaining 6 bits may be used to express the upper-layer signaling UL-TCIState-Id. The maximum number of TCI states that may be activated may be 8 for the joint TCI state and 16 for the separate DL or UL TCI state.
R 6-30: Means reserved bit and may be configured to 0.

For the MAC-CE structure of the above-described FIG. 6, regardless of whether unifiedTCI-StateType-r17 in MIMOparam-r17 in ServingCellConfig, which is the upper-layer signaling, is configured to joint or separate, the UE may include the third octet including the P₁, P₂, . . . , P₈ fields in FIG. 6 in the corresponding MAC-CE structure. In this case, the UE may perform TCI state activation by using a fixed MAC-CE structure regardless of the upper-layer signaling configured by the base station.

As another example, for the MAC-CE structure of the above-described FIG. 6, if unifiedTCI-StateType-r17 in MIMOparam-r17 in ServingCellConfig, which is the upper-layer signaling, is configured to joint, the UE may omit the third octet including the P₁, P₂, . . . , P₈ fields in FIG. 6. In this case, the UE may save up to 8 bits of the payload of the corresponding MAC-CE according to the upper-layer signaling configured by the base station. In addition, all D/U fields located from the fourth octet to the first bit in FIG. 6 may be regarded as R fields, and all corresponding R fields may be configured to 0 bits.

### [PDCCH: Regarding DCI]

Subsequently, downlink control information (DCI) in a 5G system is described in detail.

In the 5G system, scheduling information for uplink data (or a physical uplink data channel (physical uplink shared channel (PUSCH)) or downlink data (or physical downlink data channel (physical downlink shared channel (PDSCH)) is transmitted from the BS to the UE through DCI. The UE may monitor a fallback DCI format and a non-fallback DCI format for the PUSCH or the PDSCH. The fallback DCI format may include a fixed field predefined between the BS and the UE, and the non-fallback DCI format may include a configurable field.

The DCI may be transmitted through a Physical Downlink Control Channel (PDCCH) via a channel coding and modulation process. A cyclic redundancy check (CRC) may be added to a DCI message payload and may be scrambled by a radio network temporary identifier (RNTI) corresponding to the identity of the UE. Depending on the purpose of the DCI message, for example, UE-specific data transmission, a power control command, a random access response, or the like, different RNTIs may be used. That is, the RNTI is not explicitly transmitted but is included in a CRC calculation process to be transmitted. If the DCI message transmitted through the PDCCH is received, the UE may identify the CRC through the allocated RNTI, and may recognize that the corresponding message is transmitted to the UE when the CRC is determined to be correct on the basis of the CRC identification result.

For example, DCI for scheduling a PDSCH for system information (SI) may be scrambled by an SI-RNTI. DCI for scheduling a PDSCH for a random access response (RAR) message may be scrambled by an RA-RNTI. DCI for scheduling a PDSCH for a paging message may be scrambled by a P-RNTI. DCI for notifying of a slot format indicator (SFI) may be scrambled by an SFI-RNTI. DCI for notifying of transmit power control (TPC) may be scrambled with a TPC-RNTI. DCI for scheduling a UE-specific PDSCH or PUSCH may be scrambled by a cell RNTI (C-RNTI).

DCI format 0_0 may be used for fallback DCI for scheduling a PUSCH in which case the CRC may be scrambled by a C-RNTI. DCI format 0_0 in which the CRC is scrambled by the C-RNTI may include, for example, the following information of Table 4.

TABLE 4
- Identifier for DCI formats - [1] bit
- Frequency domain resource assignment -[┌log₂( N_{RB}^{UL, BWP} (N_{RB}^{UL, BWP} +
1)/2)┐ ] bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- Transmit power control (TPC) command for scheduled PUSCH - [2] bits
- Uplink (UL)/supplementary UL (SUL) indicator - 0 or 1 bit

DCI format 0_1 may be used for non-fallback DCI for scheduling a PUSCH in which case the CRC may be scrambled by a C-RNTI. DCI format 0_1 in which the CRC is scrambled by the C-RNTI may include, for example, the following information of Table 5.

```
TABLE 5
- Carrier indicator - 0 or 3 bits
- UL/SUL indicator - 0 or 1 bit
- Identifier for DCI formats - [1] bits
- Bandwidth part indicator - 0, 1 or 2 bits
- Frequency domain resource assignment
    For resource allocation type 0, ┌N_{RB}^{UL,BWP}/P┐ bits
    For resource allocation type 1, ┌log₂ (N_{RB}^{UL,BWP}(N_{RB}^{UL,BWP} + 1)/2)┐ bits
- Time domain resource assignment - 1, 2, 3, or 4 bits
- Virtual resource block (VRB)-to-physical resource block (PRB) mapping - 0 or 1 bit, only
for resource allocation type 1.
    0 bit if only resource allocation type 0 is configured;
    1 bit otherwise.
- Frequency hopping flag - 0 or 1 bit, only for resource allocation type 1.
    0 bit if only resource allocation type 0 is configured;
    1 bit otherwise.
- Modulation and coding scheme - 5 bits
- New data indicator - 1 bit
- Redundancy version - 2 bits
- HARQ process number - 4 bits
- 1st downlink assignment index - 1 or 2 bits
    1 bit for semi-static HARQ-ACK codebook;
    2 bits for dynamic HARQ-ACK codebook with single HARQ-ACK codebook.
- 2nd downlink assignment index - 0 or 2 bits
    2 bits for dynamic HARQ-ACK codebook with two HARQ-ACK sub-codebooks;
    0 bit otherwise.
- TPC command for scheduled PUSCH - 2 bits
-  $SRS resource indicator ⌈ {log}_{2} ( {Σ}_{k = 1}^{{L}_{max} Σ} ( \begin{matrix}{N}_{SRS} \\ k\end{matrix} ) ( ) ) □□ ⌉ or ⌈ {log}_{2} ( {N}_{SRS} ) ⌉ bits$
  •  $⌈ {log}_{2} ( {Σ}_{k = 1}^{{L}_{max} Σ} ( \begin{matrix}{N}_{SRS} \\ k\end{matrix} ) ( ) ) □□ ⌉ bits for non - codebook based PUSCH$
    transmission;
  • ┌log₂(N_{SRS})┐ bits for codebook based PUSCH transmission.
- Precoding information and number of layers - up to 6 bits
- Antenna ports - up to 5 bits
- SRS request - 2 bits
- Channel state information (CSI) request - 0, 1, 2, 3, 4, 5, or 6 bits
- Code block group (CBG) transmission information - 0, 2, 4, 6, or 8 bits
- Phase tracking reference signal (PTRS)-demodulation reference signal (DMRS) association -
0 or 2 bits.
- beta_offset indicator - 0 or 2 bits
- DMRS sequence initialization - 0 or 1 bit
```

DCI format 1_0 may be used for fallback DCI for scheduling a PDSCH in which case the CRC may be scrambled by a C-RNTI. DCI format 1_0 in which the CRC is scrambled by the C-RNTI may include, for example, the following information of Table 6.

TABLE 6
- Identifier for DCI formats - [1] bit
- Frequency domain resource assignment -[┌log₂( N_{RB}^{DL, BWP} (N_{RB}^{DL, BWP} +
1)/2)┐ ] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- Physical uplink control channel (PUCCH) resource indicator - 3 bits
- PDSCH-to-HARQ feedback timing indicator - [3] bits

DCI format 1_1 may be used for non-fallback DCI for scheduling a PDSCH in which case the CRC may be scrambled by a C-RNTI. DCI format 1_1 in which the CRC is scrambled by the C-RNTI may include, for example, the following information of Table 7.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |

```
  For resource allocation type 0, ┌N_{RB}^{DL, BWP}/ P┐ bits
  For resource allocation type 1, ┌log₂( N_{RB}^{DL, BWP} (N_{RB}^{DL, BWP} + 1)/2)┐ bits
```

| | |
|---|---|
| - | Time domain resource assignment -1, 2, 3, or 4 bits |
| - | VRB-to-PRB mapping - 0 or 1 bit, only for resource allocation type 1. |

0 bit if only resource allocation type 0 is configured;
1 bit otherwise.

| | |
|---|---|
| - | Physical resource block (PRB) bundling size indicator - 0 or 1 bit |
| - | Rate matching indicator - 0, 1, or 2 bits |
| - | Zero power (ZP) channel state information (CSI)-reference signal (RS) |

trigger - 0, 1, or 2 bits
For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | Code block group (CBG) flushing out information - 0 or 1 bit |
| - | DMRS sequence initialization - 1 bit |

### [PDCCH: CORESET, REG, CCE, Search Space]

Subsequently, a downlink control channel in a 5G communication system is described in more detail with reference to the drawings.

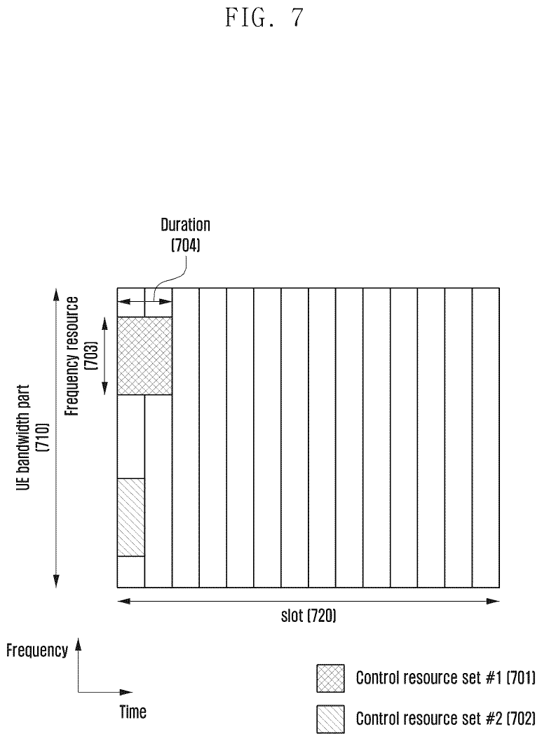

FIG. 7 illustrates an example of a control resource set (CORESET) in which a downlink control channel is transmitted in 5G wireless communication systems according to an embodiment of the disclosure.

FIG. 7 illustrates an example in which a UE bandwidth part 710 is configured in the frequency axis and two control resource sets (control resource set #1 701 and control resource set #2 702) are configured within 1 slot 720 in the time axis. The control resource sets 701 and 702 may be configured in specific frequency resources 703 within a total UE BWP 710 in the frequency axis. The control resource set may be configured as one or a plurality of OFDM symbols in the time axis, which may be defined as a control resource set duration 704. Referring to the example illustrated in FIG. 7, control resource set #1 701 may be configured as a control resource set duration of 2 symbols, and control resource set #2 702 may be configured as a control resource set duration of 1 symbol.

The control resource sets in the 5G system may be configured through higher-layer signaling (for example, system information, a master information block (MIB), or radio resource control (RRC) signaling) in the UE by the BS. Configuring the control resource set in the UE may mean providing information such as a control resource set identity, a frequency location of the control resource set, and a symbol length of the control resource set. For example, the following information of Table 8 may be included.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(control resource set identity)

| | |
|---|---|
| frequencyDomainResources | BIT STRING (SIZE |

```
(45)),
(frequency axis resource allocation information)
  duration
  INTEGER (1..maxCoReSetDuration),
(time axis resource allocation information)
  cce-REG-MappingType
  CHOICE {
(CCE-to-REG mapping scheme)
    interleaved
  SEQUENCE {
      reg-BundleSize
  ENUMERATED {n2, n3, n6},
  (REG bundle size)
      precoderGranularity
  ENUMERATED {sameAsREG-bundle, allContiguousRBs},
      interleaverSize
  ENUMERATED {n2, n3, n6}
      (interleaver size)
      shiftIndex
  INTEGER(0..maxNrofPhysicalResourceBlocks−1)
          OPTIONAL
    (interleaver shift)
  },
```

| | |
|---|---|
| nonInterleaved | NULL |

```
  },
  tci-StatesPDCCH
  SEQUENCE(SIZE (1..maxNrofTCI-StatesPDCCH)) OF TCI-StateId
        OPTIONAL,
(QCL configuration information)
```

| | |
|---|---|
| tci-PresentInDCI | ENUMERATED |

{enabled}
OPTIONAL, -- Need S
}

In Table 8, tci-StatesPDCCH (referred to as a transmission configuration indication (TCI) state) configuration information may include information on one or a plurality of synchronization signal (SS)/physical broadcast channel (PBCH) block indexes or channel state information reference signal (CSI-RS) indexes having the Quasi Co-Located (QCL) relationship with a DMRS transmitted in the corresponding CORESET.

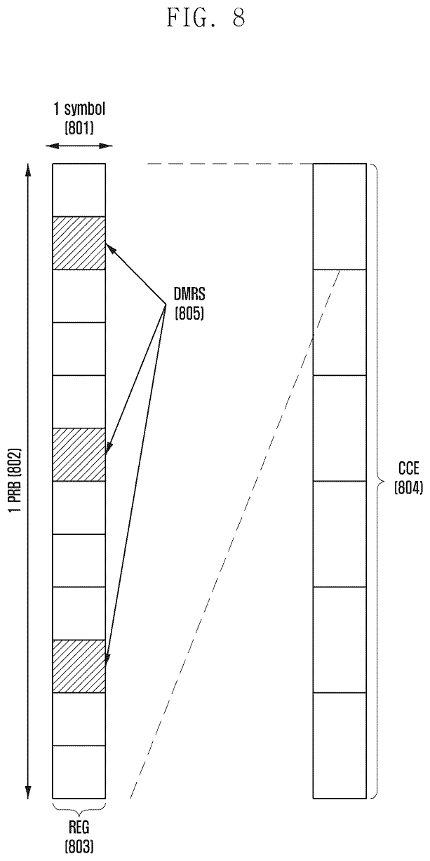

FIG. 8 illustrates an example of a basic unit of time and frequency resources included in a downlink control channel which can be used in a 5G system according to an embodiment of the disclosure.

Referring to FIG. 8, the basic unit of time and frequency resources included in the control channel may be a resource element group (REG) 803, and the REG 803 may be defined as 1 OFDM symbol 801 in the time axis and 1 physical resource block (PRB) 802 in the frequency axis, that is, as 12 subcarriers. The BS may configure a downlink control channel allocation unit by concatenating the REGs 803.

As illustrated in FIG. 8, when the basic unit for allocation of the downlink control channel in the 5G system is a control channel eminent (CCE) 804, 1 CCE 804 may include a plurality of REGs 803. In a description of the REG 803 illustrated in FIG. 8 by way of example, the REG 803 may include 12 REs and, when 1 CCE 804 includes 6 REGs 803, 1 CCE 804 may include 72 REs. When a downlink CORESET is configured, the corresponding area may include a plurality of CCEs 804, and a specific downlink control channel may be mapped to one or a plurality of CCEs 804 according to an aggregation level (AL) within the CORESET and then transmitted. CCEs 804 within the CORESET may be distinguished by numbers and the numbers of the CCEs 804 may be assigned according to a logical mapping scheme.

The basic unit of the downlink control channel illustrated in FIG. 8, that is, the REG 803, may include all of the REs to which the DCI is mapped and the areas to which DMRSs 805, which are reference signals for decoding the REs, are mapped. As illustrated in FIG. 8, 3 DMRSs 805 may be transmitted in 1 REG 803 The number of CCEs required to transmit the PDCCH may be 1, 2, 4, 8, or 16 according to the aggregation level (AL), and the different number of CCEs may be used to implement link adaptation of the downlink control channel. For example, if AL=L, one downlink control channel may be transmitted through L CCEs. The UE should detect a signal in the state in which the UE does not know information on the downlink control channel, and a search space indicating a set of CCEs is defined to perform blind decoding in a wireless communication system (for example, 5G or NR system) according to an embodiment of the disclosure. The search space is a set of downlink control channel candidates including CCEs for which the UE should attempt decoding at the given aggregation level, and there are several aggregation levels at which one set of CCEs is configured by 1, 2, 4, 8, and 16 CCEs, so that the UE may have a plurality of search spaces. A search space set may be defined as a set of search spaces at all the configured aggregation levels.

The search space may be classified into a common search space and a UE-specific search space. UEs in a predetermined group or all UEs may search for a common search space of the PDCCH in order to receive cell-common control information such as dynamic scheduling for system information or paging messages. For example, PDSCH scheduling allocation information for transmission of an SIB including information on a service provider of a cell may be received by searching for (monitoring) a common search space of the PDCCH. In the case of the common search space, UEs in a predetermined group or all UEs should receive the PDCCH, so that the common-search space may be defined as a set of pre-arranged CCEs. Scheduling allocation information for the UE-specific PDSCH or PUSCH may be received by searching for a UE-specific search space of the PDCCH. The UE-specific search space may be UE-specifically defined as a UE identity and a function of various system parameters.

A parameter for a search space of a PDCCH in a wireless communication system (for example, 5G or NR system) according to an embodiment of the disclosure may be configured in the UE by the BS through higher-layer signaling (for example, SIB, MIB, or RRC signaling). For example, the BS may configure, in the UE, the number of PDCCH candidates at each aggregation level L, a monitoring period of the search space, a monitoring occasion in units of symbols within the slot for the search space, a search space type, that is, a common search space or a UE-specific search space, a combination of a DCI format and an RNTI to be monitored in the corresponding search space, and a control resource set index for monitoring the search space. For example, the following information of Table 9 may be included.

TABLE 9

| | |
|---|---|
| SearchSpace ::= | SEQUENCE { |

```
  -- Identity of the search space. SearchSpaceId = 0 identifies the
  SearchSpace
configured via PBCH (MIB) or ServingCellConfigCommon.
```

| | |
|---|---|
| searchSpaceId | SearchSpaceId, |

(search space identifier)

| | |
|---|---|
| controlResourceSetId | ControlResourceSetId, |

(control resource set identifier)

| | |
|---|---|
| monitoringSlotPeriodicityAndOffset | CHOICE { |

```
(monitoring slot level period)
    sl1
  NULL,
    sl2
  INTEGER (0..1),
    sl4
  INTEGER (0..3),
    sl5
  INTEGER (0..4),
    sl8
  INTEGER (0..7),
    sl10
  INTEGER (0..9),
    sl16
  INTEGER (0..15),
    sl20
  INTEGER (0..19)
  }
```

| | |
|---|---|
| | OPTIONAL, |
| duration (monitoring length) | INTEGER (2..2559) |
| monitoringSymbolsWithinSlot | BIT |

```
STRING (SIZE (14))
        OPTIONAL,
(monitoring symbol within slot)
  nrofCandidates
  SEQUENCE {
(number of PDCCH candidates at each aggregation level)
    aggregationLevel1
  ENUMERATED {n0, n1, n2, n3, n4, n5, n6, n8},
    aggregationLevel2
  ENUMERATED {n0, n1, n2, n3, n4, n5, n6, n8},
    aggregationLevel4
  ENUMERATED {n0, n1, n2, n3, n4, n5, n6, n8},
    aggregationLevel8
  ENUMERATED {n0, n1, n2, n3, n4, n5, n6, n8},
    aggregationLevel16
  ENUMERATED {n0, n1, n2, n3, n4, n5, n6, n8}
  },
```

| | |
|---|---|
| searchSpaceType | CHOICE |

```
{
  (search space type)
    -- Configures this search space as common search space (CSS) and
DCI formats to monitor.
    common
  SEQUENCE {
  (common search space)
  }
    ue-Specific
  SEQUENCE {
  (UE-specific search space)
      -- Indicates whether the UE monitors in this USS for DCI
formats 0-0 and 1-0 or for formats 0-1 and 1-1.
      formats
    ENUMERATED {formats0-0-And-1-0, formats0-1-And-1-1},
      ...
    }
```

The BS may configure one or a plurality of search space sets in the UE according to configuration information. According to some embodiments, the BS may configure search space set 1 and search space 2 in the UE, and the configuration may be performed such that DCI format A scrambled by an X-RNTI in search space set 1 is monitored in the common search space and DCI format B scrambled by a Y-RNTI in search space set 2 is monitored in the UE-specific search space.

According to configuration information, one or a plurality of search space sets may exist in the common search space or the UE-specific search space. For example, search space set #1 and search space set #2 may be configured as common search spaces, and search space set #3 and search space set #4 may be configured as UE-specific search spaces.

In the common search space, the following combinations of DCI formats and RNTIs may be monitored. Of course, the disclosure is not limited to the following examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the following combinations of DCI formats and RNTIs may be monitored. Of course, the disclosure is not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The described RNTIs may follow the following definition and use.
Cell RNTI (C-RNTI): used for scheduling UE-specific PDSCH
Temporary Cell RNTI (TC-RNTI): used for UE-specific PDSCH scheduling
Configured Scheduling (CS)-RNTI: used for semi-statically configured UE-specific PDSCH scheduling
Random Access RNTI (RA-RNTI): used for PDSCH scheduling at random access stage
Paging RNTI (P-RNTI): used for PDSCH scheduling through which paging is transmitted
System Information RNTI (SI-RNTI): used for PDSCH scheduling through which system information is transmitted
Interruption RNTI (INT-RNTI): used for indicating whether puncturing is performed for PDSCH
Transmit Power Control for PUSCH RNTI (TPC-PUSCH-RNTI): used for indicating PUSCH power control command
Transmit Power Control for PUCCH RNTI (TPC-PUCCH-RNTI): used for indicating PUCCH power control command
Transmit Power Control for SRS RNTI (TPC-SRS-RNTI): used for indicating SRS power control command

The DCI formats may follow the following definition of Table 10.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

A control resource set p and a search space of an aggregation level L in a search space set s in a wireless communication system (for example, 5G or NR system) according to an embodiment of the disclosure may be expressed as Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: aggregation level
n_{Cl}: carrier index
N_{CCE,p}: total number of CCEs existing within control resource set p
n_{s,f}^{μ}: slot index
M_{s,max}^{(L)}: number of PDCCH candidates at aggregation level L
m_{s,n}_{_{Cl}}=0, . . . , M_{s,max}^{(L)}−1: PDCCH candidate index at aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-}1=n_{RNTI}≠0, Aₚ=39827 for pmod3=0, Aₚ=39829 for pmod3=1, Aₚ=39839 for pmod3=2, D=65537
n_{RNTI}: terminal identity

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI or ID configured for the UE by the base station) and the time index in the case of a UE-specific search space.

In a wireless communication system (for example, 5G or NR system) according to an embodiment of the disclosure, a set of search space sets monitored by the UE at every time point may vary as a plurality of search space sets can be configured as different parameters (for example, the parameters in Table 9). For example, when search space set #1 is configured on an X-slot period, search space set #2 is configured on a Y-slot period, and X and Y are different from each other, the UE may monitor all of search space set #1 and search space set #2 in a specific slot and monitor one of search space set #1 and search space set #2 in another specific slot.

### [PUCCH: Transmission Related]

In the NR system, a UE may transmit control information (UCI) to a base station through PUCCH. The control information may include at least one of HARQ-ACK indicating whether demodulation/decoding of a transport block (TB) received by the UE through PDSCH is successful, scheduling request (SR) requesting resource allocation to a PUSCH base station for uplink data transmission by the UE, and channel state information (CSI) which is information for reporting the channel status of the UE.

PUCCH resources may be largely divided into long PUCCH and short PUCCH depending on the length of the allocated symbol. In the NR system, long PUCCH has a length of 4 symbols or more within a slot, and short PUCCH has a length of 2 symbols or less within a slot.

To explain long PUCCH in more detail, long PUCCH may be used for the purpose of improving uplink cell coverage, and therefore may be transmitted in discrete Fourier transform-spread-OFDM (DFT-S-OFDM), which is a single carrier transmission method, rather than OFDM transmission. Long PUCCH supports transmission formats such as PUCCH format 1, PUCCH format 3, and PUCCH format 4 depending on the number of control information bits that may be supported and whether UE multiplexing is supported through Pre-DFT orthogonal cover code (OCC) support in front of inverse fast Fourier transform (IFFT).

First, PUCCH format 1 is a long PUCCH format based on DFT-S-OFDM that may support control information up to 2 bits and uses frequency resources of 1 RB. Control information may be composed of a combination of HARQ-ACK and SR or each of them. PUCCH format 1 is composed of OFDM symbols including a demodulation reference signal (or reference signal) (DMRS) and OFDM symbols including UCI repeatedly.

For example, when the number of transmission symbols of PUCCH format 1 is 8 symbols, it may be sequentially composed of DMRS symbol, UCI symbol, DMRS symbol, UCI symbol, DMRS symbol, UCI symbol, DMRS symbol, UCI symbol, DMRS symbol, UCI symbol in order from the first starting symbol of the 8 symbols. DMRS symbols may be spread using an orthogonal code (or an orthogonal sequence or a spreading code, wᵢ(m)) in the time axis in a sequence corresponding to the length of 1 RB in the frequency axis within one OFDM symbol, and transmitted after performing IFFT.

The UCI symbol may be transmitted after generating d(0) by modulating 1-bit control information with binary phase shift keying (BPSK) and 2-bit control information with quadrature phase shift keying (QPSK) by a UE, scrambling by multiplying the generated d(0) by a sequence corresponding to the length of 1 RB on the frequency axis, and spreading the scrambled sequence in the time axis by using an orthogonal code (or an orthogonal sequence or spreading code, wᵢ(m))), and performing IFFT by the UE.

The UE generates a sequence based on the group hopping configured through the upper-layer signaling or sequence hopping configuration and the configured ID from the base station, and cyclically shifts a sequence generated with an initial cyclic shift (CS) value configured through an upper signal to generate a sequence corresponding to the length of 1 RB.

$${w}_{i} ( m ) = {e}^{\frac{j 2 π ϕ ( m )}{{N}_{SF}}}$$

wᵢ(m)) is determined as when the length (NSF) of the spreading code is given, and is specifically given as in Table 11 below. The i means the index of the spreading code itself, and m means the index of the elements of the spreading code. Here, the numbers in [ ] in Table 11 mean φ(m), and for example, if the length of the spreading code is 2 and the index of the configured spreading code i=0, the spreading code wi (m) becomes wᵢ(0)=e^{j2π·0/N}^{_{SF}}, wᵢ(1)=e^{j2π·0/N}^{_{SF}}, so wᵢ(m)=[1 1].

TABLE 11
Spreading code wᵢ(m) = e^{j2πφ (m)/N}_{SF} for PUCCH format 1

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

Next, PUCCH format 3 is a long PUCCH format based on DFT-S-OFDM that may support control information exceeding 2 bits, and the number of RBs used may be configured through the upper layer. The control information may be composed of a combination of HARQ-ACK, SR, and CSI or each of them. In PUCCH format 3, the DMRS symbol locations are presented in Table 12 below depending on whether frequency hopping occurs within the slot and whether additional DMRS symbols are configured.

TABLE 12

| | Location of DMRS within PUCCH format 3/4 transmission | | | |
|---|---|---|---|---|
| PUCCH | Additional DMRS is not configured | | Additional DMRS is configured | |
| format 3/4 | Frequency | Frequency | Frequency | Frequency |
| transmission | hopping is not | hopping is | hopping is not | hopping is |
| length | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

For example, if the number of transmission symbols of PUCCH format 3 is 8 symbols, DMRS is transmitted to the first and fifth symbols, starting with 0 for the first starting symbol of 8 symbols. Table 12 is applied in the same way to the DMRS symbol locations of PUCCH format 4.

Next, PUCCH format 4 is a long PUCCH format based on DFT-S-OFDM that may support control information exceeding 2 bits, and uses 1 RB of frequency resources. The control information may be composed of a combination of HARQ-ACK, SR, and CSI or each of them. The difference between PUCCH format 4 and PUCCH format 3 is that PUCCH format 4 may multiplex PUCCH format 4 of multiple UEs within one RB. It is possible to multiplex PUCCH format 4 of multiple UEs by applying Pre-DFT Orthogonal Cover Code (OCC) to control information in the IFFT front end. However, the number of control information symbols that may be transmitted by one UE decreases depending on the number of UEs being multiplexed. The number of UEs that may be multiplexed, i.e., the number of different OCCs that may be used, may be 2 or 4, and the number of OCCs and the OCC index to be applied may be configured through the upper layer.

Next, a short PUCCH is described. The short PUCCH may be transmitted in both the downlink centric slot and uplink centric slot, and may generally be transmitted in the last symbol of the slot or the OFDM symbol at the back (e.g., the last OFDM symbol, the second-to-last OFDM symbol, or the last 2 OFDM symbols). Of course, the short PUCCH may be transmitted at an arbitrary location within the slot. In addition, the short PUCCH may be transmitted by using one OFDM symbol or two OFDM symbols. The short PUCCH may be used to shorten the delay time compared to the long PUCCH in situations where uplink cell coverage is good, and may be transmitted in the CP-OFDM method.

The short PUCCH may support transmission formats such as PUCCH format 0 and PUCCH format 2 depending on the number of control information bits that may be supported. First, PUCCH format 0 is a short PUCCH format that may support up to 2 bits of control information and uses frequency resources of 1 RB. Control information may be composed of a combination of HARQ-ACK and SR or each. PUCCH format 0 does not transmit DMRS and is structured to transmit only sequences mapped to 12 subcarriers in the frequency axis within one OFDM symbol. The UE may generate a sequence based on the group hopping configured through a upper signal from the base station or sequence hopping and the configured ID, and cyclically shift the sequence generated with the final CS value obtained by adding another CS value depending on whether it is ACK or NACK to the indicated initial CS (cyclic shift) value and map the same to 12 subcarriers for transmission.

For example, when the HARQ-ACK is 1 bit, if it is ACK, the UE may generate the final CS by adding 6 to the initial CS value, and if it is NACK, the UE may generate the final CS by adding 0 to the initial CS as shown in Table 13 below. The CS value 0 for NACK and the CS value 6 for ACK are defined in the standard, and the UE may transmit 1-bit HARQ-ACK by generating PUCCH format 0 according to the values defined in the standard.

TABLE 13

| 1-bit HARQ-ACK | NACK | ACK |
|---|---|---|
| Final CS | (Initial CS + 0) | (Initial CS + 6) |
| | mod 12 = Initial CS | mod 12 |

For example, when HARQ-ACK is 2 bits, the UE adds 0 to the initial CS value if (NACK, NACK), 3 to the initial CS value if (NACK, ACK), 6 to the initial CS value if (ACK, ACK), and 9 to the initial CS value if (ACK, NACK) as shown in Table 14 below. The CS value 0 for (NACK, NACK), the CS value 3 for (NACK, ACK), the CS value 6 for (ACK, ACK), and the CS value 9 for (ACK, NACK) are defined in the standard, and the UE may generate PUCCH format 0 according to the values defined in the standard to transmit 2-bit HARQ-ACK. If the final CS value exceeds 12 due to the CS value added to the initial CS value according to ACK or NACK, modulo 12 may be applied to the final CS value since the length of the sequence is 12.

TABLE 14

| 2-bit HARQ-ACK | NACK, NACK | NACK, ACK | ACK, ACK | ACK, NACK |
|---|---|---|---|---|
| Final CS | (Initial CS + 0) | (Initial CS + 3) | (Initial CS + 6) | (Initial CS + 9) |
| | mod 12 = Initial CS | mod 12 | mod 12S | mod 12 |

Next, PUCCH format 2 is a short PUCCH format that may support control information exceeding 2 bits, and the number of RBs used may be configured through the upper layer. The control information may be composed of a combination of HARQ-ACK, SR, and CSI or each of them. When the index of the first subcarrier is #0, PUCCH format 2 may be fixed to the subcarrier with indices of #1, #4, #7, and #10 in which the DMRS is transmitted within one OFDM symbol. Control information may be mapped to the remaining subcarriers except for the subcarrier where the DMRS is located through a modulation process after channel encoding.

In summary, the values and their ranges that may be configured for each PUCCH format described above may be organized as shown in Table 15 below. In Table 15, cases where a value does not need to be configured are indicated as N.A.

TABLE 15

| | | PUCCH | PUCCH | PUCCH | PUCCH | PUCCH |
|---|---|---|---|---|---|---|
| | | Format 0 | Format 1 | Format 2 | Format 3 | Format 4 |
| Starting | Configurability | √ | √ | √ | √ | √ |
| symbol | Value range | 0-13 | 0-10 | 0-13 | 0-10 | 0-10 |
| Number of | Configurability | √ | √ | √ | √ | √ |
| symbols | Value range | 1, 2 | 4-14 | 1, 2 | 4-14 | 4-14 |
| in a slot | | | | | | |
| Index for | Configurability | √ | √ | √ | √ | √ |
| identifying | Value range | 0-274 | 0-274 | 0-274 | 0-274 | 0-274 |
| starting PRB | | | | | | |
| Number | Configurability | N.A. | N.A. | √ | √ | N.A. |
| of PRBs | Value range | N.A. | N.A. | 1-16 | 1-6, 8-10, | N.A. |
| | | (Default | (Default | | 12, 15, 16 | (Default |
| | | is 1) | is 1) | | | is 1) |
| Enabling | Configurability | √ | √ | √ | √ | √ |
| a FH | Value range | On/Off | On/Off | On/Off | On/Off | On/Off |
| | | (only for | | (only for | | |
| | | 2 symbol) | | 2 symbol) | | |
| Freq. cy | Configurability | √ | √ | √ | √ | √ |
| resource | Value range | 0-274 | 0-274 | 0-274 | 0-274 | 0-274 |
| of 2^{nd} hop | | | | | | |
| if FH is | | | | | | |
| enabled | | | | | | |
| Index of | Configurability | √ | √ | N.A. | N.A. | N.A. |
| initial | Value range | 0-11 | 0-11 | N.A. | 0-11 | 0-11 |
| cyclic shift | | | | | | |
| Index of | Configurability | N.A. | √ | N.A. | N.A. | N.A. |
| time-domain | Value range | N.A. | 0-6 | N.A. | N.A. | N.A. |
| OCC | | | | | | |
| Length of | Configurability | N.A. | N.A. | N.A. | N.A. | √ |
| Pre-DFT OCC | Value range | N.A. | N.A. | N.A. | N.A. | 2, 4 |
| Index of | Configurability | N.A. | N.A. | N.A. | N.A. | √ |
| Pre-DFT OCC | Value range | N.A. | N.A. | N.A. | N.A. | 0, 1, 2, 3 |

Meanwhile, in order to improve uplink coverage, multi-slot repetition may be supported for PUCCH formats 1, 3, and 4, and PUCCH repetition may be configured for each PUCCH format. The UE may perform repeated transmission for PUCCH including UCI as many slots as the number of slots configured through nrofSlots which is the upper-layer signaling. For PUCCH repeated transmission, PUCCH transmission of each slot is performed by using the same number of consecutive symbols, and the corresponding number of consecutive symbols may be configured through nrofSymbols in the upper-layer signaling PUCCH-format1, PUCCH-format3 or PUCCH-format4. For PUCCH repeated transmission, PUCCH transmission of each slot is performed by using the same starting symbol, and the corresponding starting symbol may be configured through startingSymbolIndex in upper-layer signaling PUCCH-format 1 or PUCCH-format 3 or PUCCH-format 4. For PUCCH repeated transmission, a single PUCCH-spatialRelationInfo may be configured for a single PUCCH resource. For PUCCH repeated transmission, if the UE is configured to perform frequency hopping in PUCCH transmissions in different slots, the UE may perform frequency hopping in units of slots. In addition, if the UE is configured to perform frequency hopping in PUCCH transmissions in different slots, the UE may start PUCCH transmission from the first PRB index configured through startingPRB which is the upper-layer signaling in even slots, and may start PUCCH transmission from the second PRB index configured through secondHopPRB which is the upper-layer signaling in odd slots. In addition, if the UE is configured to perform frequency hopping in PUCCH transmissions in different slots, the index of the slot in which the first PUCCH transmission is indicated to the UE is 0, and the PUCCH repeated transmission count value may increase regardless of PUCCH transmission performance in each slot during the configured total number of PUCCH repeated transmissions. If the UE is configured to perform frequency hopping in PUCCH transmissions in different slots, the UE does not expect frequency hopping to be configured within the slot when transmitting PUCCH. If the UE is not configured to perform frequency hopping in PUCCH transmissions in different slots, but is configured to perform frequency hopping within a slot, the first and second PRB indices may be applied equally within the slot. If the number of uplink symbols that may transmit PUCCH is smaller than nrofSymbols configured through upper-layer signaling, the UE may not transmit PUCCH. Even if the UE fails to transmit PUCCH in a slot for any reason during PUCCH repeated transmission, the UE may increase the number of PUCCH repeated transmissions.

In NR Release 17, the number of slots repeatedly transmitted for each PUCCH resource in PUCCH-ResourceExt, which is an extension of PUCCH-Resource that is the upper-layer signaling for PUCCH resources, may be configured through the upper-layer signaling pucch-RepetitionNrofSlots-r17. If the corresponding upper-layer signaling pucch-RepetitionNrofSlots-r17 is configured, the corresponding PUCCH resource is scheduled, and the upper-layer signaling nrofSlots is also configured, the UE determines the number of slots repeatedly transmitted for the corresponding PUCCH resource through pucch-RepetitionNrofSlots-r17 and ignores the upper-layer signaling nrofSlots.

### [PUCCH: Transmission Power Related]

As an example of an embodiment of the disclosure, when uplink control information is transmitted through a physical uplink control channel (PUCCH) in response to a power control command received from a base station, a method for a UE to configure and transmit the transmission power of the uplink control channel is described. The uplink control channel transmission power (P_{PUCCH}) of the UE together with the PUCCH power control adjustment state corresponding to the i^{th} transmission unit and the closed-loop index l may be determined as shown in the following Equation 2, which is expressed in dBm units. In the following Equation 2, when the UE supports multiple carrier frequencies in multiple cells, each parameter may be determined separately for the primary cell c, the carrier frequency f, and the bandwidth part b, and may be distinguished by the indices b, f, and c.

$${P}_{PUCCH , b , f , c} ( i , {q}_{u} , {q}_{d} , l ) = \qquad Equation 2$$

$$min \{ \begin{matrix}{P}_{CMAX , f , c} ( i ) , \\ \begin{matrix}{P}_{0 \_ PUCCH , b , f , c} ( {q}_{u} ) + 10 {log}_{10} ( {2}^{μ} * {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {f}_{b , f , c} ( i , l )\end{matrix}\end{matrix} \} [ dBm ]$$

P_{CMAX,f,c}(i): The maximum transmission power available to the UE in the i^{th} transmission unit, which is determined by the power class of the UE, parameters activated by the base station, and various parameters embedded in the UE.
P_{0_PUCCH,b,f,c}(qᵤ): P_{0_PUCCH,b,f,c}(qᵤ) may be composed of the sum of P_{0_NOMINAL_PUCCH} and P_{0_UE_PUCCH}(qᵤ). P_{0_NOMINAL_PUCCH} is a cell-specific value, which is configured through the cell-specific upper-layer signaling p0-nominal, and if there is no corresponding configuration, P_{0_NOMINAL_PUCCH} may be 0 dBm. P_{0_UE_PUCCH}(qᵤ) is a UE-specific value, configured through p0-PUCCH-Value in the upper-layer signaling p0-PUCCH in the bandwidth part b, carrier frequency f, and the primary cell c, and qᵤ may be a value greater than or equal to 0 and less than qᵤ, and qᵤ may mean the size of the set of P_{0_UE_PUCCH} values and may be configured through the upper-layer signaling maxNrofPUCCH-P0-PerSet. The set of P_{0_UE_PUCCH} values may be configured through the upper-layer signaling p0-Set, and if there is no corresponding configuration, it may be regarded as

$${P}_{{0}_{{UE}_{PUCCH}}} ( {q}_{u} ) = 0.$$

μ: Subcarrier spacing configuration value
M_{RB,b,f,c}^{PUCCH}(i): It may mean the amount of resources (e.g., the number of resource blocks (RBs) used for PUCCH transmission on the frequency axis) used in the
i^{th} PUCCH transmission unit within the bandwidth part b, carrier frequency f, and primary cell c.
PL_{b,f,c}(q_{d}): Pathloss indicating the pathloss between the base station and the UE, and the UE calculates the pathloss from the difference between the transmission power of the reference signal (RS) resource q_{d} signaled by the base station and the UE's reception signal level of the reference signal.
Δ_{F_PUCCH}(F): For PUCCH format 0, if deltaF-PUCCH-f0, which is a upper-layer signaling, is configured, the corresponding value is used, for PUCCH format 1, if deltaF-PUCCH-f1, which is a upper-layer signaling, is configured, the corresponding value is used, for PUCCH format 2, if deltaF-PUCCH-f2, which is a upper-layer signaling, is configured, the corresponding value is used, for PUCCH format 3, if deltaF-PUCCH-f3, which is a upper-layer signaling, is configured, the corresponding value is used, for PUCCH format 4, if deltaF-PUCCH-f4, which is a upper-layer signaling, is configured, the corresponding value is used, and for all PUCCH formats, if no upper-layer signaling is configured, 0 may be used.
Δ_{TF,b,f,c}(i): A PUCCH transmission power adjustment factor within the bandwidth part b, carrier frequency f, and primary cell c, which may use different calculation methods depending on the PUCCH format.
g_{b,f,c}(i,l): It may mean a PUCCH power control adjustment state value for the i^{th} PUCCH transmission unit corresponding to the closed-loop index l within the bandwidth part b, carrier frequency f, and primary cell c. Here, the closed loop power adjustment for PUCCH transmission may use an accumulation method that accumulates and applies the value indicated by the TPC command.

The PUCCH power control adjustment state g_{b,f,c}(i,l) may be determined through the bandwidth part b, carrier frequency f, and primary cell c, the i^{th} transmission unit, and the closed-loop index l.
δ_{PUCCH,b,f,c}(i,l): It may be a value indicated by a TPC command field included in DCI format 1_0, 1_1 or 1_2 that schedules the i^{th} PUCCH transmission unit corresponding to the closed-loop index l and PDSCH reception within the bandwidth part b, carrier frequency f, and primary cell c, or a value indicated by a TPC command field included in DCI format 2_2 transmitted together with a CRC scrambled with TPC-PUCCH-RNTI.
If the UE is configured with twoPUCCH-PC-AdjustmentStates and PUCCH-SpatialRelationInfo, which are upper-layer signaling, the closed-loop index l may have a value of 0 or 1.
If the UE is not configured with twoPUSCH-PC-AdjustmentStates or PUCCH-SpatialRelationInfo, which are upper-layer signaling, the closed-loop index l may have a value of 0.
If the UE obtains the TPC command value through the TPC command field included in the DCI format 1_0, 1_1, or 1_2 that schedules PDSCH reception, and the UE is configured with PUCCH-SpatialRelationInfo, which is a upper-layer signaling, the UE may obtain the connection relationship between the pucch-SpatialRelationInfold value and the closedLoopIndex value that configures the closed-loop index l value based on the index that may be configured through p0-PUCCH-Id, which is a upper-layer signaling. If the UE receives a MAC-CE corresponding to pucch-SpatialRelationInfold, the UE may determine the closedLoopIndex value that configures the closed-loop index l value based on the corresponding p0-PUCCH-Id index.
If the UE obtains one TPC command value from the TPC command field included in the DCI format 2_2 transmitted with the CRC scrambled with TPC-PUCCH-RNTI, the 1 value may be obtained based on the closed-loop index field included in the DCI format 2_2.
In the bandwidth part b, carrier frequency f, and primary cell c, the PUCCH power control adjustment state g_{b,f,c}(i,l) for the i^{th} PUCCH transmission unit corresponding to the closed-loop index l may be calculated as in Equation 3.

$${g}_{b , f , c} ( i , l ) = {g}_{b , f , c} ( i - {i}_{0} , l ) + {\sum }_{m = 0}^{c ( {C}_{i} ) - 1} {δ}_{PUCCH , b , f , c} ( m , l ) \qquad Equation 3$$

As described above, δ_{PUCCH,b,f,c}(m,l) may be a value indicated by a TPC command field included in DCI format 1_0, 1_1 or 1_2 that schedules the m^{th} PUCCH transmission unit and PDSCH reception corresponding to the closed-loop index l within the bandwidth part b, carrier frequency f, and primary cell c, or a value indicated by a TPC command field included in DCI format 2_2 transmitted together with a CRC scrambled with TPC-PUCCH-RNTI. When TPC command accumulation operation is possible, the δ_{PUCCH,b,f,c} value may have a corresponding value in [dB] units depending on which value the TPC command field included in DCI format 1_0, 1_1, 1_2 or 2_2 is indicated as in Table 18. As an example, if the value of the TPC command field is 0, δ_{PUCCH,b,f,c} may have a value of −1 dB.
Σₘ₌₀^{c(C}^{ᵢ}⁾⁻¹δ_{PUCCH, b,f,c}(m,l) may mean the sum of δ_{PUCCH,b,f,c} for all transmission units corresponding to the above-described TPC command value within a specific set Cᵢ. In this case, c(Cᵢ) may mean the number of all elements belonging to the set Cᵢ. Cᵢ may mean a set of DCIs including all TPC command values for performing TPC command accumulation operation for the i^{th} PUCCH transmission unit. In order to determine Cᵢ, a start point and an end point may be defined in the time dimension, and all DCIs received by the UE within the two points may be included as elements of Cᵢ.

The end point for determining Cᵢ may be a point that is K_{PUCCH}(i) symbols earlier than the starting symbol of the i^{th} PUCCH transmission unit.

The start point for determining Cᵢ may be a point that is K_{PUCCH}(i−i₀)−1 symbols earlier than the starting symbol of the i−i₀^{th} PUCCH transmission unit. In this case, i₀, which is a positive integer, may be determined as the smallest value satisfying that the time point that is K_{PUCCH}(i−i₀) symbols earlier than the end point (a point prior to K_{PUCCH}(i) symbols from the starting symbol of the i^{th} PUCCH transmission unit) for determining Cᵢ is a time point that is earlier in time than the starting symbol of the i−i₀^{th} PUCCH transmission unit.

As an example, when the end point for determining Cᵢ may be defined as sym(i), and the time point prior to K_{PUCCH}(i−i₀) symbols from the starting symbol of the i−i₀^{th} PUCCH transmission unit may be defined as sym(i−i₀), if sym(i)=sym(i−1)>sym(i−2)>sym(i−3) holds, i₀ may be determined as 2.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 16 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 16 through upper signaling. If PUSCH transmission is operated by a configured grant, parameters applied to the PUSCH transmission are applied through configuredGrantConfig (upper signaling) in Table 16 except for dataScramblingIdentityPUSCH, txConfig, codebookSubset, maxRank, and scaling of UCI-OnPUSCH, which are provided by pusch-Config (upper signaling) in Table 17. If provided with transformPrecoder inside configuredGrantConfig (upper signaling) in Table 16, the UE applies tp-pi2BPSK inside pusch-Config in Table 17 to PUSCH transmission operated by a configured grant.

TABLE 16

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14, sym2560x14,

sym5120x14,

sym6, sym1x12, sym2x12, sym4x12, sym5x12, sym8x12,

sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks−1) | OPTIONAL, -- Need R |
| pathlossReferenceIndex | INTEGER (0..maxNrofPUSCH- |

PathlossReferenceRSs−1),
...

| | |
|---|---|
| } | OPTIONAL, -- |

Need R
...
}

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 17, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 30, the UE does not expect scheduling through DCI format 0_1.

TABLE 17

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig |
| } | OPTIONAL, -- Need M |
| dmrs-UplinkForPUSCH-MappingTypeB | SetupRelease { DMRS-UplinkConfig |
| } | OPTIONAL, -- Need M |
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks−1)

OPTIONAL, --

Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent,nonCoherent}

OPTIONAL, -- Cond

codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be indicated through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI is used to indicate a precoder to be applied to PUSCH transmission. If one SRS resource is configured for the UE, the TPMI is used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent” as UE capability, the UE does not expect that the value of codebookSubset (upper signaling) will be configured as “fullyAndPartialAndNonCoherent”. In addition, if the UE reported “nonCoherent” as UE capability, UE does not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE transmits, to the base station, one or multiple SRS resources included in the SRS resource set wherein the value of usage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected non-zero power CSI-RS (NZP CSI-RS) resource may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

[PUSCH: Transmission power related]

As an example of an embodiment of the disclosure, when uplink data is transmitted through a physical uplink shared channel (PUSCH) in response to a power control command received from a base station, a method for a UE to configure and transmit the transmission power of the uplink shared channel is described. The uplink shared channel transmission power of the UE together with the PUSCH power control adjustment state corresponding to the i^{th} transmission unit, parameter set configuration index j, and the closed-loop index l may be determined as shown in the following Equation 4, which is expressed in dBm units. In the following Equation 4, when the UE supports multiple carrier frequencies in multiple cells, each parameter may be determined separately for the cell c, the carrier frequency f, and the bandwidth part b, and may be distinguished by the indices b, f, and c.

$${P}_{PUSCH , b , f , c} ( i , j , {q}_{d} , l ) = \qquad Equation 4$$

$$min \{ \begin{matrix}{P}_{CMAX , f , c} ( i ) , \\ \begin{matrix}{P}_{0 \_ PUSCH , b , f , c} ( j ) + 10 {log}_{10} ( {2}^{μ} * {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \}$$

P_{CMAX,f,c}(i): The maximum transmission power available to the UE in the i^{th} transmission unit, which is determined by the power class of the UE, parameters activated by the base station, and various parameters embedded in the UE.
P_{0_PUSCH,b,f,c}(j): P_{0_PUSCH,b,f,c}(j) is composed of the sum of P_{0_NOMINAL_PUSCH,f,c}(j) and P_{0_UE_PUSCH,b,f,c}(j). P_{0_NOMINAL_PUSCH,f,c}(j) is a value configured to the UE through cell-specific upper-layer signaling, and P_{0_UE_PUSCH,b,f,c}(j) is a value configured to the UE through UE-specific upper-layer signaling. Here, when j=0, it means a PUSCH for transmitting msg3, when j=1, it means a configured grant PUSCH, and when j is one of the values of {2, . . . , J−1}, it means a grant PUSCH.
ρ: Subcarrier spacing configuration value
M_{RB,b,f,c}^{PUSCH}(i): It may mean the amount of resources (e.g., the number of resource blocks (RBs) used for PUCCH transmission on the frequency axis) used in the i^{th} PUSCH transmission unit.
α_{b,f,c}(j): It means a value that may be determined (in case of dynamic grant PUSCH) through the upper-layer configuration and SRS resource indicator (SRI) as a value to compensate for pathloss.
PL_{b,f,c}(q_{d}): Pathloss indicating the pathloss between the base station and the UE, and the UE calculates the pathloss from the difference between the transmission power of the reference signal (RS) resource q_{d} signaled by the base station and the UE's reception signal level of the reference signal. PL_{b,f,c}(q_{d}) means a downlink pathloss estimate estimated by the UE through a reference signal having a reference signal index of q_{d}, and the reference signal index q_{d} may be determined by the UE through the upper-layer configuration and SRI (in the case of a dynamic grant PUSCH or a configured grant PUSCH (type 2 configured grant PUSCH) based on ConfiguredGrantConfig that does not include the upper-layer configuration rrc-ConfiguredUplinkGrant) or through the upper-layer configuration.
Δ_{TF,b,f,c}(i): It means a value determined by the modulation coding scheme (MCS) and the format (TF: transport format, e.g., whether UL-SCH is included or CSI is included, etc.) of the information transmitted on the PUSCH.
f_{b,f,c}(i,l): It means a closed-loop power control adjustment value that means a value for a closed-loop index l that may be determined by the upper-layer configuration and SRI for PUSCH. Here, closed-loop power adjustment for PUSCH transmission may be supported by dividing into an accumulation method that applies the value indicated by the TPC command by accumulating the value and an absolute method that applies the value indicated by the TPC command directly, and may be determined depending on whether the upper-layer parameter tpc-Accumulation is configured. If the upper-layer parameter tpc-Accumulation is configured to disabled, closed-loop power adjustment for PUSCH transmission is performed by the absolute method, and if tpc-Accumulation is not configured, closed-loop power adjustment for PUSCH transmission is performed by the accumulation method.

The PUSCH power control adjustment state f_{b,f,c}(i,l) may be determined through the bandwidth part b, carrier frequency f, and cell c, the i^{th} transmission unit, and the closed-loop index l.
δ_{PUSCH,b,f,c}(i,l): It may be a value indicated by a TPC command field included in DCI format 0_0, 0_1 or 0_2 that schedules the i^{th} PUSCH transmission unit corresponding to the closed-loop index l within the bandwidth part b, carrier frequency f, and cell c, or a value indicated by a TPC command field included in DCI format 2_2 transmitted together with a CRC scrambled with TPC-PUCCH-RNTI.
If the UE is configured with twoPUSCH-PC-AdjustmentStates, which is a upper-layer signaling, the closed-loop index l may have a value of 0 or 1.
If the UE is not configured with twoPUSCH-PC-AdjustmentStates, which is a upper-layer signaling or scheduled with PUSCH transmission based on RAR UL grant, the closed-loop index l may have a value of 0.

If the UE is configured with ConfiguredGrantConfig, which is a upper layer signaling, and performs PUSCH transmission or retransmission for accordingly, the closed-loop index l may follow the powerControlLoopToUse value, which is a upper-layer signaling.

If the UE is configured with SRI-PUSCH-PowerControl, which is a upper-layer signaling, the UE may obtain a connection relationship between the value indicated by the SRS resource indicator (SRI) field in the DCI format that schedules PUSCH transmission and the closed-loop index l configured through the upper-layer signaling sri-PUSCH-ClosedLoopIndex, and determine the closed-loop index l based on the value indicated by the SRI field in the DCI format based on the corresponding connection relationship.

If the UE is scheduled for PUSCH transmission based on a DCI format that does not include the SRI field, or is not configured with the upper-layer signaling SRI-PUSCH-PowerControl, the UE may consider the closed-loop index l as 0.

If the UE is indicated with the TPC command value through the TPC command field included in the DCI format 2_2 transmitted with the CRC scrambled with TPC-PUSCH-RNTI, the closed-loop index l may be indicated through the closed-loop index field included in the DCI format 2_2.
If the UE is not configured with the upper-layer signaling tpc-Accumulation, i.e., if the TPC command accumulation operation is possible for the UE, the PUSCH power control adjustment state f_{b,f,c}(i,l) for the i^{th} PUSCH transmission unit corresponding to the closed loop index l in the bandwidth part b, carrier frequency f, and cell c may be calculated as in Equation 5.

$${f}_{b , f , c} ( i , l ) = {f}_{b , f , c} ( i - {i}_{0} , l ) + {\sum }_{m = 0}^{c ( {D}_{i} ) - 1} {δ}_{PUSCH , b , f , c} ( m , l ) \qquad Equation 5$$

As described above, δ_{PUSCH,b,f,c}(m,l) may be a value indicated by a TPC command field included in DCI format 0_0, 0_1 or 0_2 that schedules the m^{th} PUSCH transmission unit corresponding to the closed-loop index l within the bandwidth part b, carrier frequency f, and cell c, or a value indicated by a TPC command field included in DCI format 2_2 transmitted together with a CRC scrambled with TPC-PUCCH-RNTI. When TPC command accumulation operation is possible, the δ_{PUSCH,b,f,c} value may have a corresponding value in [dB] units depending on which value the TPC command field included in DCI format 0_0, 0_1, 0_2 or 2_2 is indicated as in Table 18. As an example, if the value of the TPC command field is 0, 8PUSCH,b,f,c may have a value of −1 dB.
Σₘ₌₀^{c(D}^{ᵢ}⁾⁻¹δ_{PUCCH, b,f,c}(m,l) may mean the sum of δ_{PUSCH,b,f,c} for all transmission units corresponding to the above-described TPC command value within a specific set Dᵢ. In this case, c(Dᵢ) may mean the number of all elements belonging to the set Dᵢ. Dᵢ may mean a set of DCIs including all TPC command values for performing TPC command accumulation operation for the i^{th} PUSCH transmission unit. In order to determine Dᵢ, a start point and an end point may be defined in the time dimension, and all DCIs received by the UE within the two points may be included as elements of Dᵢ.

The end point for determining Dᵢ may be a point that is K_{PUSCH}(i) symbols earlier than the starting symbol of the i^{th} PUSCH transmission unit.

The start point for determining Dᵢ may be a point that is K_{PUCCH}(i−i₀)−1 symbols earlier than the starting symbol of the i−i₀^{th} PUSCH transmission unit. In this case, i₀, which is a positive integer, may be determined as the smallest value satisfying that the time point that is K_{PUSCH}(i−i₀) symbols earlier than the end point (a point prior to K_{PUSCH}(i) symbols from the starting symbol of the i^{th} PUSCH transmission unit) for determining Dᵢ is a time point that is earlier in time than the starting symbol of the i−i₀^{th} PUSCH transmission unit.

As an example, when the end point for determining Dᵢ may be defined as sym(i), and the time point prior to K_{PUSCH}(i−i₀) symbols from the starting symbol of the i−i₀^{th} PUSCH transmission unit may be defined as sym(i−i₀), if sym(i)=sym(i−1)>sym(i−2)>sym(i−3) holds, i₀ may be determined as 2.
If the UE is configured with the upper-layer signaling tpc-Accumulation, i.e., if the TPC command accumulation operation is impossible for the UE, the PUSCH power control adjustment state f_{b,f,c}(i,l) for the i^{th} PUSCH transmission unit corresponding to the closed loop index l in the bandwidth part b, carrier frequency f, and cell c may be calculated as in Equation 6.

f_{b,f,c}(i,l)=δ_{PUSCH,b,f,c}(i,l) Equation 6
As described above, δ_{PUSCH,b,f,c}(m,l) may be a value indicated by a TPC command field included in DCI format 0_0, 0_1 or 0_2 that schedules the i^{th} PUSCH transmission unit corresponding to the closed-loop index l within the bandwidth part b, carrier frequency f, and cell c, or a value indicated by a TPC command field included in DCI format 2_2 transmitted together with a CRC scrambled with TPC-PUCCH-RNTI. When TPC command accumulation operation is impossible, the δ_{PUSCH,b,f,c} value may have a corresponding value in [dB] units depending on which value the TPC command field included in DCI format 0_0, 0_1, 0_2 or 2_2 is indicated as in Table 18. As an example, if the value of the TPC command field is 0, δ_{PUSCH,b,f,c} may have a value of −4 dB.

TABLE 18

| TPC command | Accumulated | Absolute |
|---|---|---|
| field | δ_{PUSCH, b, f, c}[dB] | δ_{PUSCH, b, f, c}[dB] |
| 0 | −1 | −4 |
| 1 | 0 | −1 |
| 2 | 1 | 1 |
| 3 | 3 | 4 |

### [Regarding SRS]

Next, an uplink channel estimation method using sounding reference signal (SRS) transmission of a UE will be described. The base station may configure at least one SRS configuration with regard to each uplink BWP in order to transfer configuration information for SRS transmission to the UE, and may also configure as least one SRS resource set with regard to each SRS configuration. As an example, the base station and the UE may exchange upper signaling information as follows, in order to transfer information regarding the SRS resource set.
srs-ResourceSetId: an SRS resource set index
srs-ResourceIdList: a set of SRS resource indices referred to by SRS resource sets
resourceType: time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.
usage: a configuration regarding the place of use of SRS resources referred to by SRS resource sets, and may be configured as one of “beamManagement”, “codebook”, “nonCodebook”, and “antennaSwitching”.
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive upper layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. The individual configuration information regarding SRS resources may include time domain transmission configuration of SRS resources, and may be configured as one of “periodic”, “semi-persistent”, and “aperiodic”. The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (for example, periodicityAndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through upper layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource follows resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. In addition, the minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time. In addition, if the place of use of the SRS resource set is configured as “codebook” or “antennaSwitching” in view of the place of use of the SRS resource set including the transmitted SRS resource, the minimum time interval may be determined as N2 symbols, and if the place of use of the SRS resource set is configured as “nonCodebook” or “beamManagement”, the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 19

| | |
|---|---|
| SRS-Resource ::= | SEQUENCE { |
| srs-ResourceId | , |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, |

sequenceHopping },

| | |
|---|---|
| resourceType | CHOICE { |
| aperiodic | SEQUENCE { |

```
      ...
    },
```

| | |
|---|---|
| semi-persistent | SEQUENCE { |
| periodicityAndOffset-sp | SRS-PeriodicityAndOffset, |

```
      ...
    },
```

| | |
|---|---|
| periodic | SEQUENCE { |
| periodicityAndOffset-p | SRS-PeriodicityAndOffset, |

```
      ...
    }
  },
```

| | |
|---|---|
| sequenceId | INTEGER (0..1023), |
| spatialRelationInfo | SRS-SpatialRelationInfo |

OPTIONAL, -- Need R
...
}

Configuration information spatialRelationInfo in Table 19 above is applied, with reference to one reference signal, to a beam used for SRS transmission corresponding to beam information of the corresponding reference signal. For example, configuration of spatialRelationInfo may include information as in Table 20 below.

TABLE 20

| | |
|---|---|
| SRS-SpatialRelationInfo ::= | SEQUENCE { |
| servingCellId | ServCellIndex OPTIONAL, -- Need S |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

Referring to the above-described spatialRelationInfo configuration, an SS/PBCH block index, CSI-RS index, or SRS index may be configured as the index of a reference signal to be referred to in order to use beam information of a specific reference signal. Upper signaling referenceSignal corresponds to configuration information indicating which reference signal's beam information is to be referred to for corresponding SRS transmission, ssb-Index refers to the index of an SS/PBCH block, csi-RS-Index refers to the index of a CSI-RS, and srs refers to the index of an SRS. If upper signaling referenceSignal has a configured value of “ssb-Index”, the UE may apply the reception beam which was used to receive the SS/PBCH block corresponding to ssb-Index as the transmission beam for the corresponding SRS transmission. If upper signaling referenceSignal has a configured value of “‘csi-RS-Index”, the UE may apply the reception beam which was used to receive the CSI-RS corresponding to csi-RS-Index as the transmission beam for the corresponding SRS transmission. If upper signaling referenceSignal has a configured value of “‘srs”, the UE may apply the reception beam which was used to transmit the SRS corresponding to srs as the transmission beam for the corresponding SRS transmission.

### [SRS Transmission Power Related]

As an example of an embodiment of the disclosure, when transmitting a uplink sounding reference signal (SRS) in response to a power control command received from a base station, a method for a UE to configure and transmit the transmission power of the uplink sounding reference signal is described. The uplink sounding reference signal transmission power (P_{SRS}) of the UE together with the SRS power control adjustment state corresponding to the i^{th} transmission unit and the closed-loop index l may be determined as shown in the following Equation 7, which is expressed in dBm units. In the following Equation 7, when the UE supports multiple carrier frequencies in multiple cells, each parameter may be determined separately for the cell c, the carrier frequency f, and the bandwidth part b, and may be distinguished by the indices b, f, and c.

$${P}_{SRS , b , f , c} ( i , {q}_{s} , l ) = \qquad Equation 7$$

$$min \{ \begin{matrix}{P}_{CMAX , f , c} ( i ) , \\ \begin{matrix}{P}_{0 \_ SRS , b , f , c} ( {q}_{s} ) + 10 {log}_{10} ( {2}^{μ} * {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} [ dBm ]$$

P_{CMAX,f,c}(i): The maximum transmission power available to the UE in the i^{th} transmission unit, which is determined by the power class of the UE, parameters activated by the base station, and various parameters embedded in the UE.
P_{0_SRS,b,f,c}(qₛ): it may be configured to p0, which is a upper-layer signaling for bandwidth part b, carrier frequency f, and cell c, and SRS resource set qₛ may be configured through SRS-ResourceSet and SRS-ResourceSetId, which are upper-layer signaling.
μ: Subcarrier spacing configuration value
M_{SRS,b,f,c}(i): It may mean the amount of resources (e.g., the number of resource blocks (RBs) used for SRS transmission on the frequency axis) used in the i^{th} SRS transmission unit.
α_{SRS,b,f,c}(j): It may be configured to alpha, which is a upper-layer signaling for bandwidth part b, carrier frequency f, and cell c, and SRS resource set qₛ may be configured through upper layer signaling SRS-ResourceSet and SRS-ResourceSetId.
PL_{b,f,c}(q_{d}): Pathloss indicating the pathloss between the base station and the UE, and the UE calculates the pathloss from the difference between the transmission power of the reference signal (RS) resource q_{d} signaled by the base station and the UE's reception signal level of the reference signal.
h_{b,f,c}(i,l): It may mean an SRS power control adjustment state value for the i^{th} SRS transmission unit corresponding to the closed-loop index l within the bandwidth part b, carrier frequency f, and cell c.

The SRS power control adjustment state may be determined through the bandwidth part b, carrier frequency f, cell c, and the i^{th} transmission unit.
If the UE is configured to have the same power control adjustment state value between the SRS transmission and the PUSCH transmission through the upper-layer signaling srs-PowerControlAdjustmentStates, the SRS power control adjustment state may be expressed as in Equation 8 below, and in Equation 8, f_{b,f,c}(i,l) may mean the current PUSCH power control adjustment state. In this case, f_{b,f,c}(i,l) may be calculated through various methods of the above-described embodiment 1, and the value may be substituted into h_{b,f,c}(i,l) and used.

$${h}_{b , f , c} ( i , l ) = {f}_{b , f , c} ( i , l ) \qquad Equation 8$$

If the UE is not configured for PUSCH transmission in bandwidth part b, carrier frequency f, and cell c, or configured to have separate power control adjustment state values between SRS transmission and PUSCH transmission through the upper-layer signaling srs-PowerControlAdjustmentStates, and not configured with the upper-layer signaling tpc-Accumulation, the SRS power control adjustment state may be expressed regardless of the closed loop/as in Equation 9 below.

$${h}_{b , f , c} ( i ) = {h}_{b , f , c} ( i - {i}_{0} ) + {\sum }_{m = 0}^{c ( {S}_{i} ) - 1} {δ}_{SRS , b , f , c} ( m ) \qquad Equation 9$$

δ_{SRS,b,f,c}(m): It may be a value indicated by the TPC command field included in DCI format 2_3, and the value may follow Table 18.
Σₘ₌₀^{c(S}^{ᵢ}⁾⁻¹δ_{PUCCH, b,f,c}(m) may mean the sum of δ_{SRS,b,f,c} for all transmission units corresponding to the above-described TPC command value within a specific set Sᵢ. In this case, c(Sᵢ) may mean the number of all elements belonging to the set Sᵢ. Sᵢ may mean a set of DCIs including all TPC command values for performing TPC command accumulation operation for the i^{th} PUSCH transmission unit. In order to determine Sᵢ, a start point and an end point may be defined in the time dimension, and all DCIs received by the UE within the two points may be included as elements of Sᵢ.

The end point for determining Sᵢ may be a point that is K_{SRS}(i) symbols prior to the starting symbol of the i^{th} SRS transmission unit.

The start point for determining Sᵢ may be a point that is K_{SRS}(i−i₀)−1symbols earlier than the starting symbol of the i−i₀^{th} SRS transmission unit. In this case, i₀, which is a positive integer, may be determined as the smallest value satisfying that the time point that is K_{SRS}(i−i₀) symbols earlier than the end point (a point prior to K_{SRS}(i) symbols from the starting symbol of the i^{th} SRS transmission unit) for determining Sᵢ is a time point that is earlier in time than the starting symbol of the i−i₀^{th} SRS transmission unit.

As an example, when the end point for determining Sᵢ may be defined as sym(i), and the time point prior to K_{SRS}(i−i₀) symbols from the starting symbol of the i−i₀^{th} SRS transmission unit may be defined as sym(i−i₀), if sym(i)=sym(i−1)>sym(i−2)>sym(i−3) holds, i₀ may be determined as 2.
If the UE is not configured for PUSCH transmission in bandwidth part b, carrier frequency f, and cell c, or is configured to have separate power control adjustment state values between SRS transmission and PUSCH transmission through upper-layer signaling srs-PowerControlAdjustmentStates, and upper-layer signaling tpc-Accumulation is configured (i.e., TPC command accumulation operation cannot be performed and absolute TPC command value may be applied), the SRS power control adjustment state may be expressed regardless of closed loop/as in Equation 10 below.

$${h}_{b , f , c} ( i ) = {δ}_{SRS , b , f , c} ( i ) \qquad Equation 10$$

As described above, δ_{SRS,b,f,c}(i) may be a value indicated by a TPC command field included in DCI format 2_3 within the bandwidth part b, carrier frequency f, and cell c, and the value may follow Table 18. As an example, if the value of the TPC command field is 0, δ_{SRS,b,f,c} may have a value of −4 dB.

### [SRS: Carrier Switching]

Next, SRS carrier switching will be described. In a TDD system, the SRS carrier switching is used to perform SRS transmission to support downlink channel estimation of a base station for a support cell where PUSCH/PUCCH transmission is not configured, i.e., a cell where only downlink transmission is supported. This is because channel reciprocity is established between the downlink channel and the uplink channel in the TDD system, so the base station may estimate the downlink channel based on the uplink channel estimated through SRS. This has the advantage in that, when the base station is supported with a large number of antennas but the UE is supported with a relatively small number of antennas, the method of estimating a downlink channel through SRS-based channel reciprocity requires less overhead than the method of estimating a downlink channel based on CSI-RS.

In order to transmit the SRS to the cell, which only supports the downlink transmission, through the SRS carrier switching, the UE needs to use an RF transmitter for uplink transmission to one of the other cells. This is because a target cell (hereinafter, specified as a target component carrier (CC)) performing the SRS carrier switching is a frequency band that only supports downlink transmission without PUCCH/PUSCH transmission configured, so the target cell does not use the RF transmitter except for the usage of the SRS carrier switching. Accordingly, considering aspects such as the cost of the UE, the RF transmitter for uplink transmission to the target cell performing the SRS carrier switching is not separately arranged, and when the SRS carrier switching is scheduled (hereinafter, scheduling for performing the SRS carrier switching may include all schedulings based on downlink control information (DCI) format 2_3-based aperiodic (AP) triggering or higher layer configuration-based semi-persistent (SP) or periodic (P) triggering.), the UE may retune an RF transmitter for uplink transmission to other cells to transmit the SRS. In order to perform the SRS carrier switching, the cell where the RF transmitter is arranged before the UE retunes the RF transmitter may be defined as a source cell (hereinafter, specified as a source CC), which may be configured in the UE through higher layer parameters srs-Switch FromServCellIndex and srs-SwitchFromCarrier. The higher layer parameter srs-SwitchFromServCellIndex indicates a cell index for the source CC, and the srs-SwitchFromCarrier indicates one of the NUL and SUL of the target CC to determine the RF transmitter that the UE should retune.

When performing the SRS carrier switching, the UE requires a retuning time that is a time to prepare the RF transmitter of the source CC to transmit the SRSs to the target CC and a time to retune the RF transmitter back to the source CC after transmitting all the SRSs to the target CC. This is an additional time required in addition to a preparation time required to transmit the SRS for usage other than the SRS carrier switching. In this way, the UE may report, to the base station, the UE capability regarding the retuning time of the RF transmitter required before and after performing the SRS carrier switching, and inform the base station of the required time. In this case, the UE may report the retuning time of the RF transmitter to the base station through switchingTimeUL and the switchingTimeDL.

Since the UE retunes the RF transmitter from the source CC to perform the SRS carrier switching, the UE may not transmit the uplink signal (e.g., PUCCH or PUSCH or SRS) to the source CC while transmitting the SRS to the target CC. Therefore, in order to perform the SRS carrier switching, the UE first identifies whether the scheduled uplink transmission to the source CC overlaps with the SRS transmission including the RF retuning time. If the scheduled uplink transmission to the source CC overlaps with the scheduled SRS transmission to the target CC (including the retuning time) and the simultaneous transmission is impossible behind the UE's indicated UL CA capability, the UE may compare the priorities between the two signals and transmit only one uplink signal. In this case, the priorities for the SRS carrier switching defined in NR release 15/16 are as follows:
If the PUSCH or PUCCH and/or the physical random access channel (PRACH) including one or a plurality of pieces of information among HARQ-ACK/positive scheduling request (SR)/rank indicator (RI)/CSI-RS resource indicator (CRI)/SS/PBCH block resource indicator (SSBRI) to the source CC overlaps with the SRS transmission to the target CC, the UE may not transmit the SRS to the target CC. That is, the UE may transmit the scheduled uplink signal to the source CC without performing the SRS carrier switching.
If the PUSCH including the aperiodic CSI to the source CC overlaps with the periodic or semi-persistent SRS transmission to the target CC, the UE may not transmit the periodic or semi-persistent SRS to the target CC. That is, the UE may transmit the scheduled uplink signal to the source CC without performing the SRS carrier switching.
If the PUCCH or PUSCH and/or the SRS including the periodic or semi-persistent CSI composed of one or a plurality of pieces of information among only channel quality indicator (CQI)/precoding matrix indicator (PMI)/layer 1 reference signal received power (L1-RSRP)/layer 1 signal to interference plus noise ratio (L1-SINR) to the source CC overlaps with the SRS transmission to the target CC, the UE may not transmit the PUCCH or PUSCH and/or the SRS to the source CC. That is, the UE may transmit the SRS to the target CC by performing the SRS carrier switching.
If the PUSCH including aperiodic CSI composed of one or a plurality of pieces of information among only CQI/PMI/L1-RSRP/L1-SINR on the source CC overlaps with the aperiodic SRS transmission to the target CC, the UE may not transmit the PUSCH to the source CC. That is, the UE may transmit the aperiodic SRS to the target CC by performing the SRS carrier switching.

When comparing the priorities between the uplink transmission to the source CC and the SRS transmission to the target CC described above, the time for the UE to receive and decode the DCI scheduling each transmission, the time required to determine the uplink transmission according to the higher layer configuration, the SRS transmission preparation time to which the preparation time required to transmit the uplink signal and the RF retuning time of the target CC are added, etc., should be considered. This is because when the UE prepares for transmission of either the uplink transmission to the source CC or the SRS transmission to the target CC, the UE may not cancel the uplink transmission or the SRS transmission. For example, even if the DCI scheduling the uplink signal transmission to the source CC with the high priority is received while the UE is preparing for the SRS transmission to the target CC that has already been scheduled (considering all the preparation time such as the DCI decoding and RF retuning time), the UE may not cancel the SRS transmission to the target CC.

Since this case is classified as the scheduling error case, the base station should consider the following conditions when performing the SRS carrier switching. The UE starts the SRS transmission in a symbol N_{C}_{₁} of a carrier c₁ (target CC) to cancel one of the specific transmissions (uplink signal transmission to the source CC or the SRS transmission to the target CC) and applies the above-described priority rule (priority rule between the uplink transmission to the source CC and the SRS transmission to the target CC) in consideration of the following conditions for the uplink transmission conflicting in a symbol N_{C}_{₂} of a carrier c₂ (source CC):

The DCI(s) should be received by the UE so that an interval between the last symbol of the PDCCH and N_{C}_{₁} is at least greater than the summed value of a N₂ symbol and T_{SRS}_{_{CS}} and an interval between the last symbol of the PDCCH and N_{C}_{₂} is at least greater than the N₂ symbol. In this case, the DCI may correspond to both the DCI for scheduling the uplink signal transmission to the source CC and the DCI for scheduling the SRS transmission to the target CC.

The semi-persistent CSI reporting or the SRS transmission should be active at least before the interval greater than the summed value of the N₂ symbol and T_{SRS}_{_{CS}} based on N_{C}_{₁}, and should be active at least before the interval greater than the N₂ symbol based on N_{C}_{₂}. In this case, the activated transmission may include both the uplink transmission to the source CC and the SRS transmission to the target CC.

Here, T_{SRS}_{_{CS}} IS T_{SRS}_{_{CS}}=max {the switchingTimeUL, switchingTimeDL}, the time interval unit of the OFDM symbol is determined based on c₁, c₂, and the smallest subcarrier spacing (SCS) among the corresponding scheduling cells (if the overlapping uplink signal is not transmitted to the target CC or the source CC). N₂ means the processing ability according to the UE capability for the PUSCH preparation time described later.

When the UE receives the SRS request through the DCI (or grant) for the target CC c and transmits an nth aperiodic SRS, the UE may start the SRS transmission with the configured symbol and slot that satisfies the following conditions:
The configured symbol and slot are values later than the total sum of the detailed conditions below.
Maximum time interval among the time intervals of N OFDM symbols for each cell including the target CC c and the DCI (or grant), respectively
Uplink or downlink RF retuning time defined by the switchingTimeUL and switchingTimeDL of the higher layer parameter SRS-SwitchingTimeNR
Does not collide with any previous SRS transmission (the SRS transmission before the nth aperiodic SRS) and is not interrupted by the uplink or downlink RF retuning time.

If the conditions are not satisfied, the UE does not transmit the nth the SRS. Here, N is the minimum time interval in symbol units between the DCI that triggers the aperiodic SRS and the aperiodic SRS, and is a value reported in the UE capability.

In case of the inter-band carrier aggregation (CA), the UE may simultaneously transmit the SRS and PUCCH/PUSCH to component carriers (CCs) of different bands based on the UE capability.

In case of the inter-band carrier aggregation (CA), the UE may simultaneously transmit the PRACH and SRS for component carriers (CCs) of different bands based on the UE capability.

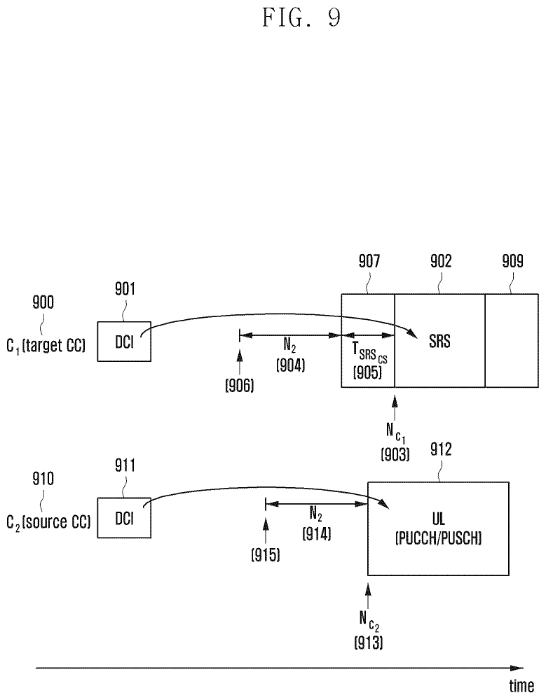

FIG. 9 is a diagram illustrating an example of the SRS carrier switching according to an embodiment of the disclosure.

Referring to FIG. 9, DCI 901 received by a target CC 900 may schedule the SRS transmission 902 through the SRS carrier switching. DCI 911 received by a source CC 910 may schedule uplink transmission 912 that may overlap with the SRS transmission 902. In this case, two pieces of DCI 906 should be received at least before a summed value of a N₂ 904 symbol and T_{SRS}_{_{CS}} 905 based on a transmission start symbol N_{C}_{₁} 903 of the SRS. Additionally, the two pieces of DCI 915 should be received at least before a N₂ 914 symbol based on an uplink transmission start symbol N_{C}_{₂} 913 on the source CC. In FIG. 9, 907 is the time required for the RF retuning from the downlink to the uplink to perform the SRS carrier switching, and 909 is the time required for the RF retuning from the uplink to the downlink after performing the SRS carrier switching.

### [Regarding UE Capability Reporting]

In a wireless communication system (for example, LTE system, 5G system, or NR system), the UE may perform a procedure for reporting a capability supported by the UE to the corresponding BS in the state in which the UE is connected to a serving BS. In the following description, this is referred to as a UE capability report.

The BS may transmit a UE capability enquiry message that makes a request for a capability report to the UE in the connected state. The message may include a UE capability request for each radio access technology (RAT) type of the BS. The request for each RAT type may include supported frequency band combination (BC) information. In the case of the UE capability enquiry message, a plurality of UE capabilities for respective RAT types may be requested through one RRC message container transmitted by the BS or the BS may insert the UE capability enquiry message including the UE capability request for each RAT type multiple times and transmit the same to the UE. That is, the UE capability enquiry is repeated multiple times within one message and the UE may configure a UE capability information message corresponding thereto and report the same multiple times. In the next-generation mobile communication system, a UE capability request for NR, LTE, E-UTRA-NR dual connectivity (EN-DC), and multi-RAT dual connectivity (MR-DC) may be made. The UE capability enquiry message is generally transmitted initially after the UE is connected to the BS, but may be requested at any time when the BS needs the same.

The UE receiving the request for the UE capability report from the BS in the above step may configure a UE capability according to RAT type and band information requested by the BS. A method by which the UE configures the UE capability in a wireless communication system (for example, 5G or NR system) according to an embodiment of the disclosure is described below.
1. When the UE receives a list of LTE and/or NR bands from the BS through a UE capability request, the UE configures a band combination (BC) for EN-DC and NR stand alone (SA). That is, the UE configures a candidate list of BCs for EN-DC and NR SA on the basis of requested bands in FreqBandList. The bands sequentially have priorities as stated in FreqBandList.
2. When the BS sets a “eutra-nr-only” flag or an “eutra” flag and makes a request for the UE capability report, the UE completely removes NR SA BCs from the configured candidate list of BCs. Such an operation may occur only when the LTE BS (eNB) makes a request for an “eutra” capability.
3. Thereafter, the UE removes fallback BCs from the candidate list of BCs configured in the above stage. The fallback BC is a BC which can be obtained by removing a band corresponding to at least one secondary cell (Scell) from a predetermined BC, and a BC before the removal of the band corresponding at least one SCell can cover the fallback BC and thus the fallback BC can be omitted. This stage is applied to MR-DC, that is, LTE bands. BCs left after the stage are a final “candidate BC list”.
4. The UE selects BCs suitable for a requested RAT type in the final “candidate BC list” and selects BCs to be reported. In this stage, the UE configures supportedBandCombinationList according to a determined order. That is, the UE configures BCs and UE capability to be reported according to an order of a preset rat-Type (nr->eutra-nr->eutra). Further, the UE configures featureSetCombination for the configured supportedBandCombinationList and configures a list of “candidate feature set combination” in a candidate BC list from which a list for fallback BCs (including capability at the same or lower stage) is received. The “candidate feature set combination” may include all feature set combinations for NR and evolved universal terrestrial radio access (EUTRA)-NR BCs, and may be acquired from a feature set combination of UE-NR-Capabilities and UE-MRDC-Capabilities containers.
5. When the requested rat Type is eutra-nr and influences, featureSetCombinations are included in all of the two containers of UE-MRDC-Capabilities and UE-NR-Capabilities. However, the NR feature set includes only UE-NR-Capabilities.

After configuring the UE capability, the UE may transfer a UE capability information message including the UE capability to the BS. The BS may perform scheduling for the corresponding UE and transmission/reception management on the basis of the UE capability received from the UE.

### [PDSCH: TCI State Activation MAC-CE]

Next, a beam configuration method for PDSCH is described.

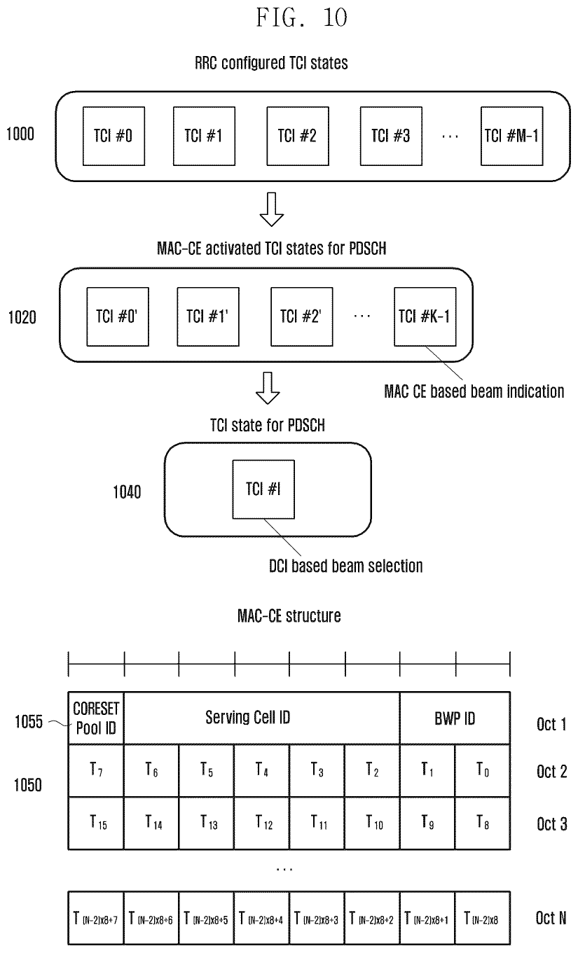

FIG. 10 illustrates a process for beam configuration and activation of PDSCH according to an embodiment of the disclosure.

Referring to FIG. 10, a list of TCI states for PDSCH may be indicated through a upper-layer list such as RRC and the like (1000). The list of TCI states may be indicated, for example, as tci-StatesToAddModList and/or tci-StatesToReleaseList in the PDSCH-Config IE for each BWP. Next, some of the list of TCI states may be activated through MAC-CE (1020). The maximum number of activated TCI states may be determined according to the capability reported by the UE. One of the TCI states activated through MAC-CE may be indicated through DCI (1040). (1050) illustrates an example of a MAC-CE structure for PDSCH TCI state activation/deactivation. The MAC CE may include a serving cell identifier, a BWP ID, a TCI state identifier (Ti), and a CORESET Pool ID 1055.

### [Regarding NC-JT]

According to an embodiment of the disclosure, in order to receive a PDSCH from a plurality of TRPs, the UE may use non-coherent joint transmission (NC-JT).

A wireless communication system (for example, 5G or NR system) may support all of the service having very short transmission latency and the service requiring a high connectivity density as well as the service requiring a high transmission rate unlike the conventional system. In a wireless communication network including a plurality of cells, transmission and reception points (TRPs), or beams, cooperative communication (coordinated transmission) between respective cells, TRPs, or/and beams may satisfy various service requirements by increasing the strength of a signal received by the UE or efficiently controlling interference between the cells, TRPs, or/and beams.

Joint transmission (JT) is a representative transmission technology for the cooperative communication and may increase the strength of a signal received by the UE or throughput by transmitting signals to one UE through different cells, TRPs, or/and beams. At this time, a channel between each cell, TRP, or/and beam and the UE may have different characteristics, and particularly, non-coherent joint transmission (NC-JT) supporting non-coherent precoding between respective cells, TRPs, or/and beams may need individual precoding, MCS, resource allocation, and TCI indication according to the channel characteristics for each link between each cell, TRP, or/and beam and the UE.

The NC-JT may be applied to at least one of a downlink data channel (physical downlink shared channel (PDSCH)), a downlink control channel (physical downlink control channel (PDCCH)), an uplink data channel (physical uplink shared channel (PUSCH)), and an uplink control channel (Physical uplink control channel (PUCCH)). In PDSCH transmission, transmission information such as precoding, MCS, resource allocation, and TCI may be indicated through DL DCI, and should be independently indicated for each cell, TRP, or/and beam for the NC-JT. This is a main factor that increases payload required for DL DCI transmission, which may have a bad influence on reception performance of a PDCCH for transmitting the DCI. Accordingly, in order to support JT of the PDSCH, it is required to carefully design tradeoff between an amount of DCI information and reception performance of control information.

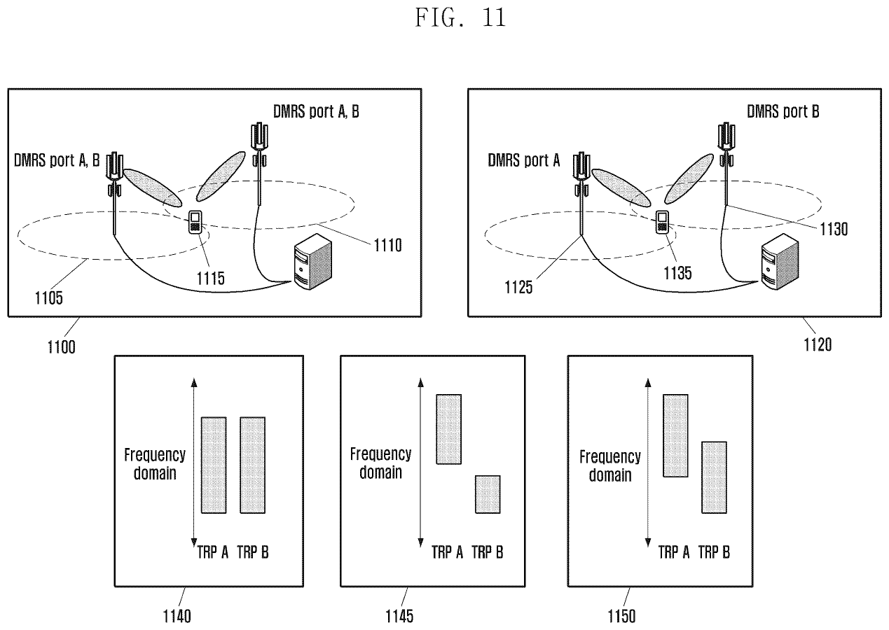

FIG. 11 illustrates a configuration of antenna ports and an example of resource allocation for transmitting a PDSCH using cooperative communication in a wireless communication system according to an embodiment of the disclosure.

Referring to FIG. 11, the example for PDSCH transmission is described for each scheme of joint transmission (JT), and examples for allocating radio resources for each TRP are described.

Referring to FIG. 11, an example 1100 of coherent joint transmission (C-JT) supporting coherent precoding between respective cells, TRPs, or/and beams is illustrated.

In the case of C-JT, a TRP A 1105 and a TRP B 1110 transmit single data (PDSCH) to a UE 1115, and the plurality of TRPs may perform joint precoding. This may mean that the TRP A 1105 and the TRP B 1110 transmit DMRSs through the same DMRS ports in order to transmit the same PDSCH. For example, the TRP A 1105 and the TRP B 1110 may transmit DMRSs to the UE through a DMRS port A and a DMRS port B, respectively. In this case, the UE may receive one piece of DCI information for receiving one PDSCH demodulated on the basis of the DMRSs transmitted through the DMRS port A and the DMRS port B.

FIG. 11 illustrates an example 1120 of non-coherent joint transmission (NC-JT) supporting non-coherent precoding between respective cells, TRPs, or/and beams for PDSCH transmission.

In the case of NC-JT, the PDSCH is transmitted to a UE 1135 for each cell, TRP (e.g., TRP A 1125, TRP B 1130), or/and beam, and individual precoding may be applied to each PDSCH. Respective cells, TRPs, or/and beams may transmit different PDSCHs or different PDSCH layers to the UE, thereby improving throughput compared to single cell, TRP, or/and beam transmission. Further, respective cells, TRPs, or/and beams may repeatedly transmit the same PDSCH to the UE, thereby improving reliability compared to single cell, TRP, or/and beam transmission. For convenience of description, the cell, TRP, or/and beam are commonly called a TRP.

At this time, various wireless resource allocations such as the case 1140 in which frequency and time resources used by a plurality of TRPs for PDSCH transmission are all the same, the case 1145 in which frequency and time resources used by a plurality of TRPs do not overlap at all, and the case 1150 in which some of the frequency and time resources used by a plurality of TRPs overlap each other may be considered.

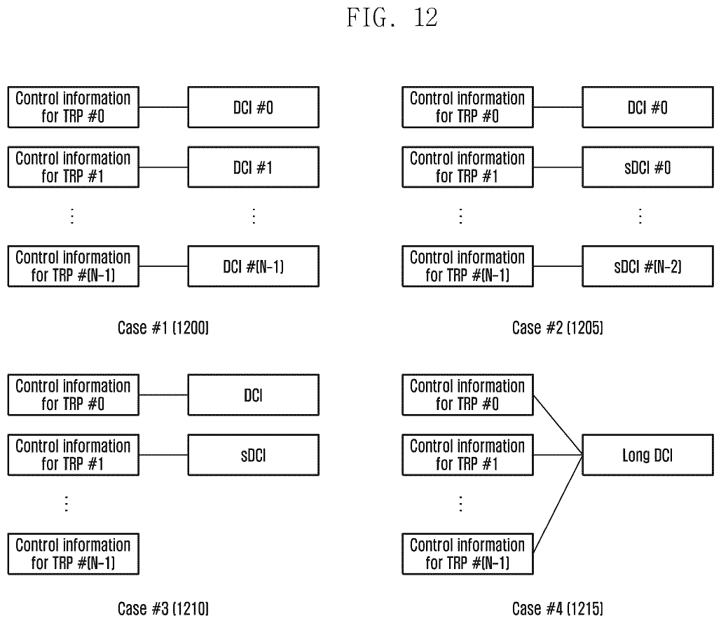

In order to support NC-JT, DCIs in various forms, structures, and relations may be considered to simultaneously allocate a plurality of PDSCHs to one UE. FIG. 12 illustrates an example for a configuration of downlink control information (DCI) for NC-JT in which respective TRPs transmit different PDSCHs or different PDSCH layers to the UE in a wireless communication system according to an embodiment of the disclosure.

Referring to FIG. 12, case #1 1200 is an example in which control information for PDSCHs transmitted from (N−1) additional TRPs is transmitted independently from control information for a PDSCH transmitted by a serving TRP in a situation in which (N−1) different PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through independent DCIs (DCI #0 to DCI #(N−1)). Formats between the independent DCIs may be the same as or different from each other, and payload between the DCIs may also be the same as or different from each other. In case #1, a degree of freedom of PDSCH control or allocation can be completely guaranteed, but when respective pieces of DCI are transmitted by different TRPs, a difference between DCI coverages may be generated and reception performance may deteriorate.

Case #2 1205 is an example in which pieces of control information for PDSCHs of (N−1) additional TRPs are transmitted and each piece of the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, DCI #0 that is control information for a PDSCH transmitted from the serving TRP (TRP #0) may include all information elements of DCI format 1_0, DCI format 1_1, and DCI format 1_2, but shortened DCIs (hereinafter, referred to as sDCIs) (sDCI #0 to sDCI #(N−2)) that are control information for PDSCHs transmitted from the cooperative TRPs (TRP #1 to TRP #(N−1)) may include only some of the information elements of DCI format 1_0, DCI format 1_1, and DCI format 1_2. Accordingly, the sDCI for transmitting control information of PDSCHs transmitted from cooperative TRPs has smaller payload compared to the normal DCI (nDCI) for transmitting control information related to the PDSCH transmitted from the serving TRP, and thus can include reserved bits compared to the nDCI.

In case #2 1205, a degree of freedom of each PDSCH control or allocation may be limited according to content of information elements included in the sDCI, but reception capability of the sDCI is better than the nDCI, and thus a probability of the generation of difference between DCI coverages may become lower.

Case #3 1210 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, in the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DCI format 1_0, DCI format 1_1, and DCI format 1_2 may be gathered in one “secondary” DCI (sDCI) and transmitted. For example, the sDCI may include at least one piece of HARQ-related information such as frequency domain resource assignment and time domain resource assignment of the cooperative TRPs and the MCS. In addition, information that is not included in the sDCI such as a BWP indicator and a carrier indicator may follow DCI (DCI #0, normal DCI, or nDCI) of the serving TRP.

In case #3 1210, a degree of freedom of PDSCH control or allocation may be limited according to content of the information elements included in the sDCI but reception performance of the sDCI can be controlled, and case #3 1210 may have smaller complexity of DCI blind decoding of the UE compared to case #1 1200 or case #2 1205.

Case #4 1215 is an example in which control information for PDSCHs transmitted from (N−1) additional TRPs is transmitted in DCI (long DCI) that is the same as that of control information for the PDSCH transmitted from the serving TRP in a situation in which different (N−1) PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through single DCI. In case #4 1215, complexity of DCI blind decoding of the UE may not be increased, but a degree of freedom of PDSCH control or allocation may be low since the number of cooperative TRPs is limited according to long DCI payload restriction.

In the following description and embodiments, the sDCI may refer to various pieces of supplementary DCI such as shortened DCI, secondary DCI, or normal DCI (DCI formats 1_0 and 1_1) including PDSCH control information transmitted in the cooperative TRP, and unless specific restriction is mentioned, the corresponding description may be similarly applied to the various pieces of supplementary DCI.

In the following description and embodiments, case #1 1200, case #2 1205, and case #3 1210 in which one or more pieces of DCI (or PDCCHs) are used to support NC-JT may be classified as multiple PDCCH-based NC-JT and case #4 1215 in which single DCI (or PDCCH) is used to support NC-JT may be classified as single PDCCH-based NC-JT. In multiple PDCCH-based PDSCH transmission, a CORESET for scheduling DCI of the serving TRP (TRP #0) is separated from CORESETs for scheduling DCI of cooperative TRPs (TRP #1 to TRP #(N−1)). A method of distinguishing the CORESETs may include a distinguishing method through a higher-layer indicator for each CORESET and a distinguishing method through a beam configuration for each CORESET. Further, in single PDCCH-based NC-JT, single DCI schedules a single PDSCH having a plurality of layers instead of scheduling a plurality of PDSCHs, and the plurality of layers may be transmitted from a plurality of TRPs. At this time, association between a layer and a TRP transmitting the corresponding layer may be indicated through a transmission configuration indicator (TCI) indication for the layer.

In embodiments of the disclosure, the “cooperative TRP” may be replaced with various terms such as a “cooperative panel” or a “cooperative beam” when actually applied.

In embodiments of the disclosure, “the case in which NC-JT is applied” may be variously interpreted as “the case in which the UE simultaneously receives one or more PDSCHs in one BWP”, “the case in which the UE simultaneously receives PDSCHs on the basis of two or more transmission configuration indicator (TCI) indications in one BWP”, and “the case in which the PDSCHs received by the UE are associated with one or more DMRS port groups” according to circumstances, but is used by one expression for convenience of description.

In the disclosure, a wireless protocol structure for NC-JT may be variously used according to a TRP development scenario. For example, when there is no backhaul delay between cooperative TRPs or there is a small backhaul delay, a method (CA-like method) using a structure based on MAC layer multiplexing can be used similarly to reference numeral S10 of FIG. 4. On the other hand, when the backhaul delay between cooperative TRPs is too large to be ignored (for example, when a time of 2 ms or longer is needed to exchange information such as CSI, scheduling, and HARQ-ACK between cooperative TRPs), a method (DC-like method) of securing a characteristic robust to a delay can be used through an independent structure for each TRP from an RLC layer similarly to reference numeral S20 of FIG. 4.

The UE supporting C-JT and/or NC-JT may receive a C-JT and/or NC-JT-related parameter or a setting value from a higher-layer configuration and set an RRC parameter of the UE on the basis thereof. For the higher-layer configuration, the UE may use a UE capability parameter, for example, tci-StatePDSCH. The UE capability parameter, for example, tci-StatePDSCH may define TCI states for PDSCH transmission, the number of TCI states may be configured as 4, 8, 16, 32, 64, and 128 in FR1 and as 64 and 128 in FR2, and a maximum of 8 states which can be indicated by 3 bits of a TCI field of the DCI may be configured through a MAC CE message among the configured numbers. A maximum value 128 means a value indicated by maxNumberConfiguredTCIstatesPerCC within the parameter tci-StatePDSCH which is included in capability signaling of the UE. As described above, a series of configuration processes from the higher-layer configuration to the MAC CE configuration may be applied to a beamforming indication or a beamforming change command for at least one PDSCH in one TRP.

### [Multi-DCI Based Multi-TRP]

As an embodiment of the disclosure, a multi-DCI based multi-TRP transmission method is described. The multi-DCI based multi-TRP transmission method may configure a downlink control channel for NC-JT transmission based on a multi-PDCCH.

In NC-JT based on multiple PDCCHs, there may be a CORESET or a search space separated for each TRP when DCI for scheduling the PDSCH of each TRP is transmitted. The CORESET or the search space for each TRP can be configured like in at least one of the following cases.
A configuration of a higher-layer index for each CORESET: CORESET configuration information configured by a higher layer may include an index value, and a TRP for transmitting a PDCCH in the corresponding CORESET may be identified by the configured index value for each CORESET. That is, in a set of CORESETs having the same higher-layer index value, it may be considered that the same TRP transmits the PDCCH or the PDCCH for scheduling the PDSCH of the same TRP is transmitted. The index for each CORESET may be named CORESETPoolIndex, and it may be considered that the PDCCH is transmitted from the same TRP in CORESETs in which the same CORESETPoolIndex value is configured. In the CORESET in which the same CORESETPoolIndex value is not configured, it may be considered that a default value of CORESETPoolIndex is configured, and the default value may be 0.
   In the disclosure, if each of the multiple CORESETs included in the upper-layer signaling PDCCH-Config has more than one type of CORESETPoolIndex, i.e., if each CORESET has a different CORESETPoolIndex, the UE may consider that the base station may use a multi-DCI based multi-TRP transmission method.
   In contrast, in the disclosure, if each of the multiple CORESETs included in the upper-layer signaling PDCCH-Config has only one type of CORESETPoolIndex, i.e., if all CORESETs have the same CORESETPoolIndex of 0 or 1, the UE may consider that the base station transmits using single-TRP without using the multi-DCI based multi-TRP transmission method.
A configuration of multiple PDCCH-Config: a plurality of PDCCH-Config are configured in one BWP, and each PDCCH-Config may include a PDCCH configuration for each TRP. That is, a list of CORESETs for each TRP and/or a list of search spaces for each TRP may be included in one PDCCH-Config, and one or more CORESETs and one or more search spaces included in one PDCCH-Config may be considered to correspond to a specific TRP.
A configuration of a CORESET beam/beam group: a TRP corresponding to the corresponding CORESET may be identified through a beam or a beam group configured for each CORESET. For example, when the same TCI state is configured in a plurality of CORESETs, it may be considered that the corresponding CORESETs are transmitted through the same TRP or a PDCCH for scheduling a PDSCH of the same TRP is transmitted in the corresponding CORESET.
A configuration of a search space beam/beam group: a beam or a beam group is configured for each search space, and a TRP for each search space may be identified therethrough. For example, when the same beam/beam group or TCI state is configured in a plurality of search spaces, it may be considered that the same TRP transmits the PDCCH in the corresponding search space or a PDCCH for scheduling a PDSCH of the same TRP is transmitted in the corresponding search space.

As described above, by separating the CORESETs or search spaces for each TRP, it is possible to divide PDSCHs and HARQ-ACK for each TRP and accordingly to generate an independent HARQ-ACK codebook for each TRP and use an independent PUCCH resource.

The configuration may be independent for each cell or BWP. For example, while two different CORESETPoolIndex values may be configured in the primary cell (PCell), no CORESETPoolIndex value may be configured in a specific SCell. In this case, it may be considered that NC-JT is configured in the PCell, but NC-JT is not configured in the SCell in which no CORESETPoolIndex value is configured.

The PDSCH TCI state activation/deactivation MAC-CE applicable to the multi-DCI based multi-TRP transmission method may follow FIG. 10.

If the UE is not configured with CORESETPoolIndex for each of all CORESETs in the upper-layer signaling PDCCH-Config, the UE may ignore the CORESET Pool ID field 1055 in the corresponding MAC-CE 1050. If the UE may support the multi-DCI based multi-TRP transmission method, i.e., if the UE has CORESETPoolIndex with different CORESETs in upper-layer signaling PDCCH-Config, the UE may activate the TCI state in the DCI included in the PDCCH transmitted from CORESETs having the same CORESETPoolIndex value as the CORESET Pool ID field 1055 value in the corresponding MAC-CE 1050. As an example, if the CORESET Pool ID field 1055 value in the corresponding MAC-CE 1050 is 0, the TCI state in the DCI included in the PDCCH transmitted from CORESETs having CORESETPoolIndex of 0 may follow the activation information of the corresponding MAC-CE.

If the UE is configured to use a multi-DCI based multi-TRP transmission method from the base station, i.e., if each of the multiple CORESETs included in the upper-layer signaling PDCCH-Config has more than one type of CORESETPoolIndex, or if each CORESET has a different CORESETPoolIndex, the UE may know that the following restrictions exist for PDSCHs scheduled from PDCCHs within each CORESET having two different CORESETPoolIndexes.
1) If the PDSCHs indicated from the PDCCHs within each CORESET having two different CORESETPoolIndexes overlap completely or partially, the UE may apply the TCI states indicated from each PDCCH to different code division multiplexing (CDM) groups, respectively. That is, two or more TCI states may not be applied to one CDM group.
2) If the PDSCHs indicated from the PDCCHs within each CORESET having two different CORESETPoolIndexes overlap completely or partially, the UE may expect that the actual number of front-loaded DMRS symbols, the actual number of additional DMRS symbols, the locations of actual DMRS symbols, and the DMRS type of each PDSCH will not be different from each other.
3) The UE may expect that the bandwidth part indicated from the PDCCHs within each CORESET having two different CORESETPoolIndexes is the same and that the subcarrier spacing is also the same.
4) The UE may expect that the information on the PDSCH scheduled from the PDCCH within each CORESET having two different CORESETPoolIndexes is completely included in each PDCCH.

### [Single-DCI Based Multi-TRP]

As an embodiment of the disclosure, a single-DCI based multi-TRP transmission method is described. The single-DCI based multi-TRP transmission method may configure a downlink control channel for NC-JT transmission based on a single-PDCCH.

In the single DCI-based multi-TRP transmission method, PDSCHs transmitted by multiple TRPs may be scheduled with a single DCI. In this case, the number of TCI states may be used as a method for indicating the number of TRPs transmitting the corresponding PDSCH. That is, if the number of TCI states indicated in the DCI scheduling the PDSCH is 2, it may be considered as a single PDCCH-based NC-JT transmission, and if the number of TCI states is 1, it may be considered as a single-TRP transmission. The TCI states indicated in the above DCI may correspond to one or two TCI states among the TCI states activated by MAC-CE. In the case where the TCI states of the DCI correspond to two TCI states activated by MAC-CE, a correspondence relationship between the TCI codepoint indicated in the DCI and the TCI states activated by MAC-CE is established, and it may be when there are two TCI states activated by MAC-CE corresponding to the TCI codepoint.

As another example, if at least one codepoint among all codepoints in the TCI state field in the DCI indicates two TCI states, the UE may consider that the base station may transmit based on the single-DCI based multi-TRP method. In this case, at least one codepoint indicating two TCI states in the TCI state field may be activated through the Enhanced PDSCH TCI state activation/deactivation MAC-CE.

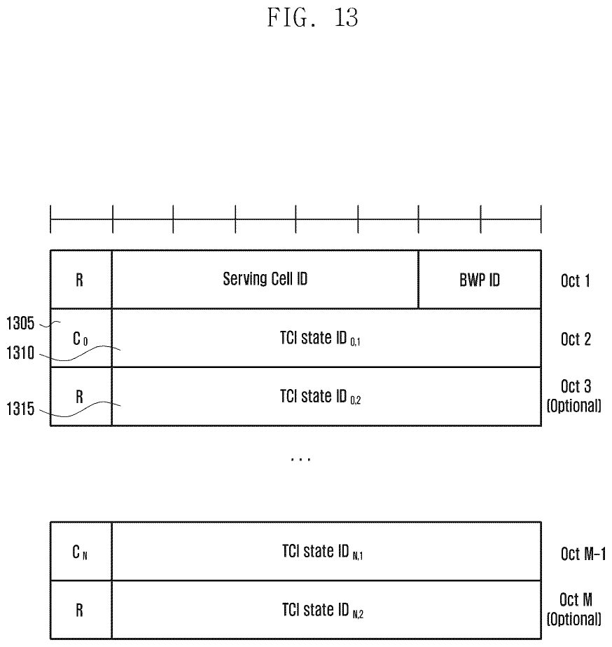

FIG. 13 is a drawing illustrating an Enhanced PDSCH TCI state activation/deactivation MAC-CE structure according to an embodiment of the disclosure.

Referring to FIG. 13, the meaning of each field in the Enhanced PDSCH TCI state activation/deactivation MAC CE and the values that may be configured for each field are as shown in Table 21 below.

```
TABLE 21
  - Serving Cell ID: This field indicates the identity of the Serving Cell for
which the MAC CE applies. The length of the field is 5 bits. If the indicated Serving
Cell is configured as part of a simultaneousTCI-UpdateList1 or simultaneousTCI-
UpdateList2 as specified in TS 38.331 [5], this MAC CE applies to all the Serving
Cells configured in the set simultaneousTCI-UpdateList1 or simultaneousTCI-
UpdateList2, respectively;
  - BWP ID: This field indicates a DL BWP for which the MAC CE applies as
the codepoint of the DCI bandwidth part indicator field as specified in TS 38.212 [9].
The length of the BWP ID field is 2 bits;
  - Cᵢ: This field indicates whether the octet containing TCI state ID_{i,2} is present.
If this field is set to “1”, the octet containing TCI state ID_{i,2} is present. If this field is
set to “0”, the octet containing TCI state ID_{i,2} is not present;
  - TCI state ID_{i,j}: This field indicates the TCI state identified by TCI-StateId as
specified in TS 38.331 [5], where i is the index of the codepoint of the DCI
Transmission configuration indication field as specified in TS 38.212 [9] and TCI
state ID_{i,j} denotes the j-th TCI state indicated for the i-th codepoint in the DCI
Transmission Configuration Indication field. The TCI codepoint to which the TCI
States are mapped is determined by its ordinal position among all the TCI codepoints
with sets of TCI state ID_{i,j} fields, i.e. the first TCI codepoint with TCI state ID_{0,1} and
TCI state ID_{0,2} shall be mapped to the codepoint value 0, the second TCI codepoint
with TCI state ID_{1,1} and TCI state ID_{1,2} shall be mapped to the codepoint value 1 and
so on. The TCI state ID_{i,2} is optional based on the indication of the Ci field. The
maximum number of activated TCI codepoint is 8 and the maximum number of TCI
states mapped to a TCI codepoint is 2.
  - R: Reserved bit, set to “0”.
```

If the value of a Co field 1305 is 1, the MAC-CE may include a TCI state ID_{0,2} field 1315 in addition to a TCI state ID_{0,1} field 1310. This means that the TCI state ID_{0,1} and TCI state ID_{0,2} are activated for the 0^{th} codepoint of the TCI state field included in the DCI, and if the base station indicates the codepoint to the UE, the UE may be indicated with two TCI states. If the value of the Co field 1305 is 0, the MAC-CE may not include the TCI state ID_{0,2} field 1315, and this means that one TCI state corresponding to TCI state ID_{0,1} is activated for the 0^{th} codepoint of the TCI state field included in the DCI.

The above configuration may be independent per cell or per BWP. For example, a PCell may have at most 2 activated TCI states corresponding to one TCI codepoint, while a specific SCell may have at most 1 activated TCI state corresponding to one TCI codepoint. In this case, it may be considered that the PCell is configured for NC-JT transmission, while the SCell is not configured for NC-JT transmission.

### [Distinguishing Method of Single-DCI Based Multi-TRP PDSCH Repeated Transmission Technique (Time Division Multiplexing (TDM)/Frequency Division Multiplexing (FDM)/Subscriber Data Management (SDM))]

Next, a method for distinguishing single-DCI based multi-TRP PDSCH repeated transmission techniques is described. Depending on the value indicated by the DCI field from the base station and the upper-layer signaling configuration, the UE may be indicated with different single-DCI based multi-TRP PDSCH repeated transmission techniques (e.g., TDM, FDM, SDM). The following Table 22 illustrates a method for distinguishing between single or multiple TRP-based techniques indicated to the UE depending on the value of a specific DCI field and the upper-layer signaling configuration.

TABLE 22

| | Number | Number | RepetitionNumber | RepetitionScheme | Transmission |
|---|---|---|---|---|---|
| | of TCI | of CDM | configuration and | configuration | scheme |
| Combination | states | groups | indication conditions | related | indicated to UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP |
| | | | | not configured | TDM scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 1 | Condition 3 | Configured | Multi-TRP FDM |
| | | | | | scheme A/FDM |
| | | | | | scheme B/TDM |
| | | | | | scheme A |
| 9 | 2 | 1 | Condition 1 | Not configured | Multi-TRP |
| | | | | | TDM scheme B |

In Table 22, each column may be described as follows.
Number of TCI states (column 2): This means the number of TCI states indicated by the TCI state field in the DCI, and may be 1 or 2.
Number of CDM groups (column 3): This means the number of different CDM groups of DMRS ports indicated by the Antenna port field in the DCI. It may be 1, 2, or 3.
repetitionNumber configuration and indication condition (column 4): This may have 3 conditions depending on whether repetitionNumber is configured for all TDRA entries that may be indicated by the Time Domain Resource Allocation field in the DCI and whether the actually indicated TDRA entry has repetitionNumber configuration.
Condition 1: If at least one of all TDRA entries that may be indicated by the Time Domain Resource Allocation field includes a configuration for repetitionNumber, and if the TDRA entry indicated by the Time Domain Resource Allocation field in the DCI includes a configuration for repetitionNumber greater than 1
Condition 2: If at least one of all TDRA entries that may be indicated by the Time Domain Resource Allocation field includes a configuration for repetitionNumber, and if the TDRA entry indicated by the Time Domain Resource Allocation field in the DCI does not include a configuration for repetitionNumber
Condition 3: If all TDRA entries that may be indicated by the Time Domain Resource Allocation field do not include a configuration for repetitionNumber
repetitionScheme configuration related (column 5): This means whether the upper-layer signaling repetitionScheme is configured. The upper-layer signaling repetitionScheme may be configured with one of “tdmSchemeA”, “fdmSchemeA”, and “fdmSchemeB”.
Transmission scheme indicated to UE (column 6): This means single or multiple TRP schemes indicated according to each combination (column 1) expressed in Table 22.
Single-TRP: This means single TRP-based PDSCH transmission. If the UE is configured with pdsch-AggegationFactor in the upper-layer signaling PDSCH-config, the UE may be scheduled for single TRP-based PDSCH repeated transmission as many times as configured. Otherwise, the UE may be scheduled for single TRP-based PDSCH single transmission.
Single-TRP TDM scheme B: This means PDSCH repeated transmission based on time resource division between single TRP slots. According to Condition 1 related to repetitionNumber described above, the UE repetitively transmits PDSCH on the time dimension as many times as the number of slots with repetitionNumber greater than 1 configured in the TDRA entry indicated by the Time Domain Resource Allocation field. In this case, for each slot with repetitionNumber, the starting symbol and symbol length of the PDSCH indicated by the TDRA entry are applied equally, and the same TCI state is applied to each PDSCH repeated transmission. This technique is similar to the slot aggregation method in that it performs PDSCH repeated transmission between slots on time resources, but it differs from slot aggregation in that it may dynamically determine whether to indicate repetitive transmission based on the time domain resource allocation field in the DCI.
Multi-TRP SDM: This means a multi-TRP based spatial resource division PDSCH transmission method. This is a method of receiving layers from each TRP by dividing them, and although it is not a repeated transmission method, the reliability of PDSCH transmission may be increased in that it may be transmitted by lowering the coding rate by increasing the number of layers. The UE may receive PDSCH by applying the two TCI states indicated through the TCI state field in the DCI for each of the two CDM groups indicated by the base station.
Multi-TRP FDM scheme A: This refers to a multi-TRP-based frequency resource division PDSCH transmission method, and it has one PDSCH transmission location (occasion), so it is not a repetitive transmission like multi-TRP SDM, but it is a technique that may transmit with high reliability by increasing the frequency resource amount and lowering the coding rate. The multi-TRP FDM scheme A may apply two TCI states indicated through the TCI state field in the DCI to non-overlapping frequency resources. If the PRB bundling size is determined as wideband, when the number of RBs indicated by the Frequency Domain Resource Allocation field is N, the UE applies the first TCI state to the first ceil (N/2) RBs and applies the second TCI state to the remaining floor (N/2) RBs. Here, ceil (.) and floor (.) are operators that refers to rounding up and down to the first decimal place. If the PRB bundling size is determined as 2 or 4, even-numbered precoding resource block groups (PRGs) receive by applying the first TCI state, and odd-numbered PRGs receive by applying the second TCI state.
Multi-TRP FDM scheme B: This refers to a multi-TRP-based frequency resource division PDSCH transmission method, and it has two PDSCH transmission locations (occasions) so that PDSCH may be repeatedly transmitted at each location. The multi-TRP FDM scheme B, like A, may apply two TCI states indicated through the TCI state field in the DCI to non-overlapping frequency resources. If the PRB bundling size is determined as wideband, when the number of RBs indicated by the Frequency Domain Resource Allocation field is N, the UE applies the first TCI state to the first ceil (N/2) RBs and applies the second TCI state to the remaining floor (N/2) RBs. Here, ceil (.) and floor (.) are operators that refers to rounding up and down to the first decimal place. If the PRB bundling size is determined as 2 or 4, even-numbered PRGs receive by applying the first TCI state, and odd-numbered PRGs receive by applying the second TCI state.
Multi-TRP TDM scheme A: This refers to a PDSCH repeated transmission method within the multi-TRP based time resource division slot. The UE has two PDSCH transmission locations (occasions) within one slot, and the first reception location may be determined based on the starting symbol and symbol length of the PDSCH indicated through the time domain resource allocation field in the DCI. The starting symbol of the second reception location of the PDSCH may be the location that applies the symbol offset by the upper-layer signaling StartingSymbolOffsetK from the last symbol of the first transmission location, and the transmission location may be determined by the symbol length indicated therefrom. If the upper-layer signaling StartingSymbolOffsetK is not configured, the symbol offset may be considered as 0.
Multi-TRP TDM scheme B: This means a PDSCH repeated transmission method between the multi-TRP based time resource division slot. The UE has one PDSCH transmission location (occasion) within one slot, and may receive repeated transmissions based on the starting symbol and symbol length of the same PDSCH for the number of slots indicated by the repetitionNumber through the time domain resource allocation field in the DCI. If repetitionNumber is 2, the UE may receive repeated PDSCH transmissions of the first and second slots by applying the first and second TCI states, respectively. If repetitionNumber is greater than 2, the UE may use different TCI state application methods depending on which upper-layer signaling tciMapping is configured to. If tciMapping is configured to cyclicMapping, the first and second TCI states are applied to the first and second PDSCH transmission locations, respectively, and the same TCI state application method is applied to the remaining PDSCH transmission locations. If tciMapping is configured to sequentialMapping, the first TCI state is applied to the first and second PDSCH transmission locations, the second TCI state is applied to the third and fourth PDSCH transmission locations, and the same TCI state application method is applied to the remaining PDSCH transmission locations.

In this disclosure below, upper signaling (or upper-layer signaling) is a signal transmission method in which a base station transmits a signal to a UE by using a downlink data channel of a physical layer, or a UE transmits a signal to a base station by using an uplink data channel of a physical layer, and may be referred to as RRC signaling, PDCP signaling, or medium access control (MAC) control element (CE).

In the disclosure below, the UE may use various methods to determine whether cooperative communication is applied, such as the PDCCH(s) that allocate the PDSCH to which cooperative communication is applied have a specific format, the PDCCH(s) that allocate the PDSCH to which cooperative communication is applied include a specific indicator indicating whether cooperative communication is applied, the PDCCH(s) that allocate the PDSCH to which cooperative communication is applied are scrambled with a specific RNTI, or assuming that cooperative communication is applied in a specific section indicated to a upper layer. For the convenience of the following explanation, the case where a UE receives a PDSCH to which cooperative communication is applied based on conditions similar to the above will be referred to as an NC-JT case.

In the disclosure below, determining the priority between A and B may be referred to in various ways, such as selecting the one with the higher priority according to a predetermined priority rule and performing the corresponding operation, or omitting or dropping the operation for the one with the lower priority.

As used herein, upper signaling (or upper layer signaling”) is a method for transferring signals from a base station to a UE by using a downlink data channel of a physical layer, or from the UE to the base station by using an uplink data channel of the physical layer, and may also be referred to as “RRC signaling”, “PDCP signaling”, or “MAC control element (MAC CE)”.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, when actually applied, a TRP, a beam, or a TCI state may be appropriately replaced with one of the above terms.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

In the following description of the disclosure, higher-layer signaling may be singling corresponding to at least one of or a combination of one or more of the following signaling.
Master Information Block (MIB)
System Information Block (SIB) or SIB X (X=1, 2, . . . )
Radio Resource Control (RRC)
Medium Access Control (MAC) Control Element (CE)

L1 signaling may be signaling corresponding to at least one of or a combination of one or more of signaling methods using the following physical layer channels or signaling.
Physical Downlink Control Channel (PDCCH)
Downlink Control Information (DCI)
UE-specific DCI
Group common DCI
Common DCI
Scheduling DCI (for example, DCI used to schedule downlink or uplink data)
Non-scheduling DCI (for example, DCI other than DCI used to schedule downlink or uplink data)
physical uplink control channel (PUCCH)
uplink control information (UCI)

The term slot used in the disclosure below is a general term that may mean a specific time unit corresponding to a transmit time interval (TTI), and specifically, may mean a slot used in a 5G NR system, or a slot or subframe used in a 4^{th} generation (4G) LTE system.

### First Embodiment: Method for Configuring Transmission Power Parameter when Supporting Unified TCI State

As an embodiment of the disclosure, a method for configuring a transmission power parameter to a UE when the UE supports a unified TCI state is described. This embodiment may be operated in combination with other embodiments.

The UE may be configured with the upper-layer signaling ServingCellConfig from the base station, and additionally, the UE may be configured with the upper-layer signaling MIMOParam-r17 within the ServingCellConfig. The specific upper-layer signaling structure of ServingCellConfig and MIMOParam-r17 may be as shown in Table 23 below.

TABLE 23
ServingCellConfig ::= SEQUENCE {
...
pathlossReferenceLinking ENUMERATED {spCell, sCell} OPTIONAL, -- Cond SCellOnly

| | |
|---|---|
| mimoParam-r17 | SetupRelease {MIMOParam-r17} |

```
OPTIONAL, -- Need M
...
}
MIMOParam-r17 ::= SEQUENCE {
  additionalPCI-ToAddModList-r17 SEQUENCE (SIZE(1..maxNrofAdditionalPCI-r17)) OF
SSB-MTC-AdditionalPCI-r17 OPTIONAL, -- Need N
  additionalPCI-ToReleaseList-r17 SEQUENCE (SIZE(1..maxNrofAdditionalPCI-r17)) OF
AdditionalPCIIndex-r17 OPTIONAL, -- Need N
```

| | |
|---|---|
| unifiedTCI-StateType-r17 | ENUMERATED {separate, joint} |

```
OPTIONAL, -- Need R
  uplink-PowerControlToAddModList-r17 SEQUENCE (SIZE (1..maxUL-TCI-r17)) OF
Uplink-powerControl-r17 OPTIONAL, -- Need N
  uplink-PowerControlToReleaseList-r17 SEQUENCE (SIZE (1..maxUL-TCI-r17)) OF Uplink-
powerControlId-r17 OPTIONAL, -- Need N
```

| | |
|---|---|
| sfnSchemePDCCH-r17 | ENUMERATED {sfnSchemeA,sfnSchemeB} |

OPTIONAL, -- Need R

| | |
|---|---|
| sfnSchemePDSCH-r17 | ENUMERATED {sfnSchemeA,sfnSchemeB} |

OPTIONAL -- Need R
}

As described in the Table 23, the UE may be configured with the upper-layer signaling, unifiedTCI-StateType-r17, from the base station within MIMOParam-r17, and its value may be either separate or joint.
If the UE is configured with the upper-layer signaling, unifiedTCI-StateType-r17, as separate, this may mean that when receiving the configuration and indication related to the unified TCI state from the base station, the UE may individually be configured and indicated with the TCI state applicable to downlink reception (e.g., DL TCI state) and the TCI state applicable to uplink transmission (e.g., UL TCI state). In this case, the UE may be configured with the upper-layer signaling OrJointTCI-StateList and ul-TCI-ToAddModList, which mean the list of DL TCI state and UL TCI state, from the base station, respectively.
If the UE is configured with the upper-layer signaling, unifiedTCI-StateType-r17, as joint, this may mean that when receiving the configuration and indication related to the unified TCI state from the base station, the UE may be configured and indicated with the TCI state (e.g., joint TCI state) applicable to downlink reception and uplink transmission in an unified manner. In this case, the UE may be configured with the upper-layer signaling dl-OrJointTCI-State List, which mean the list of joint UL TCI state, from the base station.

Referring to Table 23, the UE may be configured with the upper-layer signaling uplink-PowerControlToAddModList in MIMOParam-r17. If the UE is configured with the upper-layer signaling unifiedTCI-StateType in the corresponding serving cell, the upper-layer signaling uplink-PowerControlToAddModList may include transmission power control parameters for PUSCH, PUCCH, and SRS. The upper-layer signaling uplink-PowerControlToAddModList may include a list of up to 64 Uplink-powerControl-r17 and Uplink-powerControlId-r17. The upper-layer signaling Uplink-powerControl-r17 may have a structure as shown in Table 24 below.

Referring to Table 23, the UE may be configured with pathlossReferenceLinking (that indicates whether UE shall apply as pathloss reference either the downlink of SpCell (PCell for MCG or PSCell for SCG) or of SCell that corresponds with this uplink) in ServingCellConfig. The upper layer signaling, pathlossReferenceLinking, may mean whether the UE refers to a list of reference signals for pathloss measurement in SpCell (PCell for MCG or PSCell for SCG) or SCell.

TABLE 24
Uplink-powerControl-r17 ::= SEQUENCE {

| | |
|---|---|
| ul-powercontrolId-r17 | Uplink-powerControlId-r17, |

| | |
|---|---|
| p0AlphaSetforPUSCH-r17 | P0AlphaSet-r17 |

OPTIONAL, -- Need R

| | |
|---|---|
| p0AlphaSetforPUCCH-r17 | P0AlphaSet-r17 |

OPTIONAL, -- Need R

| | |
|---|---|
| p0AlphaSetforSRS-r17 | P0AlphaSet-r17 |

OPTIONAL -- Need R
}

| P0AlphaSet-r17 ::= | SEQUENCE { | |
|---|---|---|
| p0-r17 | INTEGER (−16..15) | OPTIONAL, -- |

Need R

| | | |
|---|---|---|
| alpha-r17 | Alpha | OPTIONAL, -- Need |

S

| | |
|---|---|
| closedLoopIndex-r17 | ENUMERATED { i0, i1 } |

}
Uplink-powerControlId-r17 ::= INTEGER(1.. maxUL-TCI-r17)

As shown in Table 24, the UE may include ul-powercontrolId-r17 in one Uplink-powerControl-r17 parameter, and may be configured with individual P0AlphaSet-r17 applicable to PUSCH, PUCCH, or SRS, respectively, and each P0AlphaSet-r17 may include the above-described uplink transmission power parameters p0, alpha, and closed circuit index.

The upper-layer signaling in Table 23 may be applied to all bandwidth parts within the corresponding serving cell. The following Table 25 illustrates a upper-layer signaling structure in which the UE may be configured for each uplink bandwidth part (e.g., BWP-UplinkDedicated).

TABLE 25

| | |
|---|---|
| BWP-UplinkDedicated ::= | SEQUENCE { |
| pucch-Config | SetupRelease { PUCCH-Config } |

OPTIONAL, -- Need M

| | |
|---|---|
| pusch-Config | SetupRelease { PUSCH-Config } |

OPTIONAL, -- Need M

| | |
|---|---|
| configuredGrantConfig | SetupRelease { ConfiguredGrantConfig } |

OPTIONAL, -- Need M

| | |
|---|---|
| srs-Config | SetupRelease { SRS-Config } |

OPTIONAL, -- Need M
...
[[

| | |
|---|---|
| ul-TCI-StateList-r17 | CHOICE { |
| explicitlist | SEQUENCE { |
| ul-TCI-ToAddModList-r17 | SEQUENCE (SIZE (1..maxUL-TCI-r17)) OF TCI- |

UL-State-r17 OPTIONAL, -- Need N

| | |
|---|---|
| ul-TCI-ToReleaseList-r17 | SEQUENCE (SIZE (1..maxUL-TCI-r17)) OF TCI-UL- |

StateId-r17 OPTIONAL -- Need N
},

| | |
|---|---|
| unifiedTCI-StateRef-r17 | ServingCellAndBWP-Id-r17 |
| } | OPTIONAL, -- Need R |
| ul-powerControl-r17 | Uplink-powerControlId-r17 |

OPTIONAL, -- Cond NoTCI-PC
...
[[

| | |
|---|---|
| pathlossReferenceRSToAddModList-r17 | SEQUENCE (SIZE |

(1..maxNrofPathlossReferenceRSs-r17)) OF PathlossReferenceRS-r17

| | |
|---|---|
| | OPTIONAL, -- Need N |
| pathlossReferenceRSToReleaseList-r17 | SEQUENCE (SIZE |

(1..maxNrofPathlossReferenceRSs-r17)) OF PathlossReferenceRS-Id-r17

| | |
|---|---|
| ]] | OPTIONAL -- Need N |

}

As shown in Table 25, the UE may be configured with the upper-layer signaling ul-TCI-StateList-r17 (that indicates the applicable UL TCI states for PUCCH, PUSCH and SRS), and accordingly, the UE may be configured with either explicitlist or unifiedTCI-StateRef-r17. If the UE is configured with explicitlist for the upper-layer signaling ul-TCI-StateList-r17, the UE may explicitly be configured with a list of UL TCI states that may be used in the corresponding uplink bandwidth part through ul-TCI-ToAddModList-r17. If the UE is configured with unifiedTCI-StateRef-r17 (that provides the serving cell and UL BWP where UL TCI states applicable to this UL BWP are defined. The value of unifiedTCI-StateType of current serving cell is the same in the serving cell indicated by unifiedTCI-StateRef) for the upper-layer signaling ul-TCI-StateList-r17, the UE may use the joint TCI state or UL TCI state that may be used in the corresponding uplink bandwidth part by referencing the joint TCI state or UL TCI state configured in another uplink bandwidth part without being explicitly configured in the corresponding uplink bandwidth part. In this case, the upper-layer signaling unifiedTCI-StateRef-r17 may mean the index of an arbitrary bandwidth part within an arbitrary serving cell. In addition, the UE may expect that the serving cell that includes the bandwidth part configured with unifiedTCI-StateRef-r17 and an arbitrary serving cell that includes the bandwidth part that may be configured from the base station through unifiedTCI-StateRef-r17 have the same unifiedTCI-StateType.

As shown in Table 25, if the UE is configured with unifiedTCI-StateType, the UE may be configured with the upper-layer signaling ul-powerControl, and the ul-powerControl may refer to one Uplink-powerControlId-r17. In this case, the UE may be configured with the upper-layer signaling, ul-powerControl (ul-powerControl configures power control parameters for PUCCH, PUSCH and SRS when UE is configured with unifiedTCI-StateType for this serving cell. For each serving cell, ul-powerControl is either configured in all BWP-UplinkDedicated or it is not configured in any BWP-UplinkDedicated. When unifiedTCI-StateRef in the BWP-UplinkDedicated or in the PDSCH-Config if the unifiedTCI-StateType is set to joint, of a serving cell refers to another serving cell, ul-powerControl is either configured in all BWP-UplinkDedicated of these two serving cells or it is not configured in any BWP-UplinkDedicated of these two serving cells.), for all uplink bandwidth parts within a specific serving cell, or may not be configured with the upper-layer signaling ul-powerControl for all uplink bandwidth parts. If the UE is configured with unifiedTCI-StateRef-r17 in BWP-UplinkDedicated, or receives a configuration referencing another serving cell and bandwidth part with the value of unifiedTCI-StateRef-r17 in PDSCH-Config, and unifiedTCI-StateType is configured to joint, the UE may expect to be configured with ul-powerControl in all uplink bandwidth parts within the referenced serving cell and the corresponding serving cell, or not to be configured with ul-powerControl in all uplink bandwidth parts within the referenced serving cell and the corresponding serving cell. In this case, the upper-layer signaling, ul-powerControl, may be configured to the UE only when the condition called NoTCI-PC is met, and the meaning of the condition called NoTCI-PC may mean the case where the upper-layer signaling, ul-powerControl, is not configured within the joint TCI state or UL TCI state in the corresponding serving cell.

As shown in Table 25, if the UE is configured with unifiedTCI-StateType, the UE may be configured with the upper-layer signaling, pathlossReferenceRSToAddModList-r17. The pathlossReferenceRSToAddModList-r17 may mean a list of reference signals (e.g., a CSI-RS config or a SS block) that may be used to calculate pathloss when transmitting PUSCH, PUCCH, or SRS in case that the UE supports unified TCI state. If unifiedTCI-StateType is not configured in the corresponding serving cell, no list may be included in the upper-layer signaling.

If the UE is configured with unifiedTCI-StateType, and if the UE is indicated with a reference signal for pathloss measurement through a TCI state indication, the reference signal for the indicated pathloss measurement may mean a reference signal for pathloss measurement configured within a serving cell to which the indicated TCI state is applied. In this case, if the UE is configured with the pathlossReferenceLinking, the UE may consider that the reference signal for the indicated pathloss measurement means a reference signal for the configured pathloss measurement within a serving cell configured through the pathlossReferenceLinking.

If the UE operates based on the unified TCI state, that is, depending on whether the is configured with the upper-layer signaling, unifiedTCI-StateType, as joint or separate, the upper-layer signaling structure of the TCI state with which the UE may be indicated from the base station may be determined. If the UE is configured with the upper-layer signaling, unifiedTCI-StateType, as joint, the UE may be configured and indicated with the joint TCI state from the base station by using the upper-layer signaling structure shown in Table 26 below. If the UE is configured with the upper-layer signaling, unifiedTCI-StateType, as separate, the UE may be configured and indicated with the DL TCI state from the base station by using the upper-layer signaling structure shown in Table 26 below, and may be configured and indicated with the UL TCI state from the base station by using the upper-layer signaling structure shown in Table 27.

If the UE is configured with the upper-layer signaling, unifiedTCI-StateType, as joint, the UE may expect that pathlossReferenceRS-Id-r17 in Table 26 is always configured, and may expect that pathlossReferenceRS-Id-r17 will not be configured when unifiedTCI-StateType is configured as separate or unifiedTCI-StateType is not configured, and the name of such a condition may be defined as JointTCI1.

If the UE is configured with the upper-layer signaling, unifiedTCI-StateType, as separate, the UE may expect that pathlossReferenceRS-Id-r17 in Table 27 is always configured, and the name of such a condition may be defined as Mandatory.

TABLE 26

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

```
  ...,
  [[
```

| | | |
|---|---|---|
| additionalPCI-r17 | AdditionalPCIIndex-r17 | OPTIONAL, -- |

Need R

| | |
|---|---|
| pathlossReferenceRS-Id-r17 | PathlossReferenceRS-Id-r17 |

OPTIONAL, -- Cond JointTCI1

| | | |
|---|---|---|
| ul-powerControl-r17 | Uplink-powerControlId-r17 | OPTIONAL |

-- Cond JointTCI
]]
}

TABLE 27

| TCI-UL-State-r17 ::= | SEQUENCE { | |
|---|---|---|
| tci-UL-StateId-r17 | TCI-UL-StateId-r17, | |
| servingCellId-r17 | ServCellIndex | OPTIONAL, -- Need R |
| bwp-Id-r17 | BWP-Id | OPTIONAL, -- Cond CSI- |

RSorSRS-Indicated

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | | |
|---|---|---|
| additionalPCI-r17 | AdditionalPCIIndex-r17 | OPTIONAL, -- Need |

R

| | | |
|---|---|---|
| ul-powerControl-r17 | Uplink-powerControlId-r17 | OPTIONAL, -- |

Need R

| | | |
|---|---|---|
| pathlossReferenceRS-Id-r17 | PathlossReferenceRS-Id-r17 | OPTIONAL, - |

- Cond Mandatory
...
}

The UE may be configured with the upper-layer signaling related to the transmission power parameters applicable to SRS transmission according to Table 28 and Table 29. Table 28 illustrates the SRS configuration (SRS-Config), and Table 29 illustrates the SRS resource set configuration (SRS-Resourceset).

TABLE 28

| | |
|---|---|
| SRS-Config ::= | SEQUENCE { |
| srs-ResourceSetToReleaseList | SEQUENCE (SIZE(1..maxNrofSRS-ResourceSets)) OF |
| SRS-ResourceSetId | OPTIONAL, -- Need N |
| srs-ResourceSetToAddModList | SEQUENCE (SIZE(1..maxNrofSRS-ResourceSets)) |
| OF SRS-ResourceSet | OPTIONAL, -- Need N |
| srs-ResourceToReleaseList | SEQUENCE (SIZE(1..maxNrofSRS-Resources)) OF |
| SRS-ResourceId | OPTIONAL, -- Need N |
| srs-ResourceToAddModList | SEQUENCE (SIZE(1..maxNrofSRS-Resources)) OF |
| SRS-Resource | OPTIONAL, -- Need N |
| tpc-Accumulation | ENUMERATED {disabled} |

```
OPTIONAL, -- Need S
  ...,
  [[
```

| | |
|---|---|
| srs-RequestDCI-1-2-r16 | INTEGER (1..2) |

OPTIONAL, -- Need S

| | |
|---|---|
| srs-RequestDCI-0-2-r16 | INTEGER (1..2) |

OPTIONAL, -- Need S

| srs-ResourceSetToAddModListDCI-0-2-r16 | SEQUENCE | (SIZE(1..maxNrofSRS- |
|---|---|---|
| ResourceSets)) OF SRS-ResourceSet | OPTIONAL, -- Need N | |
| srs-ResourceSetToReleaseListDCI-0-2-r16 | SEQUENCE | (SIZE(1..maxNrofSRS- |
| ResourceSets)) OF SRS-ResourceSetId | OPTIONAL, -- Need N | |
| srs-PosResourceSetToReleaseList-r16 | SEQUENCE | (SIZE(1..maxNrofSRS- |

PosResourceSets-r16)) OF SRS-PosResourceSetId-r16

| | | OPTIONAL, -- Need N |
|---|---|---|
| srs-PosResourceSetToAddModList-r16 | SEQUENCE | (SIZE(1..maxNrofSRS- |

| | |
|---|---|
| PosResourceSets-r16)) OF SRS-PosResourceSet-r16 | OPTIONAL, -- Need N |
| srs-PosResourceToReleaseList-r16 | SEQUENCE (SIZE(1..maxNrofSRS-PosResources- |
| r16)) OF SRS-PosResourceId-r16 | OPTIONAL, -- Need N |
| srs-PosResourceToAddModList-r16 | SEQUENCE (SIZE(1..maxNrofSRS-PosResources- |
| r16)) OF SRS-PosResource-r16 | OPTIONAL -- Need N |

]]
}

TABLE 29

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS- |

ResourcesPerSet)) OF SRS-ResourceId OPTIONAL, -- Cond Setup

| | |
|---|---|
| resourceType | CHOICE { |
| aperiodic | SEQUENCE { |
| aperiodicSRS-ResourceTrigger | INTEGER (1..maxNrofSRS- |

TriggerStates−1),

| | |
|---|---|
| csi-RS | NZP-CSI-RS-ResourceId |

OPTIONAL, -- Cond NonCodebook

| | |
|---|---|
| slotOffset | INTEGER (1..32) |

```
OPTIONAL, -- Need S
      ...,
      [[
```

| | |
|---|---|
| aperiodicSRS-ResourceTriggerList | SEQUENCE |

(SIZE(1..maxNrofSRS-TriggerStates−2))

OF INTEGER (1..maxNrofSRS-TriggerStates-

```
1) OPTIONAL -- Need M
      ]]
    },
```

| | |
|---|---|
| semi-persistent | SEQUENCE { |
| associatedCSI-RS | NZP-CSI-RS-ResourceId |

```
OPTIONAL, -- Cond NonCodebook
      ...
    },
```

| | |
|---|---|
| periodic | SEQUENCE { |
| associatedCSI-RS | NZP-CSI-RS-ResourceId |

```
OPTIONAL, -- Cond NonCodebook
      ...
    }
  },
```

| | |
|---|---|
| usage | ENUMERATED {beamManagement, codebook, |

nonCodebook, antennaSwitching},

| | | |
|---|---|---|
| alpha | Alpha | OPTIONAL, |

-- Need S

| | |
|---|---|
| p0 | INTEGER (−202..24) |

OPTIONAL, -- Cond Setup

| | |
|---|---|
| pathlossReferenceRS | PathlossReferenceRS-Config |

OPTIONAL, -- Need M

| | |
|---|---|
| srs-PowerControlAdjustmentStates | ENUMERATED { sameAsFci2, |
| separateClosedLoop} | OPTIONAL, -- Need S |

```
  ...,
  [[
```

| | |
|---|---|
| pathlossReferenceRSList-r16 | SetupRelease { PathlossReferenceRSList- |
| r16} | OPTIONAL -- Need M |

```
  ]],
  [[
```

| | |
|---|---|
| usagePDC-r17 | ENUMERATED {true} |

OPTIONAL, -- Need R

| | |
|---|---|
| availableSlotOffsetList-r17 | SEQUENCE (SIZE(1..4)) OF |
| AvailableSlotOffset-r17 | OPTIONAL, -- Need R |
| followUnifiedTCI-StateSRS-r17 | ENUMERATED {enabled} |

OPTIONAL -- Need R

| | |
|---|---|
| applyIndicatedTCI-State-r18 | ENUMERATED {first, second} |

OPTIONAL -- Cond FollowUTCI
]]
}

The description of each upper-layer signaling parameter in Table 28 and Table 29 may be as follows.
tpc-Accumulation: If the UE is not configured with tpc-Accumulation, the UE may perform an additional accumulation operation on the values of previously indicated TPC commands when receiving a TPC command indicating a change in SRS transmission power. If the UE is configured with tpc-Accumulation as disabled, the UE may perform an operation of applying the absolute TPC without performing an accumulation operation when receiving the TPC command indicating a change in SRS transmission power. Such an absolute TPC operation may be possible when SRS does not share a closed-loop index with PUSCH.
Alpha: The UE may be configured with the alpha value for determining the SRS transmission power through the corresponding upper-layer signaling.
p0: The UE may be configured with the p0 value in the SRS-resourceSet for determining the SRS transmission power through the corresponding upper-layer signaling. If the UE is not configured with the upper-layer signaling, unifiedTCI-StateType, the UE may determine the P_{0_SRS,b,f,c}(qₛ) value in Equation 7 through the corresponding upper-layer signaling, p0. If the UE is configured with the upper-layer signaling, unifiedTCI-StateType, the UE may determine the P_{0_SRS,b,f,c}(qₛ) value in Equation 7 as the sum of the p0 in the corresponding upper-layer signaling, SRS-resourceSet, and the p0 value that may be configured in the p0AlphaSetforSRS in the Uplink-powerControlId-r17 (e.g., P_{0_UE_SRS,b,f,c}(qₛ)). In this case, the Uplink-powerControlId-r17 may be determined through the following method.
If the UE determines the uplink transmission power through [Method 1-1], it may be determined through one ul-powerControl configured within a specific uplink bandwidth part.
If the UE determines the uplink transmission power through [Method 1-2],

If the UE is configured with the upper-layer signaling, followUnifiedTCIstateSRS, in the SRS resource set, the UE may receive P_{0_UE_SRS,b,f,c}(qₛ), alpha, and srs-PowerControlAdjustmentStates values based on the upper-layer signaling, p0AlphaSetforSRS, related to the TCIState or UL-TCIstate indicated by the base station, and receive the upper-layer signaling, pathlossReferenceRS, meaning a pathloss reference signal, based on the upper-layer signaling, pathlossReferenceRS-Id-r17, related to or included in the TCIState or UL-TCIstate indicated by the base station.

If the UE is not configured with the upper-layer signaling, followUnifiedTCIstateSRS, in the SRS resource set, the UE may receive P_{0_UE_SRS,b,f,c}(qₛ), alpha, and srs-PowerControlAdjustmentStates values based on the upper-layer signaling, p0AlphaSetforSRS, related to the TCIState or UL-TCIstate configured in the SRS resource with the lowest index in the SRS resource set, and receive the upper-layer signaling, pathlossReferenceRS, meaning a pathloss reference signal, based on the upper-layer signaling, pathlossReferenceRS-Id-r17, related to or included in the TCIState or UL-TCIstate configured in the SRS resource with the lowest index in the corresponding SRS resource set.
srs-PowerControlAdjustmentStates: The UE may be configured with a closed circuit index used in determining SRS transmission power through the corresponding upper-layer signaling. If the UE is not configured with the corresponding upper-layer signaling, the UE may share the closed circuit index of the SRS with the first closed circuit index of the PUSCH. If the UE is configured with the corresponding upper-layer signaling as sameAsFci2, the UE may share the closed circuit index of the SRS with the second closed circuit index of the PUSCH. In this case, the UE may be configured with the upper-layer signaling so that the UE may have up to two closed circuit indices for the PUSCH. If the UE is configured with the corresponding upper-layer signaling as separateClosedLoop, the UE may be configured with the closed circuit index of the SRS separately without sharing it with the closed circuit index of the PUSCH.
If the UE is configured with the upper-layer signaling unifiedTCI-StateType and configured with the srs-PowerControlAdjustmentStates as separateClosedLoop within a specific SRS resource set, the UE may consider that the SRS resources included in the SRS resource set to be connected to a PUSCH and a separate closed loop index. In this case, the UE may consider the PUSCH and the separate closed loop index as described above, regardless of the closed loop connected to the TCI state indicated by the base station.

If the UE is configured with the upper-layer signaling unifiedTCI-StateType and not configured with the srs-PowerControlAdjustmentStates as separateClosedLoop within a specific SRS resource set ((i.e., if not configured with srs-PowerControlAdjustmentStates or configured with sameAsFci2), the UE may consider that the SRS resources included in the SRS resource set are connected to the first or second closed loop index connected to the PUSCH. In this case, if the closed loop connected to the TCI state indicated by the base station is i₀, the UE may consider that the SRS resources are connected to the first closed loop index connected to the PUSCH when determining the transmission power of the SRS to which the applicable TCI state is applied and if the closed loop is i1, the UE may consider that the SRS resources are connected to the second closed loop index connected to the PUSCH when determining the transmission power of the SRS to which the applicable TCI state is applied.
pathlossReferenceRSList: The UE may be configured with a list of reference signals that may measure the pathloss amount for determining the transmission power of the SRS through the corresponding upper-layer signaling.
follow UnifiedTCI-StateSRS-r17: The UE may determine, through the corresponding upper-layer signaling, whether the joint TCI state or the UL TCI state indicated to the UE through the DCI may be applied to the SRS resource within the corresponding SRS resource set when the UE operates in the unified TCI state, i.e., when the UE is configured with the unifiedTCI-StateType. If the corresponding upper-layer signaling is configured to enabled, the UE may apply the joint TCI state or UL TCI state indicated through DCI to the SRS resource in the corresponding SRS resource set. If the corresponding upper-layer signaling is not configured to the UE, the UE may be configured with the joint TCI state or UL TCI state for each SRS resource in the corresponding SRS resource set, and may not apply the joint TCI state or UL TCI state indicated through DCI to the SRS resources in the corresponding SRS resource set. If the usage of the SRS resource set is configured to beam management and the resourceType is aperiodic, and if the usage of the SRS resource set is configured to codebook, non-codebook, and antenna switching and the resourceType is aperiodic, semi-persistent, and periodic, the UE may be configured with the corresponding upper-layer signaling.
applyIndicatedTCI-State-r18: The UE may be configured to which TCI state to apply for SRS resources within the SRS resource set for which the corresponding upper-layer signaling is configured, through the corresponding upper-layer signaling, when the UE operates in the unified TCI state, i.e., when the UE is configured with the unifiedTCI-StateType and operates as multiple TRPs. If the UE is configured with the followUnifiedTCI-StateSRS-r17, the UE may not be configured with the applyIndicatedTCI-State-r18. If the usage of the SRS resource set is configured to beam management and the resourceType is aperiodic, or if the usage of the SRS resource set is configured to codebook, non-codebook, and antenna switching and the resourceType is aperiodic, semi-persistent, and periodic, the UE may be configured with the corresponding upper-layer signaling within the SRS resource set.
If the UE operates as a single-DCI-based multiple TRPs, i.e., when the UE is configured with two joint TCI states, two DL TCI states, or two UL TCI states in at least one codepoint of the TCI state field in the DCI, if the UE is configured with the corresponding upper-layer signaling as first, the UE may apply the first joint TCI state or the first UL TCI state to one or more SRS resources in the SRS resource set where the corresponding upper-layer signaling is configured among one or more joint TCI states or one or more UL TCI states indicated to the UE through the DCI, and if the UE is configured with the corresponding upper-layer signaling as second, the UE may apply the second joint TCI state or the second UL TCI state to one or more SRS resources in the SRS resource set where the corresponding upper-layer signaling is configured among one or more joint TCI states or one or more UL TCI states indicated to the UE through the DCI. If the UE is not configured with the corresponding upper-layer signaling, the UE may be configured with a joint TCI state or UL TCI state for each of one or more SRS resources in the corresponding SRS resource set, and may not apply the joint TCI state or UL TCI state indicated through DCI to the SRS resources in the corresponding SRS resource set.
If the UE operates as a multi-DCI-based multiple TRPs, i.e., when the UE is configured with two different CORESETPoolIndexes, and when the corresponding upper-layer signaling is configured to first or second, the UE may apply the joint TCI state or UL TCI state indicated through the DCI received in the CORESET with CORESETPoolIndex configured to 0 or 1 to one or more SRS resources in the SRS resource set in which the corresponding upper-layer signaling is configured. If the UE is not configured with the corresponding upper-layer signaling and the SRS resource set with resourceType configured to aperiodic is triggered through DCI, the UE may determine the joint TCI state or UL TCI state to apply based on which CORSET configured with CORESETPoolIndex the corresponding DCI was received from for one or more SRS resources within the corresponding SRS resource set. As an example, if the UE is not configured with the corresponding upper-layer signaling, if the UE is configured with the followUnifiedTCI-StateSRS-r17, and if the SRS resource set with resourceType configured to aperiodic is triggered by a DCI received within a CORESET with CORESETPoolIndex configured to 0, the UE may apply the joint TCI state or UL TCI state indicated by the DCI received within the CORESET with CORESETPoolIndex configured to 0 for one or more SRS resources within the SRS resource set. As another example, if the UE is not configured with the corresponding upper-layer signaling, and if the SRS resource set with resourceType configured to aperiodic is triggered by a DCI received within a CORESET with CORESETPoolIndex configured to 1, the UE may apply the joint TCI state or UL TCI state indicated by the DCI received within the CORESET with CORESETPoolIndex configured to 1 for one or more SRS resources within the SRS resource set. As an example, if the UE is not configured with the corresponding upper-layer signaling, and if the UE is not configured with the followUnifiedTCI-StateSRS-r17, the UE may be configured with the joint TCI state or UL TCI state for each of one or more SRS resources within the corresponding SRS resource set, and may not apply the joint TCI state or UL TCI state indicated through DCI to the SRS resources within the corresponding SRS resource set.

Considering the structure of the upper-layer signaling described above, the UE may use two uplink transmission power determination methods when operating in the unified TCI state.

### [Method 1-1] Basic Transmission Power Determination Method: Applying Common Transmission Power Parameters

The UE may be configured with the ul-powerControl parameter for each of one or more uplink bandwidth parts configured within a specific serving cell. That is, the UE may apply a set of transmission power parameters (e.g., p0, alpha, closed-loop index) that may be known through the ul-powerControl configured in the uplink bandwidth part to all uplink transmissions within each uplink bandwidth part. Therefore, the UE may use only a one set of common transmission power parameters without using individual transmission power parameters according to the uplink channel and signal.

### [Method 1-2] Additional Transmission Power Determination Method: Different Transmission Power Parameters May be Applied

The UE may not be configured with the ul-powerControl parameter for each of one or more uplink bandwidth parts configured within a specific serving cell, and may apply a set of transmission power parameters (e.g., p0, alpha, closed circuit index) that may be known through the upper-layer signaling ul-powerControl-r17 in the joint TCI state or UL TCI state as shown in Table 26 or Table 27. Therefore, the UE may be configured with different joint TCI states or different ul-powerControl-r17 for each UL TCI state, and accordingly, various transmission power parameters may be operated compared to [Method 1-1], and different transmission power parameters may be used depending on the uplink transmission situation and the UE and base station operation scenario.

In common with the above-described [Method 1-1] and [Method 1-2], the UE may be configured with a reference signal for pathloss measurement in the joint TCI state or the UL TCI state. That is, as described above, if the UE operates in the unified TCI state, the UE may always be configured with the reference signal for pathloss measurement in the joint TCI state or the UL TCI state, and the UE may determine the pathloss to be reflected when determining the uplink transmission power by using the reference signal for pathloss measurement configured in the configured and indicated unified TCI state. In addition, the UE may track up to four reference signals for pathloss measurement per an arbitrary serving cell and update up to four different pathlosses.

The UE may transmit whether to support at least one combination of [Method 1-1] and [Method 1-2] through the UE capability report. In addition, the UE may be configured with at least one combination of [Method 1-1] and [Method 1-2] from the base station through upper-layer signaling.

### Second Embodiment: Method for Calculating Pathloss Offset Between UE and Base Station

As an embodiment of the disclosure, a method for calculating pathloss offset between a UE and a base station is described. This embodiment may be operated in combination with another embodiment.

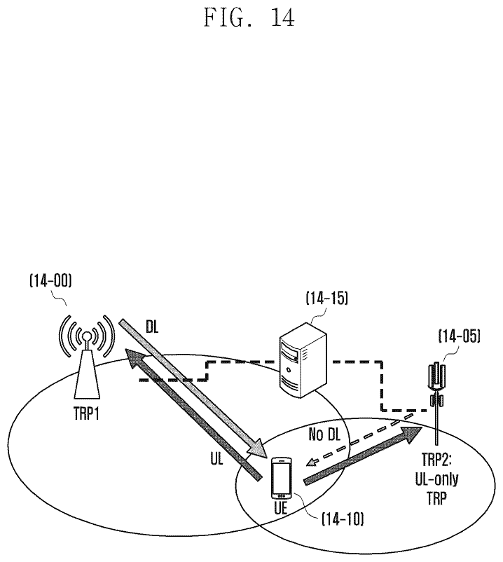

FIG. 14 is a drawing illustrating an example of operations of a base station and a UE operating as multiple TRPs, including a TRP that supports only an uplink reception function according to an embodiment of the disclosure.

Referring to FIG. 14, a UE 14-10 may be connected to and operate with a base station 14-15 operating as multiple TRPs as described above. Basically, the UE may assume that each of the multiple TRPs supports both uplink reception and downlink transmission. In this case, the base station may operate a TRP 14-05 (e.g., the TRP2) that supports only uplink reception function in addition to a conventional TRP 14-00 (e.g., the TRP1) that supports both uplink reception and downlink transmission, for the purpose of improving uplink coverage from the perspective of the UE or for the purpose of energy saving gain that may be obtained by saving downlink transmission power by the base station. This TRP that supports only uplink reception may be named a UL-only TRP. The UE may assume that downlink transmission does not occur from this UL-only TRP. In this case, as an assumption for such UL-only TRP, the base station and UE may consider at least one combination among the following.
The corresponding UL-only TRP may operate as a UL-only TRP only for specific UEs. That is, the corresponding UL-only TRP has both uplink reception and downlink transmission functions, but may support only the uplink reception function for specific UEs under a specific condition (for example, by notifying the UE that it is connected to the UL-only TRP through at least one combination of specific upper-layer signaling, MAC-CE, and L1 signaling). That is, downlink transmission may be supported to other UEs. When specific UEs exist at the boundary of arbitrary cell coverage, this UL-only TRP may expand the uplink coverage by additionally operating only the reception function of the TRP already installed or newly installed near the location.
Alternatively, the corresponding UL-only TRP may be a TRP that does not support the downlink transmission function for all UEs, but only supports the uplink reception function. That is, the corresponding UL-only TRP is a TRP with relatively low production and installation costs, and may be used to receive uplink transmissions from UEs in addition to the existing TRPs, thereby obtaining reception diversity from the base station's perspective.

The UE may receive a pathloss measurement reference signal from the TRP 14-00 capable of uplink and downlink operations, but since downlink transmission is not performed from the UL-only TRP 14-05, there may be a problem that the pathloss between the UL-only TRP and the UE cannot be known when the UE 14-10 performs uplink transmission toward the UL-only TRP 14-05. To solve this situation, the base station and the UE may consider a combination of at least one of the following methods to obtain pathloss information between the UL-only TRP and the UE.

### [Method 2-1]

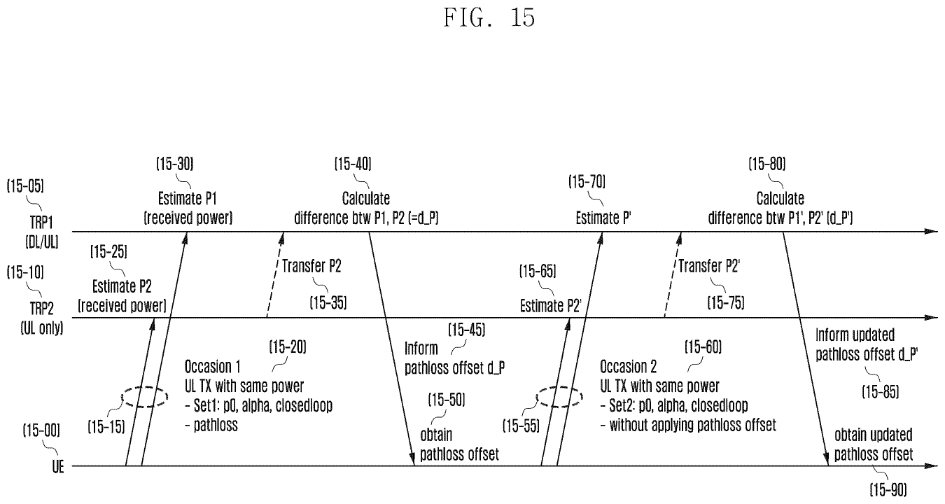

FIG. 15 is a drawing illustrating a method of calculating and updating a pathloss offset according to an embodiment of the disclosure.

Referring to FIG. 15, a UE 15-00 may operate by being connected to a base station consisting of a TRP (e.g., the TRP1 15-05) capable of uplink and downlink operations and a UL-only TRP (e.g., the TRP2 15-10) capable of performing uplink reception only. The UE 15-00 and the base station may go through a series of processes of exchanging signals between the UE 15-00 and the base station to obtain information on the pathloss between the TRP2 15-10 and the UE 15-00.

### [Process 2-1] Uplink Transmission of UE

The UE 15-00 may transmit an uplink signal to the TRP1 15-05 and the TRP2 15-10 (15-15). In this case, if the UE operates in FR1, the UE may transmit uplink signals to the TRP1 15-05 and the TRP2 15-10 only with a single uplink transmission, and if the UE operates in FR2, the UE may perform individual uplink transmission by applying different transmission beams to the TRP1 15-05 and the TRP2 15-10. If the UE operates in FR2, when the UE determines the transmission power of individual uplink signals transmitted to the TRP1 15-05 and the TRP2 15-10, the UE may apply the same transmission power parameters (15-20). That is, when the UE determines the transmission power of two uplink signals, the UE may consider the same p0, alpha, closed-loop index, and pathloss between the TRP1 15-05 and the UE. Therefore, even if the transmission power of the uplink signal transmitted by the UE to the TRP2 15-10 is the transmission power, the UE may apply the pathloss between the TRP1 15-05 and the UE when determining the transmission power for TRP2 (15-10).

### [Process 2-2] Calculating Pathloss Offset at Base Station

Then, the TRP1 15-05 and the TRP2 15-10 may receive the uplink transmissions of this UE, respectively, and calculate the reception power P1 15-30 and P2 15-25 at each TRP. The TRP2 15-10 may transmit P2 to the TRP1 15-05 (15-35). The TRP1 15-05 receiving P2 from the TRP2 15-10 may calculate d_P, which is the difference between P1 and P2 (15-40). In this case, when d_P is calculated in the TRP1 15-05 (15-40), the TRP1 15-05 may consider the reception beam gain at the TRP1 15-05, the reception beam gain at the TRP2 15-10, and the maximum permissible exposure (MPE) value that may determine the transmission beam gain and the transmission power reduction amount for each transmission beam when the UE transmits to the TRP1 15-05 and the TRP2 15-10 in case of FR2.

### [Process 2-3] Transmitting Pathloss Offset to UE

The base station may calculate the pathloss offset d_P, which is the difference between the pathloss between the TRP1 15-05 and the UE and the pathloss between the TRP2 15-10 and the UE, and then inform the UE of the value (15-45). Through this process, the UE may obtain the d_P value (15-50), and then, when transmitting uplink for the TRP2 15-10, in addition to the pathloss that may be measured through the reference signal for pathloss measurement that may be received from the TRP1 15-05, the d_P value may be applied to determine the uplink transmission power for the TRP2 15-10.

Through [Process 2-1] to [Process 2-3], the base station may calculate d_P, which is the difference value between the pathloss between the TRP1 and the UE and the pathloss between the TRP2 and the UE, by utilizing the reception power information of the uplink signal of the UE. In [Process 2-3], the base station may process one or more d_P values calculated by repeating [Process 2-1] and [Process 2-2] one or more times (for example, taking the arithmetic mean) and transmit the values to the UE.

Meanwhile, in the case of UEs that are not fixed to a specific location such as the customer premises equipment (CPE), UEs such as smartphones, smartwatches, and tablets may have mobility without being fixed in location, so d_P may be a value that changes over time. Therefore, [Process 2-1] to [Process 2-3] may be configured or activated to be repeated periodically or semi-continuously for the UE, or may be triggered aperiodically for the UE. In order to identify the changed d_P value and transmit the same to the UE, the following additional processes may be considered between the UE and the base station.

[Process 2-4] Uplink Transmission of UE after Acquiring d_P

After acquiring d_P from the base station, the UE 15-00 may transmit an uplink signal to the TRP1 15-05 and the TRP2 15-10 (15-55). In this case, if the UE operates in FR1, the UE may transmit uplink signals to the TRP1 15-05 and the TRP2 15-10 only with a single uplink transmission, and if the UE operates in FR2, the UE may perform individual uplink transmission by applying different transmission beams to the TRP1 15-05 and the TRP2 15-10. If the UE operates in FR2, when the UE determines the transmission power of individual uplink signals transmitted to the TRP1 15-05 and the TRP2 15-10, the UE may apply the same transmission power parameters (15-60). That is, when the UE determines the transmission power of two uplink signals, the UE may consider the same p0, alpha, closed-loop index, and pathloss between the TRP1 15-05 and the UE. In addition, although the UE acquired the d_P value through the above [Process 2-3], the UE may transmit without applying d_P when determining the uplink transmission power to the TRP2 15-10 so that the base station may calculate the difference value between the pathloss between the TRP1 15-05 and the UE and the pathloss between the TRP2 15-10 and the UE by applying the same transmission power parameter to the two TRPs (15-60). Therefore, even if the transmission power of the uplink signal transmitted by the UE to the TRP2 15-10 is the transmission power, the UE may apply the pathloss between the TRP1 15-05 and the UE when determining the corresponding transmission power.

### [Process 2-5] Calculating Pathloss Offset at Base Station

Then, the TRP1 15-05 and the TRP2 15-10 may receive the uplink transmissions of the UE in [Process 2-4], respectively, and calculate the reception power P₁′ 15-70 and P2′ 15-65 at each TRP. The TRP2 15-10 may transmit P2′ to the TRP1 15-05 (15-75). The TRP1 15-05 receiving P2′ from the TRP2 15-10 may calculate d_P′, which is the difference between P1′ and P2′ (15-80). In this case, when d_P′ is calculated in the TRP1 15-05 (15-80), the TRP1 15-05 may consider the reception beam gain at the TRP1 15-05, the reception beam gain at the TRP2 15-10, and the maximum permissible exposure (MPE) value that may determine the transmission beam gain and the transmission power reduction amount for each transmission beam when the UE transmits to the TRP1 15-05 and the TRP2 15-10 in case of FR2.

### [Process 2-6] Transmitting Pathloss Offset to UE

The base station may calculate d_P′, which is the pathloss offset between the TRP1 15-05 and the UE and the pathloss between the TRP2 15-10 and the UE, and then inform the UE of the value (15-85). Through this process, the UE may obtain the d_P′ value updated compared to previously obtained d_P value (15-90), and then, when transmitting uplink for the TRP2 15-10, in addition to the pathloss that may be measured through the reference signal for pathloss measurement that may be received from the TRP1 15-05, the d_P′ value may be applied to determine the uplink transmission power for the TRP2 15-10.

Afterwards, the UE and the base station may repeat [Process 2-4] to [Process 2-6] to calculate and share updated values of the d_P value. In [Process 2-6], the base station may process (for example, take the arithmetic mean) one or more d_P′ values calculated by repeating [Process 2-4] and [Process 2-5] one or more times and transmit the d_P′ values to the UE.

If the UE performs the uplink transmission as shown in [Process 2-1] and [Process 2-4], the UE may be configured with one or more SRS resources in the SRS resource set in which the upper-layer signaling resourceType is configured to periodic, semi-persistent, or aperiodic to perform [Process 2-1] and [Process 2-4] based on SRS transmission, and all of these one or more SRS resources may have the same transmission power parameter. If the UE operates in FR1, the UE may apply the same transmission power parameters (e.g., p0, alpha, closed-loop index, and pathloss) to the TRP1 15-05 and the TRP2 15-10 based on one SRS resource in the corresponding SRS resource set, and even if it is an uplink transmission for the TRP2 15-10, the pathloss offset may not be applied when determining the transmission power as described above. If the UE operates in FR2, the UE may apply the same transmission power parameters (e.g., p0, alpha, closed-loop index, and pathloss) to the TRP1 15-05 and the TRP2 15-10 based on one or more SRS resources in the corresponding SRS resource set, and may apply different transmission beams to each SRS resource. Similarly, even if it is an uplink transmission for the TRP2 15-10, the UE may not apply the pathloss offset when determining the transmission power as described above.

The UE may perform the uplink transmission shown in [Process 2-1] and [Process 2-4] through the uplink channel and signal other than SRS (for example, PUCCH, PUSCH, PRACH).

When the UE performs the uplink transmission shown in [Process 2-1] and [Process 2-4], it is necessary to apply the same transmission power parameter to the uplink channel or signal transmitted to the TRP1 15-05 and the TRP2 15-10 within each process, but it may be possible to use different transmission power parameters between processes (for example, the transmission power parameter used in [Process 2-1] and the transmission power parameter used in [Process 2-4]). As an example, if the UE determines the uplink transmission power by using the first p0, the first alpha, the first closed-loop index, and the first pathloss in [Process 2-1] and transmits the same to the TRP1 15-05 and the TRP2 15-10, the UE may determine the uplink transmission power by using the second p0, the second alpha, the second closed-loop index, and the second pathloss in [Process 2-4] and transmit the same to the TRP1 15-05 and the TRP2 15-10, and in this case, the first p0 and the second p0 may be the same or different, and a similar relationship may be established for other transmission power parameters.

In the case of [Method 2-1], the UE may receive the d_P value from the base station through [Process 2-3] and [Process 2-6]. In the case of [Method 2-1], since the UE receives the d_P value from the base station, when considering the same quantization bit amount, the UE may receive an inaccurate value compared to receiving the d_P″ value that may be considered in the following [Method 2-2], but as described above, since there is no constraint that the same transmission power parameter must be used between each transmission time point as in [Process 2-1] and [Process 2-4], the base station may be flexible in operating such uplink transmission.

### [Method 2-2]

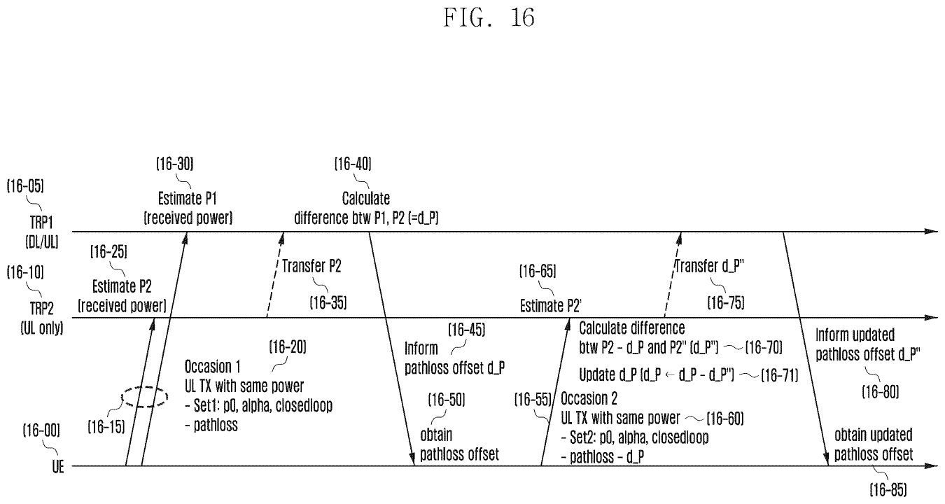

FIG. 16 is a drawing illustrating another method of calculating and updating a pathloss offset according to an embodiment of the disclosure.

Referring to FIG. 16, a UE 16-00 may operate by being connected to a base station consisting of a TRP (e.g., the TRP1 16-05) capable of uplink and downlink operations and a UL-only TRP (e.g., the TRP2 16-10) capable of performing uplink reception only. The UE 16-00 and the base station may go through a series of processes of exchanging signals between the UE 16-00 and the base station to obtain information on the pathloss between the TRP2 16-10 and the UE 16-00.

### [Process 3-1] Uplink Transmission of UE

The UE 16-00 may transmit an uplink signal to the TRP1 16-05 and the TRP2 16-10 (16-15). In this case, if the UE operates in FR1, the UE may transmit uplink signals to the TRP1 16-05 and the TRP2 16-10 only with a single uplink transmission, and if the UE operates in FR2, the UE may perform individual uplink transmission by applying different transmission beams to the TRP1 16-05 and the TRP2 16-10. If the UE operates in FR2, when the UE determines the transmission power of individual uplink signals transmitted to the TRP1 16-05 and the TRP2 16-10, the UE may apply the same transmission power parameters (16-20). That is, when the UE determines the transmission power of two uplink signals, the UE may consider the same p0, alpha, closed-loop index, and pathloss between the TRP1 16-05 and the UE. Therefore, even if the transmission power of the uplink signal transmitted by the UE to the TRP2 16-10 is the transmission power, the UE may apply the pathloss between the TRP1 16-05 and the UE when determining the corresponding transmission power.

### [Process 3-2] Calculating Pathloss Offset at Base Station

Then, the TRP1 16-05 and the TRP2 16-10 may receive the uplink transmissions of this UE, respectively, and calculate the reception power P₁ 16-30 and P2 16-25 at each TRP. The TRP2 16-10 may transmit P2 to the TRP1 16-05 (16-35). The TRP1 16-05 receiving P2 from the TRP2 16-10 may calculate d_P, which is the difference between P1 and P2 (16-40). In this case, when d_P is calculated in the TRP1 16-05 (16-40), the TRP1 16-05 may consider the reception beam gain at the TRP1 16-05, the reception beam gain at the TRP2 16-10, and the maximum permissible exposure (MPE) value that may determine the transmission beam gain and the transmission power reduction amount for each transmission beam when the UE transmits to the TRP1 16-05 and the TRP2 16-10 in case of FR2.

### [Process 3-3] Transmitting Pathloss Offset to UE

The base station may calculate the pathloss offset d_P, which is the difference between the pathloss between the TRP1 16-05 and the UE and the pathloss between the TRP2 16-10 and the UE, and then inform the UE of the value (16-45). Through this process, the UE may obtain the d_P value (16-50), and then, when transmitting uplink for the TRP2 16-10, in addition to the pathloss that may be measured through the reference signal for pathloss measurement that may be received from the TRP1 16-05, the d_P value may be applied to determine the uplink transmission power for the TRP2 16-10.

Through [Process 3-1] to [Process 3-3], the base station may calculate d_P, which is the difference value between the pathloss between the TRP1 and the UE and the pathloss between the TRP2 and the UE, by utilizing the reception power information of the uplink signal of the UE. In [Process 3-3], the base station may process one or more d_P values calculated by repeating [Process 3-1] and [Process 3-2] one or more times (for example, taking the arithmetic mean) and transmit the values to the UE. In addition, in [Process 3-3], the base station may initially perform the notification of the d_P value to the UE once at the base station, and when the UE and the base station repeat [Process 3-1] and [Process 3-2] thereafter, the base station may optionally perform [Process 3-3].

Meanwhile, in the case of UEs that are not fixed to a specific location such as the customer premises equipment (CPE), UEs such as smartphones, smartwatches, and tablets may have mobility without being fixed in location, so d_P may be a value that changes over time. Therefore, [Process 3-1] to [Process 3-3] may be configured or activated to be repeated periodically or semi-continuously for the UE, or may be triggered aperiodically for the UE. In this case, if [Process 2-4] to [Process 2-6] are methods in which the UE and the base station update the d_P value and share the same with each other, the following [Process 3-4] to [Process 3-6] may be methods in which the UE and the base station consider the d_P value acquired through [Process 3-1] to [Process 3-3] as the initial value and calculate the change amount and share the same with each other. In order to identify the changed amount of the d_P value and transmit the same to the UE in this way, the following additional processes may be considered between the UE and the base station.

[Process 3-4] Uplink Transmission of UE after Acquiring d_P

After acquiring d_P from the base station, the UE 16-00 may transmit an uplink signal to the TRP2 16-10 (16-55). In this case, the UE may use the p0, alpha, and closed-circuit index among the transmission power parameters used in [Process 3-1], and in the case of pathloss, may apply the d_P value obtained in [Process 3-3] to the amount of pathloss between the TRP1 16-05 and the UE 16-60 to use the pathloss (16-60). If the UE operates in FR2, the UE may use the same or different transmission beam used in [Process 3-1] and [Process 3-4]. If the UE uses the same transmission beam in [Process 3-1] and [Process 3-4], the does not have to compensate for the difference in the transmission beam gain value due to the change in the transmission beam at the UE when calculating the change in d_P in the subsequent process, but if not (i.e., when the UE uses different transmission beams in [Process 3-1] and [Process 3-4]), the base station may increase the accuracy when calculating the change in the d_P value by compensating for the difference in each transmission beam gain value in the subsequent process.

### [Process 3-5] Calculating Pathloss Offset at Base Station

Then, the TRP2 16-10 may receive the uplink transmission of the UE in [Process 3-4], and calculate the reception power P2″ 16-65. The TRP2 16-10 may compare the value obtained by subtracting the d_P value from P2 calculated in [Process 3-2] (for example, P2−d_P) with P2″ value. In this case, since the P2 is a reception power value calculated based on a transmission power parameter that does not consider the pathloss offset, and the P2″ is a reception power value calculated by additionally applying the pathloss offset to the same transmission power parameter as when calculating the P2, comparing the value obtained by subtracting the d_P value from P2 with P2″ may be equivalent to estimating the change in the d_P value. Through this, the TRP2 16-10 may calculate d_P″, which is the change in the d_P value (16-70). In this case, when calculating d_P″ in the TRP2 16-10 (16-70), the TRP2 16-10 may consider the reception beam gain at the TRP2 16-10, each transmission beam gain considered by the UE when transmitting to the TRP2 16-10 in the case of FR2, and the maximum permissible exposure (MPE) value that may determine the transmission power reduction amount for each transmission beam. Thereafter, the TRP2 16-10 may update the previously calculated d_P value by considering d_P″ (16-71, for example, d_P=d_P−d_P″). Thereafter, the TRP2 16-10 may transmit the d_P″ value to the TRP1 16-05 (16-75).

### [Process 3-6] Transmitting Pathloss Offset to UE

The base station may calculate the d_P″ that is the change in d_P, which is the difference between the pathloss offset between the TRP1 16-05 and the UE and the pathloss between the TRP2 16-10 and the UE, and then notify the UE of the change in d_P (16-80). Through this process, the UE may obtain the d_P value updated compared to the previous one by applying the amount of change in the d_P value from the previously acquired d_P value (16-85), and then, when transmitting uplink for the TRP2 16-10, in addition to the pathloss that may be measured through the reference signal for pathloss measurement that may be received from the TRP1 16-05, the UE may determine the uplink transmission power for the TRP2 (16-10) by applying the d_P value, which is the pathloss offset, and the d_P″ value, which is the change in d_P.

Afterwards, the UE and the base station may repeat [Process 3-4] to [Process 3-6] to calculate and share updated values of the d_P value. In [Process 3-6], the base station may process (for example, take the arithmetic mean) one or more d_P′ values calculated by repeating [Process 3-4] and [Process 3-5] one or more times and transmit the d_P″ values to the UE. In addition, the TRP2 (16-10) may also use one or more d_P″ values calculated by repeating [Process 3-4] and [Process 3-5] one or more times in [Process 3-5] after processing to update d_P value.

When the UE performs the uplink transmission as shown in [Process 3-1], the UE may be configured with one or more SRS resources in the SRS resource set in which the upper-layer signaling resourceType is configured to periodic, semi-persistent, or aperiodic to perform the uplink transmission based on SRS transmission, and all of these one or more SRS resources may have the same transmission power parameter. If the UE operates in FR1, the UE may apply the same transmission power parameters (e.g., p0, alpha, closed-loop index, and pathloss) to the TRP1 16-05 and the TRP2 16-10 based on one SRS resource in the corresponding SRS resource set, and even if it is an uplink transmission for the TRP2 16-10, the pathloss offset may not be applied when determining the transmission power as described above. If the UE operates in FR2, the UE may apply the same transmission power parameters (e.g., p0, alpha, closed-loop index, and pathloss) to the TRP1 16-05 and the TRP2 16-10 based on one or more SRS resources in the corresponding SRS resource set, and may apply different transmission beams to each SRS resource. Similarly, even if it is an uplink transmission for the TRP2 16-10, the UE may not apply the pathloss offset when determining the transmission power as described above.

When the UE performs the uplink transmission as shown in [Process 3-4], the UE may be configured with one or more SRS resources in the SRS resource set in which the upper-layer signaling resourceType is configured to periodic, semi-persistent, or aperiodic to perform the uplink transmission based on SRS transmission, and all of these one or more SRS resources may have the same transmission power parameter.

If the UE performs both the uplink transmission in [Process 3-1] and the uplink transmission in [Process 3-4] based on SRS resources in the SRS resource set in which the resourceType is configured to periodic or semi-persistent, the UE may assume that the period of the uplink transmission for [Process 3-1] is longer than or equal to the period of the uplink transmission for [Process 3-4]. As an example, if the period of uplink transmission for [Process 3-1] is 10 slots and the period of uplink transmission for [Process 3-4] is 2 slots, the UE does not need to consider the constraint that the transmission power parameter must be the same between each transmission time point of the uplink transmission for [Process 3-1], and as described above, if the transmission for the TRP1 16-05 and the TRP2 16-10 is performed individually within each transmission time point of the uplink transmission for the above [Process 3-1], the UE may consider that the transmission power parameters for the two TRPs are the same. In addition, in the case of uplink transmission for [Process 3-4], the UE may use the transmission power parameter used in the transmission period of the uplink transmission for the most recent [Process 3-1] performed prior to the uplink transmission. As an example, if the uplink transmission for [Process 3-1] is performed in slot n and the first transmission power parameter set is used at that time, when the uplink transmission for [Process 3-1] is performed from the corresponding slot to the next period, slot n+10, the UE may use the first transmission power parameter set, and as described above, the pathloss offset described above may also be applied when performing the uplink transmission for [Process 3-4]. This is because, in [Process 3-4], when calculating d_P″ in the TRP2 16-10, the P₂ value, which is the reception power calculated through the previous uplink transmission, is considered, so there is a constraint that the transmission power parameter must be the same for the two uplink transmissions, so that a more accurate d_P″ value may be calculated.

The UE may also perform the uplink transmission shown in [Process 3-1] and [Process 3-4] through uplink channels and signals (e.g., PUCCH, PUSCH, PRACH) other than SRS.

In the case of [Method 2-2], the UE may receive the d_P value from the base station at least once initially through [Process 3-3], and may be informed of the d_P″ value from the base station through [Process 3-6]. In the case of [Method 2-2], although the UE may need to be configured by the base station for different uplink transmissions for [Process 3-1] and [Process 3-4], signaling overhead may be added, but considering the same quantization bit amount, the UE may have the advantage of receiving a more accurate value for the pathloss offset by receiving the d_P″ value rather than the d_P value transmitted by the base station.

Through the above-described [Method 2-1] and [Method 2-2], the UE may use the modified transmission power calculation equation as follows when determining the uplink transmission power for UL-only TRP.

As an example, when determining the PUCCH transmission power for UL-only TRP that supports only uplink reception operation, the UE may modify Equation 2 as shown in Equation 11 below to use. In this case, PL_{off,b,f,c}(q_{d}) in Equation 11 below may be considered as the d_P value, which is the pathloss offset, and q_{d} may mean that the corresponding pathloss offset corresponds to one or more pathloss measurement reference signals. In this case, if q_{d}* corresponds to one pathloss measurement reference signal, the UE may also consider q_{d}*=q_{d}.

$${P}_{PUCCH , b , f , c} ( i , {q}_{u} , {q}_{d} , l ) = \qquad Equation 11$$

$$min \{ \begin{matrix}{P}_{CMAX , f , c} ( i ) , \\ \begin{matrix}{P}_{{0}_{PUCCH} , b , f , c} ( {q}_{u} ) + 10 {log}_{10} ( {2}^{μ} * {M}_{RB , b , f , c}^{PUCCH} ( i ) ) + {PL}_{b , f , c} ( {q}_{d} ) + \\ {PL}_{off , b , f , c} ( {q}_{d}^{*} ) + {Δ}_{{F}_{PUCCH}} ( F ) + {Δ}_{TF , b , f , c} ( i ) + {f}_{b , f , c} ( i , l )\end{matrix}\end{matrix} \} [ dBm ]$$

As another example, when determining the PUCCH transmission power for UL-only TRP that supports only uplink reception operation, the UE may modify Equation 4 as shown in Equation 12 or Equation 13 below to use. In this case, PL_{off,b,f,c}(q_{d}) in Equation 12 or Equation 13 below may be considered as the d_P value, which is the pathloss offset, and q_{d}* may mean that the corresponding pathloss offset corresponds to one or more pathloss measurement reference signals. In this case, if q_{d}* corresponds to one pathloss measurement reference signal, the UE may also consider q_{d}*=q_{d}. Equation 12 or Equation 13 below may be distinguished depending on whether the value of PL_{off,b,f,c}(q_{d}), which is the pathloss offset, is directly applied to the pathloss.

$${P}_{PUSCH , b , f , c} ( i , j , {q}_{d} , l ) = \qquad Equation 12$$

$$min \{ \begin{matrix}{P}_{CMAX , f , c} ( i ) , \\ \begin{matrix}{P}_{0 \_ PUSCH , b , f , c} ( j ) + 10 {log}_{10} ( {2}^{μ} * {M}_{RB , b , f , c}^{PUSCH} ( i ) ) + {α}_{b , f , c} ( j ) \cdot \\ ( {PL}_{b , f , c} ( {q}_{d} ) + {PL}_{off , b , f , c} ( {q}_{d}^{*} ) ) + {Δ}_{TF , b , f , c} ( i ) + {f}_{b , f , c} ( i , l )\end{matrix}\end{matrix} \} [ dBm ]$$

$${P}_{PUSCH , b , f , c} ( i , j , {q}_{d} , l ) = \qquad Equation 13$$

$$min \{ \begin{matrix}{P}_{CMAX , f , c} ( i ) , \\ \begin{matrix}{P}_{0 \_ PUSCH , b , f , c} ( j ) + 10 {log}_{10} ( {2}^{μ} * {M}_{RB , b , f , c}^{PUSCH} ( i ) ) + {α}_{b , f , c} ( j ) \cdot \\ {PL}_{b , f , c} ( {q}_{d} ) + {PL}_{off , b , f , c} ( {q}_{d}^{*} ) + {Δ}_{TF , b , f , c} ( i ) + {f}_{b , f , c} ( i , l )\end{matrix}\end{matrix} \} [ dBm ]$$

As another example, when determining the PUCCH transmission power for UL-only TRP that supports only uplink reception operation, the UE may modify Equation 7 as shown in Equation 14 or Equation 15 below to use. In this case, PL_{off,b,f,c}(q_{d}) in Equation 14 or Equation 15 below may be considered as the d_P value, which is the pathloss offset, and q_{d}* may mean that the corresponding pathloss offset corresponds to one or more pathloss measurement reference signals. In this case, if q_{d}* corresponds to one pathloss measurement reference signal, the UE may also consider q_{d}*=q_{d}. Equation 14 or Equation 15 below may be distinguished depending on whether the value of PL_{off,b,f,c}(q_{d}*), which is the pathloss offset, is directly applied to the pathloss.

$${P}_{SRS , b , f , c} ( i , {q}_{s} , l ) = \qquad Equation 14$$

$$min \{ \begin{matrix}{P}_{CMAX , f , c} ( i ) , \\ \begin{matrix}{P}_{0 \_ SRS , b , f , c} ( {q}_{s} ) + 10 {log}_{10} ( {2}^{μ} * {M}_{SRS , b , f , c} ( i ) ) + \\ {α}_{SRS , b , f , c} ( {q}_{s} ) \cdot ( {PL}_{b , f , c} ( {q}_{d} ) + {PL}_{off , b , f , c} ( {q}_{d}^{*} ) ) + {h}_{b , f , c} ( i , l )\end{matrix}\end{matrix} \} [ dBm ]$$

$${P}_{SRS , b , f , c} ( i , {q}_{s} , l ) = \qquad Equation 15$$

$$min \{ \begin{matrix}{P}_{CMAX , f , c} ( i ) , \\ \begin{matrix}{P}_{0 \_ SRS , b , f , c} ( {q}_{s} ) + 10 {log}_{10} ( {2}^{μ} * {M}_{SRS , b , f , c} ( i ) ) + \\ {α}_{SRS , b , f , c} ( {q}_{s} ) \cdot {PL}_{b , f , c} ( {q}_{d} ) + {PL}_{off , b , f , c} ( {q}_{d}^{*} ) + {h}_{b , f , c} ( i , l )\end{matrix}\end{matrix} \} [ dBm ]$$

The UE may expect to be informed by the base station of at least one combination of [Method 2-1] and [Method 2-2] through at least one combination of upper-layer signaling, MAC-CE signaling, and L1 signaling, or at least one combination of [Method 2-1] and [Method 2-2] is fixedly defined in the standard. In addition, if the UE is informed by the base station of at least one combination of specific methods through at least one combination of upper-layer signaling, MAC-CE signaling, and L1 signaling, this may mean that the UE cannot support at least one other combination of specific methods. As an example, the UE may expect that [Method 2-1] or [Method 2-2] is fixedly defined in the standard for the method of obtaining and updating the pathloss offset. As another example, the UE may be informed of [Method 2-1] from the base station through at least one combination of upper-layer signaling, MAC-CE signaling, and L1 signaling, in this case, the UE may consider that it is informed by the base station that [Method 2-2] is not supported.

The UE may report to the base station whether to support at least one combination of [Method 2-1] and [Method 2-2] as a UE capability. In this case, if the UE reports to the base station as the UE capability that a combination of one or more specific methods is supportable, it may be considered that the UE has reported that the UE cannot support one or more other combinations of methods. As an example, the UE may report to the base station whether the UE may support [Method 2-1] or [Method 2-2]. As another example, the UE may report to the base station that the UE may support [Method 2-1], and this UE capability report may mean that the UE cannot support [Method 2-2].

### Third Embodiment: Method for Updating Pathloss Offset Between UE and Base Station

As an embodiment of the disclosure, a method for updating pathloss offset between a UE and a base station is described. This embodiment may be operated in combination with another embodiment.

In [Process 2-3] and [Process 2-6] within [Method 2-1] and [Process 3-3] within [Method 2-2], the UE may receive the d_P value, which is difference value between the pathloss between the TRP that may perform both uplink and downlink operations and the UE and the pathloss between the TRP that may perform only uplink reception operations and the UE, from the base station. In addition, the UE may receive the d_P″ value, which is the change in d_P, from the base station in [Process 3-6] in [Method 2-2]. In this case, the d_P value or d_P″ value may be any integer in dB units. As an example, the UE may assume that the distance between the TRP that may perform both uplink and downlink operations and the UE is shorter than the distance between the TRP that may perform only uplink reception operations and the UE, and based on this, the d_P value may only be a value less than or equal to 0, and the d_P″ value may be an integer. The UE may consider at least one combination of the following items as a method for receiving the pathloss offset or the change amount of the pathloss from the base station.

### [Method 3-1]

The UE may be configured with the d_P value, which is the pathloss offset, or the d_P″ value, which is the change amount of the d_P value, from the base station through upper-layer signaling. In this case, the UE may be configured with one or more the d_P value, which is the pathloss offset, or the d_P″ value, which is the change amount of the d_P value for each bandwidth part or cell through upper-layer signaling. As an example, the UE may be configured with the d_P values or d_P″ values of 4, which is the maximum number of pathloss measurement reference signals that a UE may track within a specific cell, through upper-layer signaling. Since the UE may receive the d_P value, which is the pathloss offset, or the d_P″ value, which is the change amount of the d_P value from the base station only through upper-layer signaling in the corresponding method, the configured value cannot be changed unless RRC reconfiguration is performed on the UE.

As in [Method 3-1], in the case where the UE is configured with the d_P value, which is the pathloss offset, or the d_P″ value, which is the change amount of the d_P value, through upper-layer signaling, the pathloss offset between the UE and the base station may be configured semi-statically and may not be dynamically changed, which may not be flexible, and if the UE has mobility, the time interval for correcting the pathloss offset may be very long. However, if the UE has a fixed location like a CPE or has very low mobility, or if information exchange between TRPs is very slow, this may be an effective method for determining the transmission power when transmitting uplink to UL-only TRPs by reflecting the pathloss offset while sparing additional dynamic signaling.

### [Method 3-2]

The UE may be configured with the d_P value, which is the pathloss offset, or the d_P″ value, which is the change amount of the d_P value, from the base station through upper-layer signaling, and then receive MAC-CE signaling from the base station and update the preconfigured value. In this case, the UE may be configured with one or more the d_P value, which is the pathloss offset, or the d_P″ value, which is the change amount of the d_P value for each bandwidth part or cell through upper-layer signaling. As an example, the UE may be configured with the d_P values or d_P″ values of 4, which is the maximum number of pathloss measurement reference signals that a UE may track within a specific cell, through upper-layer signaling. The UE may consider at least one combination of the following items as information that may be included in the MAC-CE signaling.
Serving cell ID field (e.g., 5 bits)
Uplink bandwidth part ID field (e.g., 2 bits)
Pathloss measurement reference signal ID field (e.g., 6 bits)
Pathloss measurement reference signal group field (e.g., 2 bits)
Activated pathloss measurement reference signal ID field (e.g., 2 bits)
Pathloss offset (d_P) field (e.g., 5 to 8 bits)
Pathloss offset change amount (d_P″) field (e.g., 5 to 8 bits)
Joint TCI state or UL TCI state field (e.g., 7 or 6 bits, respectively)

As an example of a combination of MAC-CE signaling configuration information, if the UE is configured with one d_P value, which is the pathloss offset, or one d_P″ value, which is the change amount of the d_P value, for each bandwidth part through upper-layer signaling, the UE may expect that the MAC-CE signaling includes the serving cell ID field, the uplink bandwidth part ID field, the pathloss offset (d_P) field, and/or the change amount of the pathloss offset (d_P″) field among the above information. The UE may receive the corresponding MAC-CE signaling and update one d_P value, which is the pathloss offset, or one d_P″ value, which is the change amount of the d_P value, configured in the bandwidth part.

As another example of a combination of MAC-CE signaling configuration information, if the UE is configured with one d_P value, which is the pathloss offset, or one d_P″ value, which is the change amount of the d_P value, for each activated pathloss measurement reference signal within the cell through upper-layer signaling, the UE may expect that the MAC-CE signaling includes the serving cell ID field, the uplink bandwidth part ID field, the activated pathloss measurement reference signal ID field, the pathloss offset (d_P) field, and/or the change amount of the pathloss offset (d_P″) field among the above information. The UE may receive the corresponding MAC-CE signaling and update one d_P value, which is the pathloss offset, or one d_P″ value, which is the change amount of the d_P value, configured for a specific activated pathloss measurement reference signal within the cell.

The UE and the base station additionally define a field indicating the d_P value or d_P″ value in the MAC-CE signaling that changes the pathloss measurement reference signal, and if the UE receives the MAC-CE, the UE may change the pathloss measurement reference signal and may be indicated with the corresponding d_P value or d_P″ value.

After receiving the corresponding MAC-CE from the base station, the UE may update the d_P value, which is the pathloss offset configured through the upper-layer signaling to the UE or the value received through MAC-CE signaling for the d_P″ value, which is the change amount of the d_P value and apply the same when determining the uplink transmission power, after 3 slots from the PUCCH transmission including HARQ-ACK information for the PDSCH including the corresponding MAC-CE.

As in [Method 3-2], when the UE updates the d_P value, which is the pathloss offset or the d_P″ value, which is the change amount of the d_P value to the value received through MAC-CE signaling, since the UE may update the pathloss offset relatively dynamically in addition to the method of configuring the pathloss offset semi-statically, it may be useful for compensating for the pathloss amount when determining the transmission power of the UE when the UE has mobility. However, as described above, the UE and the base station may need to define a new MAC-CE signaling, and the base station should be able to periodically measure the d_P value, which is the pathloss offset or the d_P″ value, which is the change amount of the d_P value, and the delay time should not be long when exchanging information between TRPs.

### [Method 3-3]

The UE may be configured with the d_P value, which is the pathloss offset, or the d_P″ value, which is the change amount of the d_P value, from the base station through upper-layer signaling, and then indicated through DCI. In this case, the UE may be configured with one or more the d_P value, which is the pathloss offset, or the d_P″ value, which is the change amount of the d_P value for each bandwidth part or cell through upper-layer signaling. As an example, the UE may be configured with the d_P values or d_P″ values of 4, which is the maximum number of pathloss measurement reference signals that a UE may track within a specific cell, through upper-layer signaling, and may update one of the four d_P values or d_P″ values with a value received through DCI.

The UE may define a new UE group common DCI, additionally define and configured with an RNTI applicable to the DCI, and may receive update information on the d_P value, which is the pathloss offset, or the d_P″ value, which is the change amount of the d_P value through the UE group common DCI.

The UE may be indicated with update information on the d_P value, which is the pathloss offset, or the d_P″ value, which is the change amount of the d_P value as a new field in the conventional UE-specific DCI (e.g., DCI format 0_1, 0_2, 0_3, 1_1, 1_2, or 1_3).

When updating the d_P value, which is the pathloss offset, or the d_P″ value, which is the change amount of the d_P value through DCI, the UE may use a method similar to the above TPC accumulation or absolute TPC. If the UE use a method like the TPC accumulation when updating the d_P value, which is the pathloss offset, or the d_P″ value, which is the change amount of the d_P value through DCI, the UE may update the d_P value, which is the pathloss offset configured through the upper-layer signaling, by adding the d_P″ value, which is the change amount of the d_P value through DCI. If the UE use a method like the absolute TPC when updating the d_P value, which is the pathloss offset, or the d_P″ value, which is the change amount of the d_P value through DCI, the UE may replace the d_P value configured through the upper-layer signaling with the d_P value received through DCI.

When performing the update for the d_P value or d_P″ value through DCI, there may be a case where the UE fails to receive the DCI, so the HARQ-ACK transmission operation for the DCI may be defined to report to the base station whether the DCI is received for the update for the d_P or d_P″ value. The UE may update the d_P value, which is the pathloss offset configured through the upper-layer signaling to the UE or the value received through MAC-CE signaling for the d_P″ value, which is the change amount of the d_P value and apply the same when determining the uplink transmission power, after 3 slots from the PUCCH transmission including HARQ-ACK information for the corresponding DCI including the corresponding MAC-CE. As another method, the UE may update the d_P value, which is the pathloss offset configured through the upper-layer signaling to the UE or the value received through MAC-CE signaling for the d_P″ value, which is the change amount of the d_P value and apply the same when determining the uplink transmission power, after a specific time from the HARQ-ACK information including HARQ-ACK information for the PDSCH including the corresponding MAC-CE, and the specific time may be reported as a UE capability.

As in [Method 3-3], when the UE updates the d_P value, which is the pathloss offset or the d_P″ value, which is the change amount of the d_P value by using the value received through DCI signaling, since the UE may update the pathloss offset dynamically based on DCI in addition to the method of configuring the pathloss offset semi-statically, it may be useful for compensating for the pathloss amount between the UL-only TRP and the UE when determining the transmission power of the UE when the UE has mobility. However, as described above, the UE and the base station may need to define an additional field in DCI that may result in increased DCI overhead, and the base station should be able to periodically measure the d_P value, which is the pathloss offset or the d_P″ value, which is the change amount of the d_P value, and the delay time should not be long when exchanging information between TRPs.

### [Method 3-4]

The UE may be configured with the d_P value, which is the pathloss offset, or the d_P″ value, which is the change amount of the d_P value, from the base station through upper-layer signaling, and then receive two or more CSI-RSs from the base station and receive the d_P or d_P″ value implicitly through the difference in reception power of the corresponding CSI-RSs. In this case, the UE may be configured with one or more the d_P value, which is the pathloss offset, or the d_P″ value, which is the change amount of the d_P value for each bandwidth part or cell through upper-layer signaling. As an example, the UE may be configured with the d_P values or d_P″ values of 4, which is the maximum number of pathloss measurement reference signals that a UE may track within a specific cell, through upper-layer signaling, and the UE may receive CSI-RSs assuming different transmission powers from the base station to receive an updated value from the base station for one of the four d_P values or d_P″ values, and may implicitly identify the d_P or d_P″ value by using the difference in the reception power. To this end, the UE may be configured with CSI-RS resources for updating the corresponding values according to the number of the d_P value, which is the pathloss offset, or the d_P″ value, which is the change amount of the d_P value configured through upper-layer signaling.

As in [Method 3-4], when the UE updates the d_P value, which is the pathloss offset or the d_P″ value, which is the change amount of the d_P value by using the difference in the reception power value in which the transmission power of different CSI-RS resources is configured differently, since the UE may update the pathloss offset dynamically based on DCI in addition to the semi-statically configuring method, it may be useful for compensating for the pathloss amount between the UL-only TRP and the UE when determining the transmission power of the UE when the UE has mobility, and the accuracy of information may be improved in that the unquantized d_P or d_P″ value may be transmitted to the UE through the difference between the transmission powers of the CSI-RS resources when there is no interference signal. However, since the UE must define CSI-RS resources in which different transmission powers are assumed to update the d_P or d_P″ value, and the difference between the transmission powers of the corresponding CSI-RS resources may also be variable according to the d_P or d_P″ value calculated by the base station, the overhead at the base station may increase.

### [Method 3-5]

The UE may receive the d_P or d_P″ value from the base station through at least one combination of [Method 3-1] to [Method 3-4] and update the preconfigured value. In this case, when a specific event defined within the base station occurs, the base station may inform the UE to update the preconfigured or already activated value by transmitting the d_P or d_P″ value. The specific event that is possible at the base station is, for example, if the d_P or d_P″ value calculated through [Method 2-1] and/or [Method 2-2] is changed by a certain percentage or more compared to the previously calculated d_P or d_P″ value (for example, if it is decreased or increased by 10% or more), the base station may notify the UE to update the newly calculated d_P or d_P″ value. The UE may be configured with a timer from the base station. If the base station does not update the d_P value, which is the pathloss offset, or the d_P″ value, which is the change amount of the d_P value within the time defined through the timer, the UE may perform at least one combination of the following items.
The UE may request the base station to update the d_P or d_P″ value.
The UE may perform uplink transmission to the base station without applying the d_P or d_P″ value.
The UE may perform uplink transmission to the base station by applying the d_P value or d_P″ value initially received from the base station.
The UE may determine that a radio link failure situation has occurred and request the base station to reset upper-layer signaling.

The UE may expect to be informed by the base station of at least one combination of [Method 3-1] to [Method 3-5] through at least one combination of upper-layer signaling, MAC-CE signaling, and L1 signaling, or at least one combination of [Method 3-1] to [Method 3-5] is fixedly defined in the standard. In addition, if the UE is informed by the base station of at least one combination of specific methods through at least one combination of upper-layer signaling, MAC-CE signaling, and L1 signaling, this may mean that the UE cannot support at least one other combination of specific methods. As an example, the UE may expect that [Method 3-2] is fixedly defined in the standard for the method of updating the pathloss offset. As another example, the UE may be informed of [Method 3-1] from the base station through at least one combination of upper-layer signaling, MAC-CE signaling, and L1 signaling, in this case, the UE may consider that it is informed by the base station that [Method 3-2] is not supported.

The UE may report to the base station whether to support at least one combination of [Method 3-1] to [Method 3-5] as a UE capability. In this case, if the UE reports to the base station as the UE capability that a combination of one or more specific methods is supportable, it may be considered that the UE has reported that the UE cannot support one or more other combinations of methods. As an example, the UE may report to the base station whether the UE may support [Method 3-1] or [Method 3-2]. As another example, the UE may report to the base station that the UE may support [Method 3-1], and this UE capability report may mean that the UE cannot support [Method 3-2].

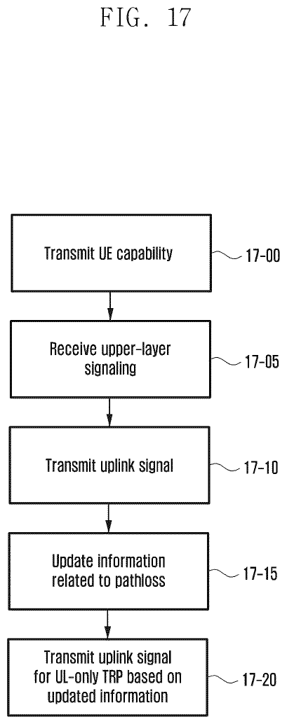

FIG. 17 is a drawing illustrating an operation of a UE for uplink transmission power control according to an embodiment of the disclosure.

Referring to FIG. 17, in operation 17-00, a UE may transmit a UE capability to a base station. In this case, the UE capability signaling that may be reported may be for a combination of at least one of PUSCH, PUCCH, UE capabilities related to SRS transmission and transmission power parameters, UE capabilities related to unified TCI state operation, and UE capabilities corresponding to [Method 1-1] and [Method 1-2], [Method 2-1] and [Method 2-2], [Method 3-1] to [Method 3-5]. The operation 17-00 may also be omitted.

In operation 17-05, the UE may receive upper-layer signaling from the base station according to the reported UE capability. In this case, the UE may receive upper-layer parameters for at least one combination of PUSCH, PUCCH, upper-layer signaling related to SRS transmission and transmission power parameters, upper-layer signaling related to unified TCI state operation, and upper-layer signaling related to support of [Method 1-1] and [Method 1-2], [Method 2-1] and [Method 2-2], [Method 3-1] to [Method 3-5], and use one of them.

In operation 17-10, the UE may transmit an uplink signal to the base station. In this case, the UE may perform the method of transmitting the uplink signal through a combination of at least one of [Method 2-1] and [Method 2-2].

In operation 17-15, the UE may be indicated with a signaling that indicates an update of pathloss-related information from the base station. In this case, the UE may the signaling that indicates an update of pathloss-related information from the base station by using a combination of at least one of [Method 3-1] to [Method 3-5].

In operation 17-20, the UE may perform uplink transmission for UL-only TRP based on the updated pathloss-related information.

The flowchart described above illustrates a method that may be implemented according to the principles of the disclosure, and various modifications may be made to the method illustrated in the flowchart in this specification. For example, although illustrated as a series of steps, the various steps in each drawing may overlap, occur in parallel, occur in different orders, or occur multiple times. In another example, steps may be omitted or replaced by other steps.

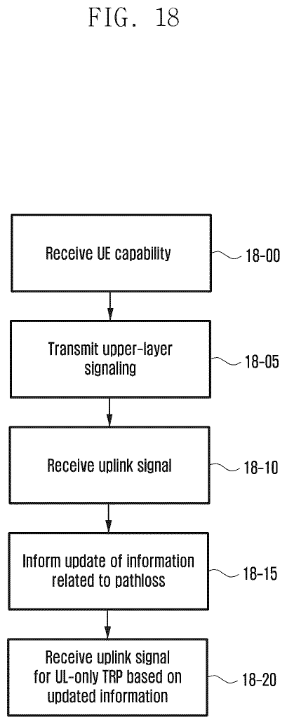

FIG. 18 is a drawing illustrating an operation of a base station for uplink transmission power control according to an embodiment of the disclosure.

Referring to FIG. 18, in operation 18-00, a base station may receive a UE capability from a UE. In this case, the UE capability signaling that may be received by the base station may be for a combination of at least one of PUSCH, PUCCH, UE capabilities related to SRS transmission and transmission power parameters, UE capabilities related to unified TCI state operation, and UE capabilities corresponding to [Method 1-1] and [Method 1-2], [Method 2-1] and [Method 2-2], [Method 3-1] to [Method 3-5]. The operation 18-00 may also be omitted.

In operation 18-05, the base station may transmit upper-layer signaling to the UE according to the UE capability reported by the UE. In this case, the base station may define upper-layer parameters for at least one combination of PUSCH, PUCCH, upper-layer signaling related to SRS transmission and transmission power parameters, upper-layer signaling related to unified TCI state operation, and upper-layer signaling related to support of [Method 1-1] and [Method 1-2], [Method 2-1] and [Method 2-2], [Method 3-1] to [Method 3-5], and use one of them and transmit the used one to the UE.

In operation 18-10, the base station may receive an uplink signal from the UE. In this case, the base station may expect the UE to perform the method of transmitting the uplink signal through a combination of at least one of [Method 2-1] and [Method 2-2].

In operation 18-15, the base station may transmit a signaling that indicates an update of pathloss-related information to the UE. In this case, the base station may transmit the signaling that indicates an update of pathloss-related information to the UE by using a combination of at least one of [Method 3-1] to [Method 3-5].

In operation 18-20, the base station may expect the UE to perform uplink transmission for UL-only TRP based on the updated pathloss-related information, and receive the uplink signal.

The flowchart described above illustrates a method that may be implemented according to the principles of the disclosure, and various modifications may be made to the method illustrated in the flowchart in this specification. For example, although illustrated as a series of steps, the various steps in each drawing may overlap, occur in parallel, occur in different orders, or occur multiple times. In another example, steps may be omitted or replaced by other steps.

<Fourth embodiment: Method for Interpreting Group Common Downlink Control Information Format 2_3>

As an embodiment of the disclosure, a method for interpreting DCI format 2_3 that a UE may receive from a base station is described. The embodiment may be operated in combination with other embodiments.

The UE may receive DCI format 2_3 from the base station. The corresponding DCI format 2_3 is group common DCI that a plurality of UEs may commonly receive. The UE may monitor the corresponding DCI format 2_3 within a control resource set connected to a common search space. The UE may receive only information about [Usage 1] below from the base station through the corresponding DCI format 2_3, or may receive both information about [Usage 1] and [Usage 2] below.

[Usage 1] The UE may receive a TPC command for dynamically controlling the transmission power for the SRS from the base station through the corresponding DCI format 2_3.
[Usage 2] The UE may receive triggering information for the SRS carrier switching described above for the purpose of acquiring the downlink channel information from the base station in a cell where the uplink transmission is impossible through the corresponding DCI format 2_3 from the base station. In this case, the SRS carrier switching may be performed in order to acquire the downlink channel information from the base station in the corresponding cell when the UE performs only downlink reception operation in a specific cell, i.e., when the PUCCH or/and PUSCH transmission is impossible.

The UE may be configured SRS-TPC-CommandConfig and SRS-CarrierSwitching, which are higher layer signaling, from the base station, and the structures of the SRS-TPC-CommandConfig and the SRS-CarrierSwitching may be as shown in Table 30 below.

TABLE 30

```
  SRS-TPC-CommandConfig ::= SEQUENCE {
    startingBitOfFormat2-3 INTEGER (1..31) OPTIONAL, -- Need R
    fieldTypeFormat2-3 INTEGER (0..1) OPTIONAL, -- Need R
    ...,
    [[
    startingBitOfFormat2-3SUL INTEGER (1..31) OPTIONAL -- Need R
    ]]
  }
  SRS-CarrierSwitching ::= SEQUENCE {
    srs-SwitchFromServCellIndex INTEGER (0..31) OPTIONAL, -- Need M
    srs-SwitchFromCarrier ENUMERATED {sUL, nUL},
    srs-TPC-PDCCH-Group CHOICE {
    typeA SEQUENCE (SIZE (1..32)) OF SRS-TPC-PDCCH-Config,
    typeB SRS-TPC-PDCCH-Config
    } OPTIONAL, -- Need M
    monitoringCells SEQUENCE (SIZE (1..maxNrofServingCells)) OF
ServCellIndex OPTIONAL, -- Need M
  ...
  }
  SRS-TPC-PDCCH-Config ::= SEQUENCE {
  srs-CC-SetIndexlist SEQUENCE (SIZE(1..4))OF SRS-CC-SetIndex
OPTIONAL -- Need M
  }
  SRS-CC-SetIndex ::= SEQUENCE {
  cc-SetIndex INTEGER (0..3) OPTIONAL, -- Need M
  cc-IndexInOneCC-Set INTEGER (0..7) OPTIONAL -- Need M
  }
```

The DCI format 2_3 may have its CRC scrambled by TPC-SRS-RNTI and be composed of one or more blocks. In this case, the UE may be configured with the TPC-SRS-RNTI within PhysicalCellGroupConfig that is the higher layer signaling. The UE may use the higher layer signaling information in the above Table 30 when interpreting the information about the UE among one or more blocks within the corresponding DCI format 2_3.

Through the SRS-TPC-CommandConfig that is the higher layer signaling in the above Table 30, the UE may be configured with the following higher layer signaling. The UE may be configured with the SRS-TPC-CommandConfig in PDCCH-config that is the higher layer signaling.
startingBitOfFormat2-3: The UE may be configured with a starting point (starting bit position) of the block including the information (e.g., the SRS request field and/or the TPC command) about the corresponding UE within the DCI format 2_3 through the corresponding higher layer signaling, which may correspond to the normal uplink carrier (NUL).
startingBitOfFormat2-3SUL-v1530: The UE may be configured with a starting point (starting bit position) of the block including the information (e.g., the SRS request field and/or the TPC command) about the corresponding UE within the DCI format 2_3 through the corresponding higher layer signaling, which may correspond to the supplementary uplink carrier (SUL)
fieldTypeFormat2-3: The UE may identify whether the SRS request field exists within the DCI format 2_3 through the corresponding higher layer signaling. When the corresponding higher layer signaling is configured to 1, the UE may assume that there is the SRS request field within the DCI format 2_3, and when the corresponding higher layer signaling is configured to 0, the UE may assume that there is no SRS request field within the DCI format 2_3.

Through the SRS-CarrierSwitching that is the higher layer signaling in the above Table 30, the UE may be configured with the following higher layer signaling. The UE may be configured with the SRS-CarrierSwitching within the UplinkConfig that is the higher layer signaling.
srs-SwitchFromServCellIndex: The UE may identify the information about which cell's the uplink transmission is interrupted when the SRS carrier switching is performed through the corresponding higher layer signaling. While the UE performs the SRS carrier switching and transmits the SRS in the cell where the PUSCH transmission is impossible, the UE may temporarily interrupt the uplink transmission in the cell that may be identified through the corresponding higher layer signaling.
srs-SwitchFromCarrier: The UE may identify information about which uplink carrier of the NUL or SUL interrupts the uplink transmission within the srs-SwitchFromServCellIndex through the corresponding higher layer signaling.
srs-TPC-PDCCH-Group: The UE may identify whether the DCI format 2_3 is interpreted as either typeA or typeB through the corresponding higher layer signaling.
monitoringCells: The UE may identify information about a cell set for which the DCI format 2_3 is monitored through the corresponding higher layer signaling.
srs-CC-SetIndexlist: The UE may identify information about one or more pairs of cc-SetIndex and cc-IndexInOneCC-Set, which are two higher layer signalings, through the corresponding higher layer signaling. When the UE is configured with the srs-TPC-PDCCH-Group as the typeB, the UE may not be configured with the corresponding higher layer signaling from the base station, and may be configured only as the typeA.
cc-SetIndex: The UE may be configured with an index for a cell set through the corresponding higher layer signaling. If the UE is configured with the srs-TPC-PDCCH-Group as the typeA, the UE may always be configured with the corresponding higher layer signaling. The UE may be configured with the corresponding higher layer signaling as one of values 0, 1, or 2 from the base station, and may not configured with the corresponding higher layer signaling as 3.
cc-IndexInOneCC-Set: The UE may identify an index for a cell within a specific cell set through the corresponding higher layer signaling. If the UE is configured with the srs-TPC-PDCCH-Group as the typeA, the UE may always be configured with the corresponding higher layer signaling.

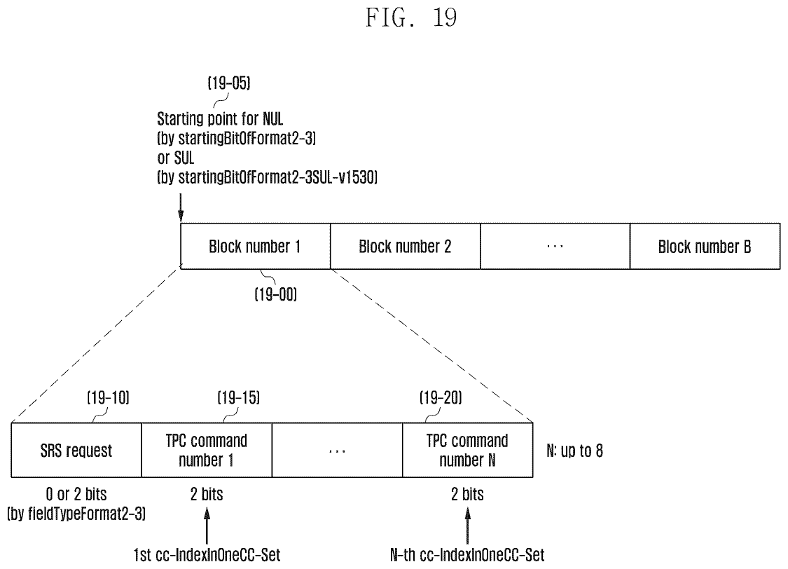

FIG. 19 is a diagram illustrating a case where DCI format 2_3 is interpreted as typeA, according to an embodiment of the disclosure.

Referring to FIG. 19, for the cell that has not been configured with the PUCCH or PUSCH-related higher layer signaling or the cell where the transmission power control of the SRS is not connected to that of the PUSCH, when the UE is configured with the srs-TPC-PDCCH-Group, which is the higher layer signaling, as the typeA, the UE may expect that one block (19-00) within the DCI format 2_3 includes the following information indicated for the corresponding UE. In this case, the UE may be configured with the information on the starting point of the block for the corresponding UE among one or more blocks within the DCI format 2_3 from the base station through the startingBitOfFormat2-3 that is the higher layer signaling in case of the NUL or the startingBitOfFormat2-3SUL-v1530 that is the higher layer signaling in case of SUL (19-05). When the number of cells for which the UE has not been configured with the PUCCH or PUSCH-related higher layer signaling or the number of cells for which the transmission power control of the SRS is not connected to that of the PUSCH is more than 5, the UE may be configured with the srs-TPC-PDCCH-Group, which is the higher layer signaling, as the typeA. On the other hand, regardless of the number of cells for which the UE has not been configured with the PUCCH or PUSCH-related higher layer signaling or the number of cells for which the transmission power control of the SRS is not connected to that of the PUSCH, the UE may be configured with the srs-TPC-PDCCH-Group, which is the higher layer signaling, as either the typeA or typeB from the base station.
An SRS request field (19-10) may be 0 or 2 bits. The existence condition of the corresponding field may be determined according to the fieldTypeFormat2-3 that is the higher layer signaling.
For TPC command number 1 (19-15), . . . , TPC command number N (19-20), each TPC command number field may be applied to the cc-IndexInOneCC-Set that is the higher layer signaling. For example, the TPC command number 1 (19-15) may be a first cc-IndexInOneCC-Set, the TPC command number N (19-20) may be the TPC command value corresponding to an Nth the cc-IndexInOneCC-Set, each TPC command number field may be 2 bits, and N may be up to 8.

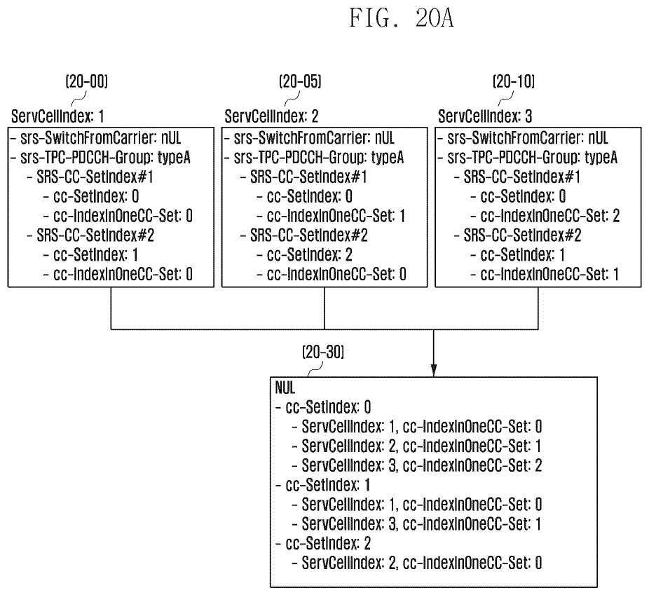

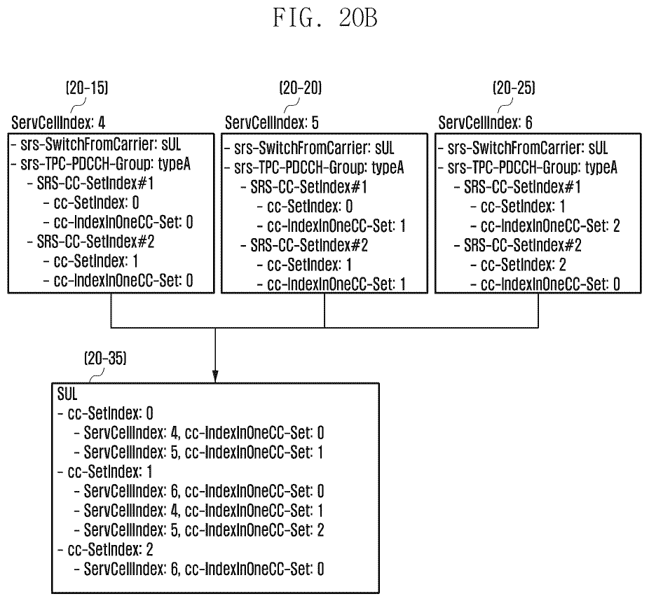

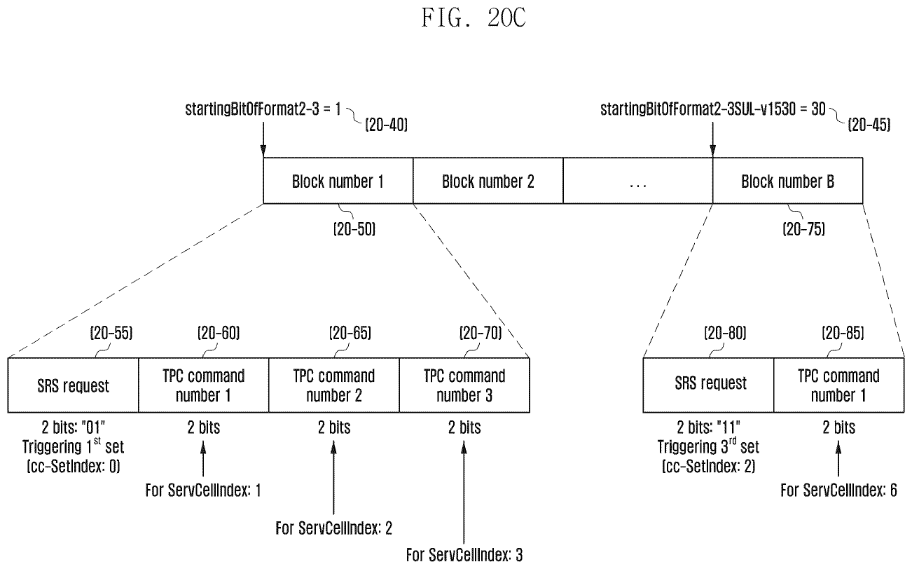

FIGS. 20A to 20C are diagrams illustrating a method for interpreting corresponding DCI according to higher layer signaling configured for a UE in case where the DCI format 2_3 is interpreted as the typeA, according to various embodiments of the disclosure.

Referring to FIGS. 20A to 20C, the UE may be configured with a total of 6 cells from the base station through the higher layer signaling, and indexes of each cell may be configured through the higher layer signaling ServCellIndex. For example, the UE may be configured with indexes for 6 cells as ServCellIndex 1 to 6. The UE may be configured with the SRS-CarrierSwitching that is the higher layer signaling for each cell.

The UE may be configured with the srs-TPC-PDCCH-Group, which is the higher layer signaling, for all the 6 cells as the typeA.

The UE may be configured with the srs-SwitchFromCarrier, which is the higher layer signaling, as nUL for the cells with ServCellIndex values of 1, 2, or 3. In this case, the UE may consider each higher layer signaling configuration for each cell with the ServCellIndex values of 1, 2, or 3 as follows.
For the cell with the ServCellIndex of 1 (20-00), the UE may be configured with the higher layer signaling so that the corresponding cell is included in two carrier sets. The UE may be configured with the value of the cc-IndexInOneCC-Set, which is the higher layer signaling meaning the index for the corresponding cell, as 0 within the first carrier set where the cc-SetIndex, which is the higher layer signaling, is 0. The UE may be configured with the value of the cc-IndexInOneCC-Set, which is the higher layer signaling meaning the index for the corresponding cell, as 0 within a second carrier set where the cc-SetIndex, which is the higher layer signaling, is 1.
For the cell with the ServCellIndex of 2 (20-05), the UE may be configured with the higher layer signaling so that the corresponding cell is included in two carrier sets. The UE may be configured with the value of the cc-IndexInOneCC-Set, which is the higher layer signaling meaning the index for the corresponding cell, as 1 within the first carrier set where the cc-SetIndex, which is the higher layer signaling, is 0. The UE may be configured with the value of the cc-IndexInOneCC-Set, which is the higher layer signaling meaning the index for the corresponding cell, as 0 within a third carrier set where the cc-SetIndex, which is the higher layer signaling, is 2.
For the cell with the ServCellIndex of 3 (20-10), the UE may be configured with the higher layer signaling so that the corresponding cell is included in two carrier sets. The UE may be configured with the value of the cc-IndexInOneCC-Set, which is the higher layer signaling meaning the index for the corresponding cell, as 2 within the first carrier set where the cc-SetIndex, which is the higher layer signaling, is 0. The UE may be configured with the value of the cc-IndexInOneCC-Set, which is the higher layer signaling meaning the index for the corresponding cell, as 1 within the second carrier set where the cc-SetIndex, which is the higher layer signaling, is 1.

In this way, if the UE collects the higher layer signaling configuration information of the cells where the srs-SwitchFromCarrier, which is the higher layer signaling, is configured as nUL (20-30), the UE may be configured with three carrier sets where three cc-SetIndexes are configured to 0, 1, or 2 as described above.
Within the first carrier set, the UE may expect that the cell with the ServCellIndex of 1 is configured with an index of 0 within the corresponding set, the cell with the ServCellIndex of 2 is configured with an index of 1 within the corresponding set, and the cell with the ServCellIndex of 3 is configured with an index of 2 within the corresponding set.
Within the second carrier set, the UE may expect that the cell with the ServCellIndex of 1 is configured with an index of 0 within the corresponding set, and the cell with the ServCellIndex of 3 is configured with an index of 1 within the corresponding set.
Within the third carrier set, the UE may expect that the cell with the ServCellIndex of 2 is configured with an index of 0 within the corresponding set.

The UE may acquire information about a starting point of a valid block within the DCI format 2_3 for the NUL of the corresponding UE through the startingBitOfFormat2-3 that is the higher layer signaling (20-40). The block corresponding to the starting point is Block number 1 (20-50), and may include an SRS request field (20-55), TPC command number 1 (20-60), TPC command number 2 (20-65), and TPC command number 3 (20-70). When the UE receives a “01” bit through the SRS request field, the UE may trigger the SRS corresponding to the SRS resource set whose usage is antenna switching and resourceType is aperiodic within all the cells within the carrier set with cc-SetIndex of 0.

The UE may be configured with the srs-SwitchFromCarrier, which is the higher layer signaling, as sUL for cells with ServCellIndex values of 4, 5, or 6.
For the cell with the ServCellIndex of 4 (20-15), the UE may be configured with the higher layer signaling so that the corresponding cell is included in two carrier sets. The UE may be configured with the value of the cc-IndexInOneCC-Set, which is the higher layer signaling meaning the index for the corresponding cell, as 0 within the first carrier set where the cc-SetIndex, which is the higher layer signaling, is 0. The UE may be configured with the value of the cc-IndexInOneCC-Set, which is the higher layer signaling meaning the index for the corresponding cell, as 0 within the second carrier set where the cc-SetIndex, which is the higher layer signaling, is 1.
For the cell with the ServCellIndex of 5 (20-20), the UE may be configured with the higher layer signaling so that the corresponding cell is included in two carrier sets. The UE may be configured with the value of the cc-IndexInOneCC-Set, which is the higher layer signaling meaning the index for the corresponding cell, as 1 within the first carrier set where the cc-SetIndex, which is the higher layer signaling, is 0. The UE may be configured with the value of the cc-IndexInOneCC-Set, which is the higher layer signaling meaning the index for the corresponding cell, as 1 within the second carrier set where the cc-SetIndex, which is the higher layer signaling, is 1.
For the cell with the ServCellIndex of 6 (20-25), the UE may be configured with the higher layer signaling so that the corresponding cell is included in two carriers sets. The UE may be configured with the value of the cc-IndexInOneCC-Set, which is the higher layer signaling meaning the index for the corresponding cell, as 2 within the second carrier set where the cc-SetIndex, which is the higher layer signaling, is 1. The UE may be configured with the value of the cc-IndexInOneCC-Set, which is the higher layer signaling meaning the index for the corresponding cell, as 0 within a third carrier set where the cc-SetIndex, which is the higher layer signaling, is 2.

In this way, if the UE collects the higher layer signaling configuration information of the cells where the srs-SwitchFromCarrier, which is the higher layer signaling, is configured as sUL (20-35), the UE may be configured with three sets of carriers in which three cc-SetIndexes are configured to 0, 1, or 2 as described above.
Within the first carrier set. the UE may expect that the cell with the ServCellIndex of 4 is configured with an index of 0 within the corresponding set, and the cell with the ServCellIndex of 5 is configured with an index of 1 within the corresponding set.
Within the second carrier set, the UE may expect that the cell with the ServCellIndex of 6 is configured with an index of 0 within the corresponding set, the cell with the ServCellIndex of 4 is configured with an index of 1 within the corresponding set, and the cell with the ServCellIndex of 5 is configured with an index of 2 within the corresponding set.
Within the third carrier set, the UE may expect that the cell with the ServCellIndex of 6 is configured with an index of 0 within the corresponding set.

The UE may acquire the information about the starting point of the valid block within the DCI format 2_3 for the SUL of the corresponding UE through the starting BitOfFormat2-3SUL-v1530 that is the higher layer signaling (20-45). The block corresponding to the corresponding starting point is Block number B (20-75), and may include an SRS request field (20-80) and TPC command number 1 (20-85). When the UE receives a “11” bit through the SRS request field, the UE may trigger the SRS corresponding to the SRS resource set whose usage is antenna switching and resourceType is aperiodic within all the cells within the carrier set with cc-SetIndex of 2. In this case, the UE may expect that the TPC command number 1 is applied to the cell with the ServCellIndex of 6.

The above description describes the case where the UE has the SRS request field for each block within the DCI format 2_3 and is configured with one or more cc-SetIndex, but when the UE does not have the SRS request fields for each block within the DCI format 2_3 according to the configuration of the fieldTypeFormat2-3 that is the higher layer signaling, it may be expected that the UE is configured with only one cc-SetIndex.

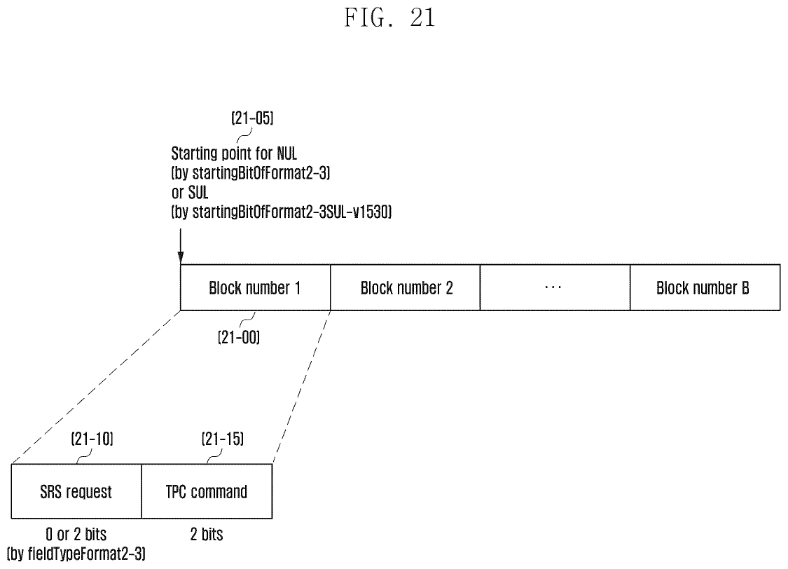

FIG. 21 is a diagram illustrating a case where the DCI format 2_3 is interpreted as typeB, according to an embodiment of the disclosure.

Referring to FIG. 21, for the cell that has not been configured with the PUCCH or PUSCH-related higher layer signaling or the cell where the transmission power control of the SRS is not connected to the PUSCH, when the UE is configured with the srs-TPC-PDCCH-Group, which is the uplink higher layer signaling, as the typeB, the UE may expect that one or more blocks (21-00) within the DCI format 2_3 include the following information indicated for the corresponding UE. In this case, the UE may be configured with the information on the starting points of one or more blocks for the corresponding UE among one or more blocks within the DCI format 2_3 from the base station through the startingBitOfFormat2-3 that is the higher layer signaling in case of the NUL or the startingBitOfFormat2-3SUL-v1530 that is the higher layer signaling in case of SUL (21-05). The UE may apply information on each block for each cell from the starting point of the block determined based on the higher layer signaling. When the number of cells for which the UE has not been configured with the PUCCH or PUSCH-related higher layer signaling or the number of cells for which the transmission power control of the SRS is not connected to that of the PUSCH is less than or equal to 5, the UE may be configured with the srs-TPC-PDCCH-Group, which is the higher layer signaling, as the typeB. On the other hand, regardless of the number of cells for which the UE has not been configured with the PUCCH or PUSCH-related higher layer signaling or the number of cells for which the transmission power control of the SRS is not connected to that of the PUSCH, the UE may be configured with the srs-TPC-PDCCH-Group, which is the higher layer signaling, as either the typeA or typeB from the base station.
An SRS request field (21-10) may be 0 or 2 bits. The existence condition of the corresponding field may be determined according to the fieldTypeFormat2-3 which is the higher layer signaling.
The TPC command (21-15) may be used for transmission power control of the SRS for the cell to which the corresponding block is applied, and may be 2 bits.

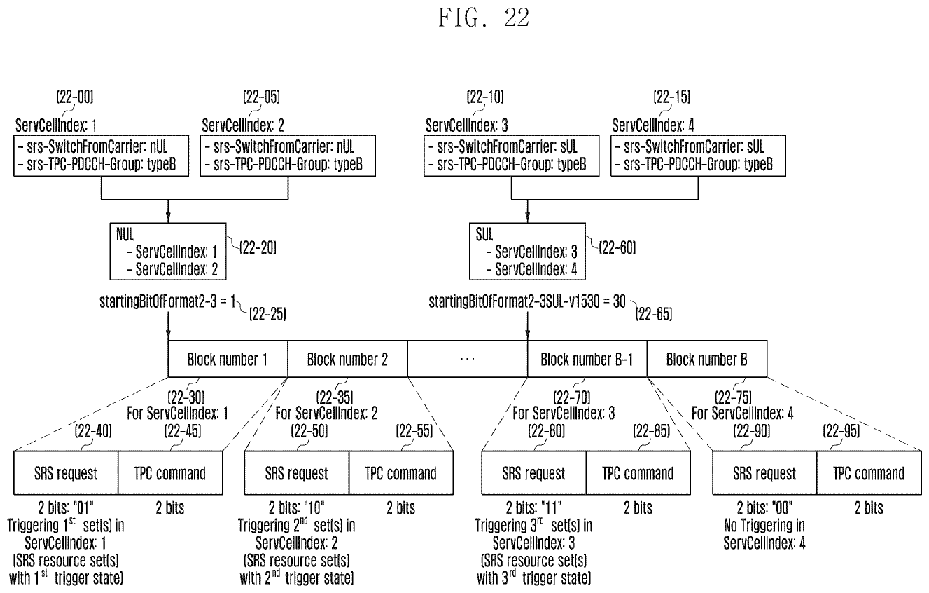

FIG. 22 is a diagram illustrating the method for interpreting corresponding DCI according to higher layer signaling configured for a UE in case where the DCI format 2_3 is interpreted as the typeB, according to an embodiment of the disclosure.

Referring to FIG. 22, the UE may be configured with a total of four cells from the base station through the higher layer signaling, and indexes of each cell may be configured through the higher layer signaling ServCellIndex. For example, the UE may be configured with indexes for four cells as ServCellIndex 1 to 4. The UE may be configured with the SRS-CarrierSwitching that is the higher layer signaling for each cell.

The UE may be configured with the srs-TPC-PDCCH-Group, which is the higher layer signaling, for all the four cells as the typeB.

The UE may be configured with the srs-SwitchFromCarrier, which is the higher layer signaling, as nUL for the cell with the ServCellIndex value of 1 (22-00) or 2 (22-05), and configured with the srs-SwitchFromCarrier, which is the higher layer signaling, as the sUL for the cell with the ServCellIndex value of 3 (22-10) or 4 (22-15). As described above, when the UE is configured with the srs-TPC-PDCCH-Group, which is the higher layer signaling, as the typeB, the UE may not be configured with the srs-CC-SetIndexlist.

In this way, if the UE collects the higher layer signaling configuration information of the cells where the srs-SwitchFromCarrier, which is the higher layer signaling, is configured as the nUL (22-20), the UE may consider the cell with the ServCellIndex value of 1 (22-00) or 2 (22-05). The UE may apply the information within two blocks (e.g., Block number 1 (22-30) and Block number 2 (22-35)) from the starting point that may be known through the startingBitOfFormat2-3 that is the higher layer signaling (22-25) within the DCI format 2_3 to the cell with the ServCellIndex value of 1 or 2, respectively.
The UE may expect that an SRS request field (22-40) and a TPC command (22-45) are included in Block number 1 (22-30) within the DCI format 2_3. If the UE receives “01” for the corresponding SRS request field (22-40), the UE may trigger an SRS resource set configured in a first trigger state within the cell with the ServCellIndex value of 1. It may be expected that the UE applies the corresponding TPC command (22-45) to the cell with the ServCellIndex value of 1.
The UE may expect that an SRS request field (22-50) and a TPC command (22-55) are included in Block number 2 (22-35) within the DCI format 2_3. If the UE receives “10” for the corresponding SRS request field (22-50), the UE may trigger an SRS resource set configured in a second trigger state within the cell with the ServCellIndex value of 2. It may be expected that the UE applies the corresponding TPC command (22-55) to the cell with the ServCellIndex value of 2.

In addition, if the UE collects the higher layer signaling configuration information of the cells where the srs-SwitchFromCarrier, which is the higher layer signaling, is configured as the sUL (22-60), the UE may consider the cell with the ServCellIndex value of 3 (22-00) or 4 (22-15). The UE may apply the information in two blocks (e.g., Block number B−1 (22-70) and Block number B (22-75)) from the starting point that may be known through the startingBitOfFormat2-3SUL-v1530 (22-65) that is the higher layer signaling within the DCI format 2_3 to the cell with the ServCellIndex value of 3 or 4, respectively.
The UE may expect that an SRS request field (22-80) and a TPC command (22-85) are included in the Block number B−1 (22-70) within the DCI format 2_3. If the UE receives “11” for the corresponding SRS request field (22-80), the UE may trigger an SRS resource set configured in a third trigger state within the cell with the ServCellIndex value of 3. It may be expected that the UE applies the corresponding TPC command (22-85) to the cell with the ServCellIndex value of 3.
The UE may expect that an SRS request field (22-90) and a TPC command (22-95) are included in the Block number B (22-75) within the DCI format 2_3. If the UE receives “00” for the corresponding SRS request field (22-90), the UE may not perform the SRS trigger within the cell with the ServCellIndex value of 4. It may be expected that the UE applies the corresponding TPC command (22-95) to the cell with the ServCellIndex value of 4.

### Fifth Embodiment: Method for Interpreting Group Common Downlink Control Information Format 2_3 Considering Closed Loop Power Control Index

According to an embodiment of the disclosure, a method for interpreting DCI format 2_3 considering a closed loop power control index in a UE and a base station will be described. The embodiment may be operated in combination with other embodiments.

The closed loop power control index with which the UE may be configured by higher layer signaling within one cell may be defined as follows for each uplink channel and signal.
The UE may be configured with up to two closed loop power control indexes for a PUSCH. The UE may be to perform different dynamic power control depending on the type of uplink data traffic (for example, URLLC or eMBB traffic) or to perform individual dynamic power control when transmitting uplink data for different TRPs as the usage of up to two closed loop power control indexes for the PUSCH.
The UE may be configured with up to two closed loop power control indexes for the PUCCH. The UE may be to perform different dynamic power control according to different PUCCH formats (for example, short PUCCH corresponding to PUCCH format 0 or 2, or long PUCCH corresponding to PUCCH format 1, 3, or 4) or to perform individual dynamic power control when transmitting uplink control information for different TRPs as the usage of up to two closed loop power control indexes for the PUCCH.
In case of the closed loop power control indexes for the SRS, the UE may consider at least one combination of the following matters:
When the SRS shares the closed loop power control index for the PUSCH, the number of closed loop power control indexes for the SRS may be configured to a maximum of two, such as the number of closed loop power control indexes configured for the PUSCH.
When a closed loop power control index for an SRS for a specific UE is not shared with that of the PUSCH and the UE has not been configured with the specific higher layer signaling from the base station (e.g., when the UE has not been configured with the pass loss difference value described above, or has not been configured with the higher layer signaling that may mean that the UE is connected to the base station including UL only TRP), the UE may be configured with up to one closed loop power control index for the SRS.
When the closed loop power control index for the SRS for the specific UE is not shared with that of the PUSCH and the UE has been configured with the specific higher layer signaling from the base station (e.g., when the UE has been configured with the path loss difference value described above, or has been configured with the higher layer signaling that may mean that the UE is connected to the base station including UL only TRP), the UE may be configured with up to two closed loop power control indexes for the SRS.
The UE may consider the case where the base station estimates downlink channel based on channel reciprocity between uplink and downlink channels by transmitting the SRS to the base station as the usage of the PUSCH and individual closed loop power control indexes for the SRS, or the case where the SRS is transmitted for uplink transmission beam management.

As described above, when the UE may be configured with up to two closed loop power control indexes not shared with the PUSCH for the SRS, the UE may be configured with parameters such as srs-PowerControlAdjustmentStates-r19 within the SRS-ResourceSet that is the higher layer signaling. In this case, the srs-PowerControlAdjustmentStates-r19 may indicate whether a first or the second index of the two closed loop power control indexes not shared with the PUSCH is applied to one or more SRS resources within the SRS-ResourceSet with which the corresponding parameter is configured.

For example, the srs-PowerControlAdjustmentStates-r19 may be configured such as ENUMERATED {Hci1, Hci2} to mean the first or second closed loop power control index, which may correspond to the case where srs-PowerControlAdjustmentStates, which is the higher layer signaling in the above Table 29 that may be configured in the UE, is separateClosedLoop. When the srs-PowerControlAdjustmentStates, which is the higher layer signaling in the above Table 29 that may be configured within the SRS-ResourceSet, is not the separateClosedLoop (i.e., the value of the srs-PowerControlAdjustmentStates is configured to sameAsFci2, or the srs-PowerControlAdjustmentStates is not configured), the UE may not expect that the srs-PowerControlAdjustmentStates-r19 is configured.

For another example, the srs-PowerControlAdjustmentStates-r19 may mean the second closed loop power control index when configured in the UE, and may mean the first closed loop power control index when not configured in the UE, which may correspond to the case where the srs-PowerControlAdjustmentStates, which is the higher layer signaling in the above Table 29 that may be configured in the UE, is configured as the separateClosedLoop. In case where the srs-PowerControlAdjustmentStates, which is the higher layer signaling in the above Table 29 that may be configured in the SRS-ResourceSet, is not the separateClosedLoop (i.e., the value of the srs-PowerControlAdjustmentStates is configured as the sameAsFci2, or the srs-PowerControlAdjustmentStates is not configured), the UE may not expect that the srs-PowerControlAdjustmentStates-r19 is configured.

For the above two cases, when the UE has been configured with followUnifiedTCI-StateSRS-r17 or/and applyIndicatedTCI-State-r18 in the above Table 29 within the SRS-ResourceSet that is the higher layer signaling, the UE may not be configured with the srs-PowerControlAdjustmentStates-r19. In this case, for the management of the closed loop power control index not shared with PUSCH, the UE may be configured with the srs-PowerControlAdjustmentStates, which is the higher layer signaling in the above Table 29, as the separateClosedLoop, and may use the first or second closed loop power control index for the SRS which may be indicated by the base station through a joint TCI state or a separate UL TCI state expressed in Table 26 or Table 27. For example, when the followUnifiedTCI-StateSRS-r17 or/and the applyIndicatedTCI-State-r18 are configured for a specific SRS resource set, the UE may apply the joint TCI state or the separate UL TCI state indicated by the base station to the SRS resource set for the power control of the corresponding SRS resource set, and thus apply the closed loop power control index for the SRS that may be indicated by the corresponding TCI state.

The DCI format 2_3 described in the fourth embodiment is defined assuming one closed loop power control index for the SRS that is not shared with the PUSCH. When the UE may use up to two closed loop power control indexes for the SRS that are not shared with the PUSCH, the UE may consider at least one combination of the following methods as various methods for determining which closed loop power control index the DCI format 2_3 received from the base station should be applied to.

### [Method 5-1]

A UE may expect that a closed loop power control index field is added within a DCI format 2_3, and the corresponding new field may be 0 or 1 bit depending on a higher layer signaling configuration. When the corresponding field is 1 bit, the UE may be indicated with information on whether the closed loop power control index is the first index or the second index through the corresponding field.

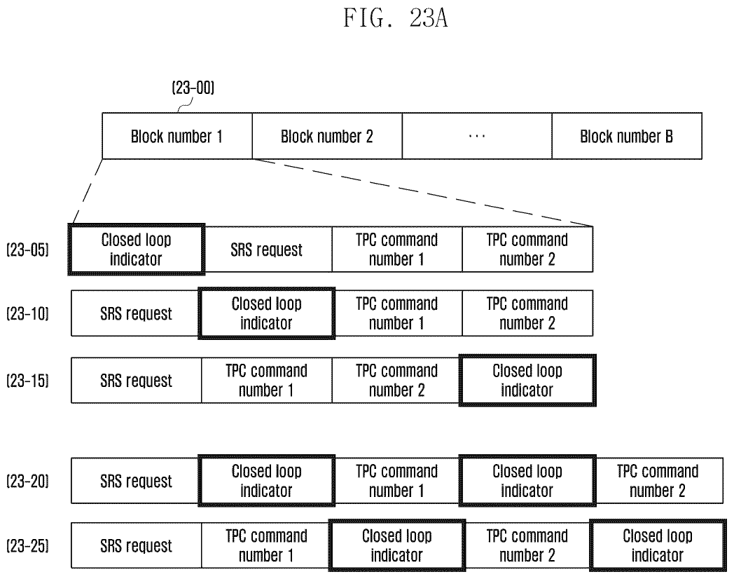

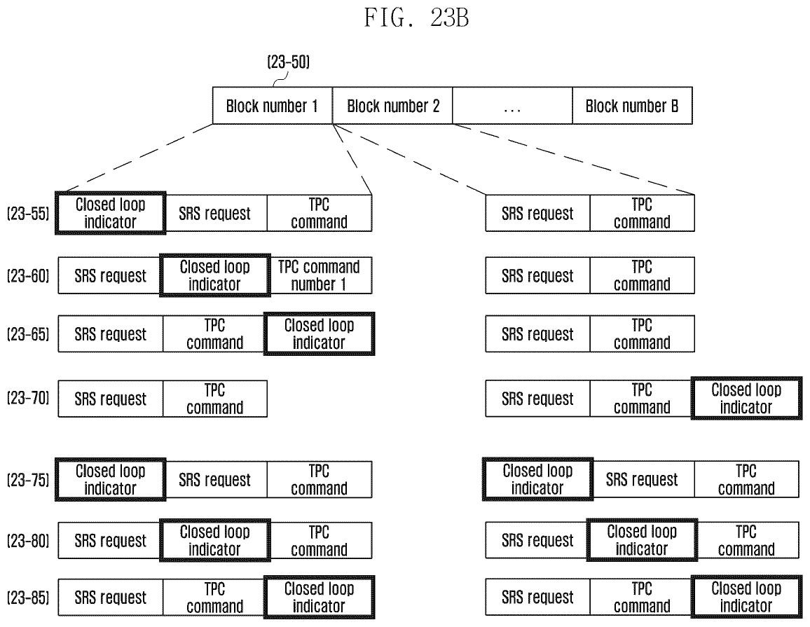

FIGS. 23A and 23B are diagrams illustrating examples in which the closed loop power control index field may be included within the DCI format 2_3, according to various embodiments of the disclosure.

FIG. 23A illustrates an example of a configuration of the closed loop power control index field within the DCI format 2_3 when the srs-TPC-PDCCH-Group, which is the higher layer signaling, is configured as the typeA according to an embodiment of the disclosure.

Referring to FIG. 23A, when the UE is configured with the srs-TPC-PDCCH-Group, which is the higher layer signaling, as the typeA, the UE may recognize one block within the DCI format 2_3 as the information about the corresponding UE and interpret the information (23-00). The closed loop power control index field may exist as one according to the higher layer signaling configuration and may be commonly applied to one or more TPC command fields that may exist in the corresponding block. Alternatively, the closed loop power control index field may exist as many as the number of TPC command fields according to the higher layer signaling configuration and may be individually applied to each TPC command field. In this case, when there is the closed loop power control index field applied to each TPC command field, the plurality of closed loop power control index fields may always exist as many as the number of TPC command fields depending on whether the specific higher layer signaling is configured, or the maximum number may exist as many as the number of TPC command fields depending on the higher layer signaling configurations for each cell to which each TPC command field is applied, and the closed loop power control index fields that may be applied to each TPC command field may exist or may not exist.

For example, when there is a closed loop power control index field commonly applied to one or more TPC command fields in each block within the DCI format 2_3, the corresponding closed loop power control index field may exist before the SRS request field (23-05). In this case, when a specific block within the DCI format 2_3 is allocated to one or more UEs, i.e., when the same SRS request and TPC command information are indicated to the plurality of UEs, there is an advantage that each UE may commonly interpret the corresponding block by being configured with the information about different starting points from the base station as the higher layer signaling. For example, when a first UE has only one PUSCH and individual closed loop power control index for the SRS, a second UE has two PUSCHs and individual closed loop power control indexes for the SRS, and the base station wants to transmit the same information to two UEs so that the two UEs interpret the same block, the base station may configure the first UE to interpret the corresponding block from bit position b1 through the higher layer signaling regarding the starting point and configure the second UE to interpret the corresponding block from bit position b1−1. The first UE and the second UE may identically interpret the SRS request and one or more TPC command fields from the bit position b1, and the second UE may additionally interpret the closed loop power control index field by one bit from the bit position b1−1 to identify a closed loop power control index to which one or more TPC command fields existing after the bit position b1−1 are to be applied.

Alternatively, when there is the closed loop power control index field commonly applied to one or more TPC command fields in each block within the DCI format 2_3, the corresponding closed loop power control index field may exist in the middle of the SRS request field and the first TPC command field among one or more TPC command fields (23-10). In this case, since the UE may assume a field order similar to that of the DCI format 2_2 in which the TPC command information may be received in group common to the PUCCH and the PUSCH (e.g., the order of the SRS request field, the closed loop power control index field, and the TPC command field), the method for interpreting DCI format 2_2 may be similarly applied to the DCI format 2_3. However, the UE may not allocate other UEs having only one PUSCH and individual closed loop power control index for the SRS to the corresponding block in which the closed loop power control index field exists between the SRS request field and the first TPC command field.

Alternatively, when there is the closed loop power control index field commonly applied to one or more TPC command fields in each block within the DCI format 2_3, the corresponding closed loop power control index field may exist after the last TPC command field among one or more TPC command fields (23-15). In this case, when a specific block within the DCI format 2_3 is allocated to one or more UEs, i.e., when the same SRS request and TPC command information are indicated to the plurality of UEs, there is an advantage that each UE may commonly interpret the corresponding block by being configured with the information about the same starting point from the base station as the higher layer signaling. For example, when a first UE has only one PUSCH and individual closed loop power control index for the SRS, a second UE has two PUSCHs and individual closed loop power control indexes for the SRS, and the base station wants to transmit the same information to two UEs so that the two UEs interpret the same block, the base station may configure all the two UEs to interpret the starting point from the bit position b1 through the higher layer signaling. If there are two TPC command fields, the first UE and the second UE may identically interpret the SRS request and the two TPC command fields from the bit position b1, and the second UE may additionally interpret the closed loop power control index field by 1 bit from bit position b1+6 to identify the closed loop power control index to which one or more TPC command fields existing before the closed loop power control index field are to be applied.

As described above, when the closed loop power control index field is commonly applied to one or more TPC command fields, although the flexibility of utilizing the closed loop power control index may be reduced, the bit length of the DCI may be made short, and when the SRS has only one PUSCH and closed loop power control index, the same principle may be maintained as if one or more TPC command fields in each block indicated through the DCI format 2_3 are applied to the same closed loop power control index.

When there is an individual closed loop power control index field that is individually applied to each of one or more TPC command fields in each block within the DCI format 2_3, the corresponding closed loop power control index field may exist before each TPC command field to which the information of the corresponding field is applied (23-20). In this case, since the UE may assume a field order similar to that of the DCI format 2_2 in which the TPC command information may be received in group common to the PUCCH and the PUSCH (e.g., the order of the SRS request field, the closed loop power control index field, and the TPC command field), the method for interpreting DCI format 2_2 may be similarly applied to the DCI format 2_3. However, the UE may not allocate other UEs having only one PUSCH and individual closed loop power control index for the SRS to the corresponding block in which the closed loop power control index field exists between the SRS request field and the first TPC command field.

Alternatively, when there is an individual closed loop power control index field that is individually applied to each of one or more TPC command fields in each block within the DCI format 2_3, the corresponding closed loop power control index field may exist after each TPC command field to which the information of the corresponding field is applied (23-25). In this case, the base station may allocate one or more UEs to the specific block within the DCI format 2_3, but specific UEs that have only one PUSCH and individual closed loop power control index for the SRS may identify up to one TPC command field. For example, when a first UE has only one PUSCH and individual closed loop power control index for the SRS, a second UE has two PUSCHs and individual closed loop power control indexes for the SRS, and the base station wants to transmit the same information so that the two UEs interpret the same block, the base station may configure the two UEs to interpret the starting point from the bit position b1 through the higher layer signaling. The first UE may interpret the SRS request field and the first TPC command field, and the second UE may identify the SRS request field, one or more TPC command fields, and one or more closed loop power control index fields.

As described above, when the closed loop power control index fields exist individually so that they may be individually applied to each TPC command field, although there is a disadvantage in that the bit length of the DCI may be long, the flexibility of utilizing the closed loop power control index for the SRS may be maximized, which may be an advantage in that, especially, the base station operating the UL only TRP may control both the TRP and the UL only TRP, which may operate in both the uplink and downlink, with one DCI signaling when performing the dynamic power control of the SRS. In addition, as described above, when the closed loop power control index fields exist individually so that they may be individually applied to each TPC command field, the UE may assume that the closed loop power control index fields is included as many as the number of TPC command fields based on the specific higher layer signaling, or may assume that there is no closed loop power control index field applied to a specific TPC command field based on the higher layer signaling for each cell to which each TPC command field is applied. For example, in (23-20) and (23-25), each closed loop power control index field may exist or may not exist depending on whether there is the above-described higher layer signaling.

FIG. 23B illustrates an example of the configuration of the closed loop power control index field within the DCI format 2_3 when the srs-TPC-PDCCH-Group, which is the higher layer signaling, is configured as the typeB according to an embodiment of the disclosure.

Referring to FIG. 23B, when the UE is configured with the srs-TPC-PDCCH-Group, which is the higher layer signaling, as the typeB, the UE may recognize one or more blocks within the DCI format 2_3 as the information about the corresponding UE and interpret the information (23-50). The closed loop power control index field may exist as one according to the higher layer signaling configuration, and may commonly be applied to each of one TPC command field that may exist in each of the corresponding one or more blocks. Alternatively, the closed loop power control index field may exist in each of one or more blocks according to the higher layer signaling configuration, and may be individually applied to each TPC command field in each block. In this case, when there is each closed loop power control index field applied to each TPC command field existing in each block (i.e., when there are the closed loop power control index fields in each block), the plurality of closed loop power control index fields may always exist as many as the number of TPC command fields depending on whether the specific higher layer signaling is configured, or the maximum number may exist as many as the number of TPC command fields depending on the higher layer signaling configurations for each cell to which each TPC command field is applied, and the closed loop power control index fields that may be applied to each TPC command field may exist or may not exist.

For example, when there is a closed loop power control index field commonly applied to one or more TPC command fields in each block within the DCI format 2_3, the corresponding closed loop power control index field may exist before the SRS request field (23-55). In this case, when one or more specific blocks within the DCI format 2_3 are commonly allocated to one or more UEs, i.e., when the same SRS request and TPC command information are indicated to the plurality of UEs, there is an advantage that each UE may commonly interpret the corresponding block by being configured with the information about different starting points from the base station as the higher layer signaling. For example, when a first UE has only one PUSCH and individual closed loop power control index for the SRS, a second UE has two PUSCHs and individual closed loop power control indexes for the SRS, and the base station wants to transmit the same information so that the two UEs interpret two identical blocks, the base station may configure the first UE to interpret the identical blocks from the bit position b1 through the higher layer signaling regarding the starting point and configure the second UE to interpret the identical blocks from the bit position b1−1. The first UE and the second UE may identically interpret information about two blocks from the bit position b1, and the second UE may additionally interpret the closed loop power control index field by one bit from the bit position b1−1 to identify a closed loop power control index to which two TPC command fields within two blocks existing after the bit position b1−1 are to be applied.

Alternatively, when there is the closed loop power control index field commonly applied to one or more TPC command fields in each block within the DCI format 2_3, the corresponding closed loop power control index field may exist in the middle of the SRS request field and the TPC command field within a first block of one or more blocks applied to the corresponding UE (23-60). In this case, since the UE may assume a field order similar to that of the DCI format 2_2 in which the TPC command information may be received in group common to the PUCCH and the PUSCH (e.g., the order of the SRS request field, the closed loop power control index field, and the TPC command field), the method for interpreting DCI format 2_2 may be similarly applied to the DCI format 2_3. However, the UE may not allocate other UEs having only one PUSCH and individual closed loop power control index for the SRS to the corresponding first block, in which the closed loop power control index field exists between the SRS request field and the TPC command field, among the blocks allocated to the UE. However, when the plurality of blocks are allocated to the UE, the blocks other than the first block may be allocated in common with the UEs that may have one PUSCH and individual closed loop power control index for the SRS.

Alternatively, when there is the closed loop power control index field commonly applied to one or more TPC command fields in each block within the DCI format 2_3, the corresponding closed loop power control index field may exist after the TPC command field of the first block of one or more blocks (23-65). In this case, the base station may allocate one or more UEs to one or more specific blocks within the DCI format 2_3, but specific UEs that have only one PUSCH and individual closed loop power control index for the SRS may identify only one block when they are configured with the same starting point as UEs that have two individual closed loop power control indices. For example, when a first UE has only one PUSCH and individual closed loop power control index for the SRS, a second UE has two PUSCHs and individual closed loop power control indexes for the SRS, and the base station wants to transmit the same information so that the two UEs interpret the same block, the base station may configure the two UEs to interpret the starting point from the bit position b1 through the higher layer signaling. The first UE may interpret the SRS request field and the TPC command field in the first block, and the second UE may interpret consecutive two blocks from the configured starting point to identify the SRS request field, the closed loop power control index field, and the TPC command field in the first block, and identify the SRS request field and the TPC command field in a second block.

Alternatively, when there is the closed loop power control index field commonly applied to one or more TPC command fields in each block within the DCI format 2_3, the corresponding closed loop power control index field may exist after the TPC command field in the last block among one or more blocks (23-70). In this case, when one or more specific blocks within the DCI format 2_3 are commonly allocated to one or more UEs, i.e., when the same SRS request and TPC command information are indicated to the plurality of UEs, there is an advantage that each UE may commonly interpret the corresponding block by being configured with the information about the same starting point from the base station as the higher layer signaling. For example, when a first UE has only one PUSCH and individual closed loop power control index for the SRS, a second UE has two PUSCHs and individual closed loop power control indexes for the SRS, and the base station wants to transmit the same information so that the two UEs interpret one or more identical blocks, the base station may configure both of the two UEs to interpret the starting point from the bit position b1 through the higher layer signaling. When the number of blocks is two, the first UE and the second UE may interpret the SRS request field and the TPC command fields in the first block and the SRS field and the TPC command field in the second block from the bit position b1, and the second UE may additionally interpret the closed loop power control index field by 1 bit from bit position b1+8 to identify the closed loop power control index to which one or more TPC command fields existing before the closed loop power control index field are to be applied.

As described above, when the closed loop power control index field is commonly applied to one or more blocks, although the flexibility of the closed loop power control index utilization may be reduced, the bit length of the DCI may be shortened.

When there are individual closed loop power control index fields individually applied to the TPC command fields in each block within the DCI format 2_3, each closed loop power control index field may exist before the SRS request field in each block (23-75). In this case, when a specific block within the DCI format 2_3 is allocated to one or more UEs, i.e., when the same SRS request and TPC command information are indicated to the plurality of UEs, there is an advantage that each UE may commonly interpret the corresponding block by being configured with the information about different starting points from the base station as the higher layer signaling. For example, the case may be considered where the first UE and the second UE have only one PUSCH and individual closed loop power control index for the SRS, the third UE has two PUSCHs and individual closed loop power control indices, the first UE and the second UE interpret one block, and the third UE interprets two blocks. In this case, when the base station wants to transmit information so that the first UE and the third UE commonly interpret the first block and the second UE and the third UE commonly interpret the second block, the base station may configure the first UE, the second UE, and the third UE to interpret the starting point from the bit positions b1, b1−1, and b1+5 through the higher layer signaling. In this case, the first UE and the third UE may identically interpret the SRS request and TPC command field in the first block from the bit position b1, and the third UE may additionally interpret the closed loop power control index field by one bit from the bit position b1−1 to identify the closed loop power control index to which the TPC command field in the corresponding block is to be applied. In addition, the second UE and the third UE may interpret the SRS request and the TPC command field in the second block from the bit position b1+5, and the third UE may additionally interpret the closed loop power control index field by one bit from the bit position b1+4 to identify the closed loop power control index to which the TPC command field in the corresponding block is to be applied.

Alternatively, when there are the individual closed loop power control index fields individually applied to the TPC command fields in each block within the DCI format 2_3, each closed loop power control index field may exist between the SRS request field and the TPC command field in each block (23-80). In this case, since the UE may assume a field order similar to that of the DCI format 2_2 in which the TPC command information may be received in group common to the PUCCH and the PUSCH (e.g., the order of the SRS request field, the closed loop power control index field, and the TPC command field), the method for interpreting DCI format 2_2 may be similarly applied to the DCI format 2_3. However, the UE may not allocate other UEs having only one PUSCH and individual closed loop power control index for the SRS to the corresponding block in which the closed loop power control index field exists between the SRS request field and the first TPC command field for each block.

Alternatively, when there are the individual closed loop power control index fields individually applied to the TPC command fields in each block within the DCI format 2_3, each closed loop power control index field may exist after the TPC command field in each block (23-85). In this case, when a specific block within the DCI format 2_3 is allocated to one or more UEs, i.e., when the same SRS request and TPC command information are indicated to the plurality of UEs, there is an advantage that each UE may commonly interpret the corresponding block by being configured with the information about different starting points from the base station as the higher layer signaling. For example, the case may be considered where the first UE and the second UE have only one PUSCH and individual closed loop power control index for the SRS, the third UE has two PUSCHs and individual closed loop power control indices, the first UE and the second UE interpret one block, and the third UE interprets two blocks. In this case, when the base station wants to transmit information so that the first UE and the third UE commonly interpret the first block and the second UE and the third UE commonly interpret the second block, the base station may configure the first UE, the second UE, and the third UE to interpret the starting point from the bit positions b1, b1−1, and b1+5 through the higher layer signaling. In this case, the first UE and the third UE may identically interpret the SRS request and TPC command field in the first block from the bit position b1, and the third UE may additionally interpret the closed loop power control index field by one bit from the bit position b1+4 to identify the closed loop power control index to which the TPC command field in the corresponding block is to be applied. In addition, the second UE and the third UE may interpret the SRS request and the TPC command field in the second block from the bit position b1+5, and the third UE may additionally interpret the closed loop power control index field by one bit from bit position b1+9 to identify the closed loop power control index to which the TPC command field in the corresponding block is to be applied.

As described above, when the closed loop power control index fields exist individually so that they may be individually applied to the TPC command fields in each block, although there is a disadvantage in that the bit length of the DCI may be long, the flexibility of utilizing the closed loop power control index for the SRS may be maximized, which may be an advantage in that, especially, the base station operating the UL only TRP may control both the TRP and the UL only TRP, which may operate in both the uplink and downlink, with one DCI signaling when performing the dynamic power control of the SRS. In addition, as described above, when the closed loop power control index fields exist individually so that they may be individually applied to the TPC command fields in each block, the UE may assume that the closed loop power control index fields is included as many as the number of blocks allocated to the corresponding UE based on the specific higher layer signaling, or may assume that there is no closed loop power control index field applied to a specific TPC command field based on the higher layer signaling for each cell to which the TPC command fields in each block are applied. For example, in (23-75), (23-80), and (23-85), the closed loop power control index fields in each block may exist or may not exist depending on whether there is the above-described higher layer signaling.

### [Method 5-2]

A UE may use a plurality of blocks when interpreting information within a DCI format 2_3 from a base station.

When the UE may be configured with the srs-TPC-PDCCH-Group, which is the higher layer signaling, as the typeA and configured with up to two PUSCHS and individual closed loop power control indexes for the SRS, the UE may interpret consecutive two blocks from the interpretation starting point within the DCI format 2_3 that may be configured through the higher layer signaling. In this case, the UE may expect that the SRS request field in the first block exists or does not exist and the SRS request field in the second block does not exist according to the fieldTypeFormat2-3 configuration that is the higher layer signaling. The UE may expect that the TPC command field exists in the second block as many as the number of one or more TPC command fields that exist in the first block, and expect that one or more TPC command fields in the first block are applied to the first closed loop power control index and one or more TPC command fields in the second block are applied to the second closed loop power control index.

When the UE may be configured with the srs-TPC-PDCCH-Group, which is the higher layer signaling, as the typeB and configured with up to two PUSCHs and individual closed loop power control indexes for the SRS, the UE may interpret consecutive 2*N blocks from the interpretation starting point within the DCI format 2_3 that may be configured through the higher layer signaling, and consider the number of cells to which the TPC command is to be applied trough the higher layer signaling. In this case, the reason why the UE interprets the consecutive 2*N blocks is that N blocks may be applied to the first closed loop power control index, and the remaining N blocks may be applied to the second closed loop power control index. In addition, the UE may expect that the first closed loop power control index is applied to the first N blocks among the consecutive 2*N blocks, and the second closed loop power control index is applied to the remaining N blocks, and such block arrangement may be named a first block arrangement. In addition, the UE may expect that the first closed loop power control index is applied to odd-numbered blocks (the first block, the third block, . . . ) among the consecutive 2*N blocks, and the second closed loop power control index is applied to even-numbered blocks (the second block, the fourth block, . . . ) (the reverse order is also possible), and such block arrangement may be named a second block arrangement. In this case, the UE may assume that it is determined whether there are the SRS request fields in N blocks applied to the first closed loop power control index according to the fieldTypeFormat2-3 configuration that is the higher layer signaling, and assume that there are no SRS request fields in the remaining N blocks applied to the second closed loop power control index. The UE may be notified of one arrangement method of the first block arrangement or the second block arrangement through at least one combination of higher layer signaling, MAC-CE signaling, and L1 signaling from the base station, or may assume that one arrangement method is fixedly defined in the specification.

### [Method 5-3]

A UE may consider that there are a plurality of TPC command fields corresponding to each closed loop power control index in each block when interpreting information within a DCI format 2_3 from a base station.

When the UE may be configured with the srs-TPC-PDCCH-Group, which is the higher layer signaling, as the typeA and may configured with up to two PUSCHs and individual closed loop power control indexes for the SRS, the UE may interpret one block from the interpretation starting point within the DCI format 2_3 that may be configured through the higher layer signaling. In this case, the UE may identify whether there is the SRS request field in the corresponding one block according to the fieldTypeFormat2-3 configuration that is the higher layer signaling. The UE may expect that there are 2*N TPC command fields in the corresponding block. In this case, this is because N may mean the number of cells to which each of one or more TPC command fields that may be indicated through the corresponding block may be applied, and the N TPC command fields among the 2*N TPC command fields may be applied to the first closed loop power control index, and the remaining N TPC command fields may be applied to the second closed loop power control index. In addition, the UE may expect that the first N TPC command fields among the 2*N TPC command fields are applied to the first closed loop power control index, and the remaining N TPC command fields are applied to the second closed loop power control index, and the TPC command field arrangement may be named a first TPC command field arrangement. In addition, the UE may expect that, among the consecutive 2*N TPC command fields, odd-numbered TPC command fields (first TPC command field, third TPC command field, . . . ) are applied to the first closed loop power control index, and even-numbered TPC command fields (second TPC command field, fourth TPC command field, . . . ) are applied to the second closed loop power control index (the reverse order is also possible), and the TPC command field arrangement may be named a second TPC command field arrangement. The UE may be notified of one arrangement method of the first TPC command field arrangement or the second TPC command field arrangement through at least one combination of the higher layer signaling, the MAC-CE signaling, and the L1 signaling from the base station, or may assume that one arrangement method is fixedly defined in the specification.

When the UE may be configured with the srs-TPC-PDCCH-Group, which is the higher layer signaling, as the typeB and may configured with up two PUSCHs and individual closed loop power control indexes for the SRS, the UE may interpret consecutive N blocks from the interpretation starting point within the DCI format 2_3 that may be configured through the higher layer signaling. In this case, the UE may consider the number of cells to which the TPC command is to be applied as N through the higher layer signaling, and identify whether there is the SRS request field in the corresponding block according to the value of the fieldTypeFormat2-3, which is the higher layer signaling, that may be configured in the UE, and may consider that there are a total of two TPC command fields that may be applied to the first and second closed loop power control indices, respectively.

### [Method 5-4]

Additional higher layer signaling may be defined to determine, by the UE, a starting point for interpreting information within DCI format 2_3 received from a base station. For example, the UE may be configured with higher layer signaling such as startingBitOfFormat2-3 and startingBitOfFormat2-3_cl1 from the base station, respectively, and configured with a starting point within the DCI format 2_3 corresponding to the first closed loop power control index and the second closed loop power control index through each parameter. In this case, the startingBitOfFormat2-3_cl1, which is the higher layer signaling name, is only an example, and may be used with another name.

When the UE may be configured with the srs-TPC-PDCCH-Group, which is the higher layer signaling, as the typeA and configured with up to two PUSCHs and individual closed loop power control indexes for the SRS, the UE may be configured with the starting points within the DCI format 2_3 corresponding to the first and second closed loop power control indexes as the higher layer signaling, respectively. The UE may interpret one block from the starting point configured through the startingBitOfFormat2-3. The UE may identify whether there is the SRS request field in the corresponding block according to the fieldTypeFormat2-3 configuration that is the higher layer signaling and assume that there are one or more TPC command fields according to the higher layer signaling configuration later, and the one or more TPC command fields may be applied to the first closed loop power control index. In addition, the UE may interpret one block from the starting point configured through the startingBitOfFormat2-3_cl1. The UE may assume that there is no the SRS request field in the corresponding block regardless of the fieldTypeFormat2-3 configuration that is the higher layer signaling, and assume that there is one or more TPC command fields in the corresponding block according to the higher layer signaling configuration, and the one or more TPC command fields may be applied to the second closed loop power control index.

When the UE may be configured with the srs-TPC-PDCCH-Group, which is the higher layer signaling, as the typeB and configured with up to two PUSCHs and individual closed loop power control indexes for the SRS, as described above, the UE may be configured with the starting points within the DCI format 2_3 corresponding to the first and second closed loop power control indexes as the higher layer signaling, respectively. The UE may interpret one or more consecutive blocks from the starting point configured through the startingBitOfFormat2-3, and the UE may identify whether there is the SRS request field in the one or more blocks according to the fieldTypeFormat2-3 configuration which is the higher layer signaling and may assume that there is one TPC command field in each block, and each TPC command field included in each of the corresponding one or more blocks may be applied to the first closed loop power control index. In addition, the UE may interpret one or more consecutive blocks from the starting point configured through the startingBitOfFormat2-3_cl1, and the UE may assume whether there is no SRS request field in the one or more blocks regardless of the fieldTypeFormat2-3 configuration which is the higher layer signaling, and assume that there is one TPC command field in each block, and each TPC command field included each of the corresponding one or more blocks may be applied to the second closed loop power control index.

### [Method 5-5]

A UE may be configured with a TPC command field indicated by a DCI format 2_3 from a base station so that the TPC command field corresponds to a specific closed loop power control index through higher layer signaling.

For example, the UE may be configured with either 0 or 1 as closedLoopIndicator that is the higher layer signaling in the SRS-CarrierSwitching that is the higher layer signaling, and the corresponding parameter being 0 or 1 may mean the first closed loop power control index or the second closed loop power control index. In this way, configuring the closed loop power control index in the SRS-CarrierSwitching may mean that only a specific closed loop power control index is supported for a specific cell in which the SRS-CarrierSwitching is configured. This method may be possible when the UE is configured with the srs-TPC-PDCCH-Group, which is the higher layer signaling, as the typeA or typeB, but in case of the typeA, the flexibility may be reduced because the same closed loop power control index may have to be used for all cell sets.

For another example, the UE may be configured with either 0 or 1 as the closedLoopIndicator that is the higher layer signaling within the SRS-cc-SetIndex that is the higher layer signaling. As described above, the UE may be configured with the SRS-cc-SetIndex only when the UE is configured with the srs-TPC-PDCCH-Group as the typeA, and the UE may be configured with the closed loop power control index that may be considered within the corresponding cell set depending on which cell set the cell is included in. For example, when the UE is configured with the SRS-TPC-PDCCH-Config including two SRS-cc-SetIndexes within the SRS-CarrierSwitching, which is the higher layer signaling, for the specific cell, the first SRS-cc-SetIndex is configured with the cc-SetIndex of 0, the cc-IndexInOneCC-Set is configured to 1, and the closedLoopIndicator is configured to 0, and the second SRS-cc-SetIndex is configured with the cc-SetIndex of 1, the cc-IndexInOneCC-Set is configured to 3, and the closedLoopIndicator is configured to 1, the UE may determine which closed-circuit power control index to apply the TPC command to depending on which cell set (e.g. each cell set with the cc-SetIndex configured to 0 or 1) the cell belongs to. The method may only be used for the case where the UE is configured with the srs-TPC-PDCCH-Group, which is the higher layer signaling, as the typeA, so there is a problem in that the method may not be used for the typeB, and the typeA may relatively secure flexibility since different closed loop power control indices may need to be used for each cell set.

In this case, the closedLoopIndicator, which is the higher layer signaling name, is only an example, and may be used with a different name.

The UE may be notified of at least one combination of the above-described [Method 5-1] to [Method 5-5] from the base station through at least one combination of the higher layer signaling, the MAC-CE signaling, and the L1 signaling, or may expect that at least one combination of the above-described [Method 5-1] to [Method 5-5] is fixedly defined in the specification. Additionally, when the UE is notified of a combination of specific one or more methods from the base station through at least one combination of the higher layer signaling, the MAC-CE signaling, and the L1 signaling, it may mean that the UE may not support specific one or more other combinations of the methods. For example, the UE may expect that the above-described [Method 5-1] is fixedly defined in the specification for the method of determining to which closed loop power control index the DCI format 2_3 received from the base station should be applied. For another example, the UE may be notified of the above-described [Method 5-2] from the base station through at least one combination of the higher layer signaling, the MAC-CE signaling, and the L1 signaling. In this case, the UE may consider that the UE has been notified by the base station that the above-described [Method 5-1] is not supported.

The UE may report to the base station in the UE capability whether it can support at least one combination of the above-described [Method 5-1] to [Method 5-5]. In this case, when the UE reports to the base station in the UE capability that it can support a combination of specific one or more methods, it may be considered that the UE has reported that it cannot support specific one or more other combinations of the methods. For example, the UE may report to the base station as to whether it can support the above-described [Method 5-1] or [Method 5-2]. For another example, the UE may report to the base station that it can support the above-described [Method 5-2], and the UE capability report may mean that the UE cannot support [Method 5-1].

### Sixth Embodiment: Method for Determining Starting Point of Interpreting Information for Each UE within Group Common Downlink Control Information Format 2_3

According to an embodiment of the disclosure, a method for determining a starting point of interpreting information for each UE within a group common downlink control information format 2_3 will be described. The embodiment may be operated in combination with other embodiments.

The UE may assume that the bit length of the DCI format 2_3 is shorter than or equal to the length of the DCI format 1_0 that may be monitored within the common search space in the same cell. When the bit length of the DCI format 2_3 is shorter than the bit length of the DCI format 1_0 that may be monitored within the common search space within the same cell, the UE may include 0 bits until the bit length of the DCI format 2_3 becomes equal to the bit length of DCI format 1_0 that may be monitored within the common search space within the same cell.

Each field and bit length within the DCI format 1_0 considering the CRC scrambled with C-RNTI, CS-RNTI, and MCS-C-RNTI may be defined as shown in Table 31 below. In Table 31 below, a first column may represent names of each field within the DCI format 1_0, a second column may represent bit lengths of each field, and a third column may represent whether the corresponding field is essentially included within the DCI format 1_0, and Y may mean that the corresponding field is essentially included, and N may mean that the corresponding field is not essentially included.

TABLE 31

| DCI format 1_0 | Bits | Mandatory |
|---|---|---|
| Identifier for DCI formats | 1 | Y |
| Frequency domain resource assignment | B | Y |
| Time domain resource assignment | 4 | Y |
| VRB-to-PRB mapping | 1 | Y |
| Modulation and coding scheme | 5 | Y |
| New data indicator | 1 | Y |
| Redundancy version | 2 | Y |
| HARQ process number | 4 | Y |
| Downlink assignment index | 2 | Y |
| TPC command for scheduled PUCCH | 2 | Y |
| PUCCH resource indicator | 3 | Y |
| PDSCH-to-HARQ feedback timing indicator | 3 | Y |
| Additional | 2 | N |
| (only for shared spectrum in FR1 or FR2-2) | | |

| | |
|---|---|
| Total | B + 28 + 2 (0 ≤ |
| | B ≤ 16) → 30~46 |

In the above Table 31, a frequency domain resource assignment (FDRA) field may be different depending on a size of a bandwidth part, and the range can be from 0 bits to 16 bits. Considering size B of the FDRA field, the UE may assume that the bit length of DCI format 1_0 ranges from 30 bits to 46 bits.

The UE may be configured with the starting point for interpreting information about the corresponding UE within the DCI format 2_3 based on the startingBitOfFormat2-3 that is the higher layer signaling for the NUL and the startingBitOfFormat2-3SUL-v1530 that is the higher layer signaling for the SUL. In this case, the range of values of the startingBitOfFormat2-3 and the startingBitOfFormat2-3SUL-v1530, which are the higher layer signaling, may be a natural number from 1 to 32.

When the higher layer signaling meaning the starting point as described above corresponds to a natural number from 1 to 32, the UE may be configured to 32 as the maximum value of the starting point. In this case, when the length of the block that may be interpreted from the starting point is 2 bits, the UE may interpret the 32nd and 33rd bits of the DCI format 2_3 to apply the TPC command or perform the SRS carrier switching. In this case, by performing an operation to match the lengths between the DCI formats, the DCI format 2_3 may add 0 bits until the length of the DCI format 2_3 becomes the same as that of the DCI format 1_0, and when the length of the last block is 2 bits as described above, the corresponding DCI format 2_3 may use only up to the 33rd bit, so that up to 13 bits may be wasted. As described above, when the UE may be configured with up to two PUSCH and individual closed loop power control indexes for the SRS, the lengths of bits to be interpreted by the UE within the DCI format 2_3 may be longer, or it may be necessary to efficiently utilize all bit positions of the DCI format 2_3, so it is necessary to adjust the range of the starting point. To this end, at least one combination of the following methods may be considered.

### [Method 6-1]

A UE may expect that a value corresponding to one natural number from 1 to X is configured for startingBitOfFormat2-3 or startingBitOfFormat2-3SUL-v1530 that is higher layer signaling meaning a starting point of the interpretation for a DCI format 2_3. In this case, X may be one natural number value from 33 to 45.

For example, when the UE considers X as 43, i.e., when the UE considers the maximum value as 43 for the startingBitOfFormat2-3 or the startingBitOfFormat2-3SUL-v1530, which is the higher layer signaling meaning the starting point of interpretation for the DCI format 2_3, it may mean that the UE does not use the Additional field (e.g., ChannelAccess-CPext field or/and Reserved bits) in the above Table 31, and the shortest length block is 2 bits, so the 43rd and 44th bits may be used.

For another example, when the UE considers X as 45, i.e., when the UE considers the maximum value as 45 for the startingBitOfFormat2-3 or the startingBitOfFormat2-3SUL-v1530 that is the higher layer signaling meaning the starting point of interpretation for the DCI format 2_3, it may mean that the UE uses the Additional field (e.g., ChannelAccess-CPext field or/and Reserved bits) in the above Table 31, and the shortest length block is 2 bits, so the 45th and 46th bits may be used.

For another example, when the UE considers X as one of the natural numbers from 33 to 45, that is, when the UE considers the maximum value as one natural number value from 33 to 45 for the startingBitOfFormat2-3 or the startingBitOfFormat2-3SUL-v1530 that is the higher layer signaling meaning the starting point of interpretation for the DCI format 2_3, the UE may support utilizing more bit positions within the DCI format 2_3 than 32 that is the conventional maximum value.

### [Method 6-2]

Since a UE may determine a final bit length of a DCI format 1_0 depending on a size B of the FDRA field, the UE may express startingBitOfFormat2-3 or startingBitOfFormat2-3SUL-v1530, which is the higher layer signaling meaning a starting point of interpretation for the DCI format 2_3, using a length B of the FDRA field in the above Table 31.

For example, the UE may consider the maximum value of the startingBitOfFormat2-3 or the startingBitOfFormat2-3SUL-v1530, which is the higher layer signaling meaning the starting point of interpretation for the DCI format 2_3, as B+27. In this case, the UE may mean that the Additional field (e.g., ChannelAccess-CPext field or/and Reserved bits) in the above Table 31 is not used, and since the block with the shortest length is 2 bits, B+27th and B+28th bits may be used.

For another example, the UE may consider the maximum value of the startingBitOfFormat2-3 or the startingBitOfFormat2-3SUL-v1530, which is the higher layer signaling meaning the starting point of interpretation for the DCI format 2_3, as B+29. In this case, the UE may mean that the Additional field (e.g., ChannelAccess-CPext field or/and Reserved bits) in the above Table 31 is used, and since the block with the shortest length is 2 bits, B+29th and B+30th bits may be used.

The UE may be notified of at least one combination of the above-described [Method 6-1] or [Method 6-2] from the base station through at least one combination of the higher layer signaling, the MAC-CE signaling, and the L1 signaling, or may expect that at least one combination of the above-described [Method 6-1] to [Method 6-2] is fixedly defined in the specification. Additionally, when the UE is notified of a combination of specific one or more methods from the base station through at least one combination of the higher layer signaling, the MAC-CE signaling, and the L1 signaling, it may mean that the UE may not support specific one or more other combinations of the methods. For example, the UE may expect that the above-described [Method 6-1] is fixedly defined in the specification for the method of determining the maximum value of the higher layer signaling related to the starting point to be interpreted by the UE within the DCI format 2_3 received from the base station. For another example, the UE may be notified of the above-described [Method 6-2] from the base station through at least one combination of the higher layer signaling, the MAC-CE signaling, and the L1 signaling. In this case, the UE may consider that the UE has been notified by the base station that the above-described [Method 6-1] is not supported.

The UE may report to the base station in the UE capability whether it can support at least one combination of the above-described [Method 6-1] or [Method 6-2]. In this case, when the UE reports to the base station in the UE capability that it can support a combination of specific one or more methods, it may be considered that the UE has reported that it cannot support specific one or more other combinations of the methods. For example, the UE may report to the base station as to whether it can support the above-described [Method 6-1] or [Method 6-2]. For another example, the UE may report to the base station that it can support the above-described [Method 6-2], and the UE capability report may mean that the UE cannot support [Method 6-1].

### Seventh Embodiment: Method for Notifying SRS Closed Loop Power Control Index

As an embodiment of the disclosure, a method for notifying an SRS closed loop power control index between a base station and a UE is described. The embodiment may operate in combination with other embodiments of the disclosure.

When the closed loop power control index (closed loop power control adjustment state or closed loop index or closed loop indicator) for the PUSCH and the closed loop power control index for the SRS are not shared, in case where at least one combination of the following conditions is satisfied, the UE may be configured with closed loop power control indexes for up to two SRSs and may be indicated with TPC command values for each closed loop power control index, otherwise, the UE may be configured with one closed loop power control index for the SRS and indicated with the TPC command value for the closed loop power control index.
When the UE reports to the base station the UE capability indicating that the UE can use up to two SRS closed loop power control indexes;
When the UE is configured, from the base station, with the higher layer signaling meaning that the UE may use up to two SRS closed loop power control indexes; and/or
For example, the corresponding higher layer signaling may be configured within ServingCellConfig.
Or, the corresponding higher layer signaling may be configured within PUSCH-config.
Or, the corresponding higher layer signaling may be configured within the SRS-ResourceSet.
Or, the corresponding higher layer signaling may be configured within SRS-config.
Or, the corresponding higher layer signaling may be configured within SRS-Resource.
When the UE is configured with the higher layer signaling for the path loss difference value from the base station.
For example, the corresponding higher layer signaling may be configured within the TCI state.
Or, the corresponding higher layer signaling may be configured within ServingCellConfig.
Or, the corresponding higher layer signaling may be configured within PUSCH-config.

When the UE does not satisfy the conditions and supports only one closed loop power control index for the SRS not shared with the PUSCH, if the UE is configured with the srs-PowerControlAdjustmentStates, which is the higher layer signaling within a specific SRS resource set, as the separateClosedLoop, the UE may expect that the SRS within the corresponding SRS resource set is connected to the corresponding closed loop power control index not shared with the PUSCH.
When the UE is configured with the followUnifiedTCI-StateSRS-r17 or/and the applyIndicatedTCI-State-r18 that are the higher layer signalings within the corresponding SRS resource set, the UE may ignore closedLoopIndex-r17 in poAlphaSetforSRS-r17 in uplink-powerControl within the joint TCI state or the UL TCI state that may be dynamically indicated through the DCI or the MAC-CE, or expect that the closedLoopIndex-r17 is always indicated as i0.
When the UE is not configured with the followUnifiedTCI-StateSRS-r17 or/and the applyIndicatedTCI-State-r18 in the corresponding SRS resource set that are the higher layer signaling, the UE may apply the power control parameters (e.g., poAlphaSetforSRS-r17 in the uplink-powerControl within the joint TCI state or the UL TCI state) within the joint TCI state or UL TCI state configured in the SRS resource having the lowest SRS resource ID among one or more SRS resources within the corresponding SRS resource set to all the SRS resources within the corresponding SRS resource set. In this case, the UE may ignore the closedLoopIndex-r17 within the corresponding power control parameter or expect that the closedLoopIndex-r17 is always indicated as i0.

When the UE satisfies the above-described conditions and supports up to two closed loop power control indexes for the SRS not shared with the PUSCH, the UE may consider at least one combination of the following methods.

### [Method 7-1]

A UE may be configured with parameters such as srs-PowerControlAdjustmentStates-r19 that is higher layer signaling within SRS-ResourceSet. In this case, the srs-PowerControlAdjustmentStates-r19 may indicate whether the first or second index of the two closed loop power control indexes not shared with the PUSCH is applied to one or more SRS resources within the SRS-ResourceSet with which the corresponding parameter is configured.

For example, the srs-PowerControlAdjustmentStates-r19 may be configured such as ENUMERATED {Hci1, Hci2} to mean the first or second closed loop power control index, which may correspond to the case where srs-PowerControlAdjustmentStates, which is the higher layer signaling in the above Table 29 that may be configured in the UE, is separateClosedLoop. When the srs-PowerControlAdjustmentStates, which is the higher layer signaling in the above Table 29 that may be configured within the SRS-ResourceSet, is not configured as the separateClosedLoop (i.e., when the value of the srs-PowerControlAdjustmentStates is configured to sameAsFci2, or the srs-PowerControlAdjustmentStates is not configured), the UE may not expect that the srs-PowerControlAdjustmentStates-r19 is configured. That is, when the srs-PowerControlAdjustmentStates, which is the higher layer signaling within the SRS resource set, is configured as the separateClosedLoop, the UE may additionally be configured with the srs-PowerControlAdjustmentStates-r19.

As another example, when the srs-PowerControlAdjustmentStates-r19 is configured, the UE may consider that the srs-PowerControlAdjustmentStates-r19 means the second closed loop power control index among up to two closed loop power control indexes that are not shared with the PUSCH. That is, when the UE is configured with the srs-PowerControlAdjustmentStates, which is the higher layer signaling, as the separateClosedLoop from the base station and the srs-PowerControlAdjustmentStates-r19 is not configured, the UE may consider that the first index of up to two closed loop power control indexes that are not shared with the PUSCH is connected to the corresponding SRS. In addition, when the UE is configured with the srs-PowerControlAdjustmentStates, which is the higher layer signaling, as the separateClosedLoop from the base station and the srs-PowerControlAdjustmentStates-r19 is configured, the UE may consider that the second index among up to two closed loop power control indexes that are not shared with the PUSCH is connected to the corresponding SRS.

The above-described matters may be applied to both the cases where the UE is configured with the follow UnifiedTCI-StateSRS-r17 or/and the applyIndicatedTCI-State-r18 that are the higher layer signaling within the SRS resource set, or is not configured with the followUnifiedTCI-StateSRS-r17 or/and the applyIndicatedTCI-State-r18. That is, when the UE is configured with the followUnifiedTCI-StateSRS-r17 or/and the applyIndicatedTCI-State-r18 within the SRS resource set, the UE may use p0 and alpha in the poAlphaSetforSRS-r17 in the uplink-powerControl in the joint TCI state or the UL TCI state indicated through the DCI or the MAC-CE for all the SRS resources in the corresponding SRS resource set, but may ignore the closedLoopIndex-r17, and use the closed loop power control index for the SRS not shared with the PUSCH configured within the SRS resource set in the above-described method, or expect that the closedLoopIndex-r17 is indicated identically to the closed loop power control index for the SRS not shared with the PUSCH configured within the SRS resource set in the above-described method. In addition, when the UE is not configured with the followUnifiedTCI-StateSRS-r17 or/and the applyIndicatedTCI-State-r18 within the SRS resource set, the UE may apply the p0 and the alpha in the poAlphaSetforSRS-r17 in the uplink-powerControl in the joint TCI state or the UL TCI state configured in the SRS resource having the lowest SRS resource ID within the corresponding SRS resource set to all the SRS resources within the corresponding SRS resource set, but may ignore the closedLoopIndex-r17, and may use the closed loop power control index for the SRS not shared with the PUSCH configured within the SRS resource set in the above-described method, or may expect that the closedLoopIndex-r17 is configured identically to the closed loop power control index for the SRS not shared with the PUSCH configured within the SRS resource set in the above-described method.

The srs-PowerControlAdjustmentStates-r19, which is the higher layer signaling name, is an example, and other names may not be excluded.

### [Method 7-2]

A UE may apply a closed loop power control index configured in a TCI state indicated to be applied to a specific SRS resource set or the TCI state configured in an SRS resource having the lowest SRS resource ID within the corresponding SRS resource set to be applied to the corresponding SRS resource set to the SRS resource within the corresponding SRS resource set. In this case, the UE may expect that the srs-PowerControlAdjustmentStates, which is the higher layer signaling within the SRS resource set, is configured to the separateClosedLoop.

When the UE is configured with the followUnifiedTCI-StateSRS-r17 or/and the applyIndicatedTCI-State-r18 within the SRS resource set, the UE may use the p0, the alpha, and the closedLoopIndex-r17 in the poAlphaSetforSRS-r17 in the uplink-powerControl within the joint TCI state or the UL TCI state indicated through DCI or MAC-CE for all the SRS resources within the corresponding SRS resource set when determining the SRS transmission power. Therefore, the UE may apply the first or second value of up to two closed loop power control indexes not shared with the PUSCH for the SRS through the p0, the alpha, and the closedLoopIndex-r17 in the poAlphaSetforSRS-r17 in the uplink-powerControl within the joint TCI state or the UL TCI state which may be indicated through the DCI or the MAC-CE.

In addition, when the UE is not configured with the followUnifiedTCI-StateSRS-r17 or/and the applyIndicatedTCI-State-r18 within the SRS resource set, the UE may apply the p0, the alpha, and the closedLoopIndex-r17 in the poAlphaSetforSRS-r17 in the uplink-powerControl within the joint TCI state or the UL TCI state configured in the SRS resource having the lowest SRS resource ID within the corresponding SRS resource set when determining the SRS transmission power. Therefore, the UE may apply the first or second value of up to two closed loop power control indexes not shared with the PUSCH for the SRS through the p0, the alpha, and the closedLoopIndex-r17 in the poAlphaSetforSRS-r17 in the uplink-powerControl in the joint TCI state or the UL TCI state configured in the SRS resource having the lowest SRS resource ID within the corresponding SRS resource set.

The above-described matters may be applied when the additional higher layer signaling is configured within the SRS resource set, when the additional higher layer signaling is configured within the TCI state (for example, an additional parameter such as the poAlphaSetforSRS-r19 is configured in the uplink-powerControl in the joint TCI state or the UL TCI state or an additional parameter is configured in the poAlphaSetforSRS-r19 in the uplink-powerControl within the joint TCI state or the UL TCI state to indicate one of two closed loop power control indexes for the SRS not shared with the PUSCH), or/and the conditions for using up to two closed circuit power control indexes for the SRS not shared with the PUSCH are satisfied.

### [Method 7-3]

When there are up to two closed loop power control indexes for SRS not shared with a PUSCH, a UE may consider that the first and second of the corresponding two closed loop power control indexes are connected to a specific usage of the SRS resource set. For example, the UE may expect that, among the usages of the SRS resource set, antennaswitching is connected to the first of up to two closed loop power control indexes for the SRS not shared with the PUSCH, and among the usages, beammanagement is connected to the second of up to two closed loop power control indexes for the SRS not shared with the PUSCH. The connection between these usages and up to two closed loop power control indexes for the SRS not shared with the PUSCH may be configured from the base station through the higher layer signaling, or may be fixedly defined in the specification.

The UE may be notified of one of the above-described [Method 7-1] to [Method 7-3] from the base station through at least one combination of the higher layer signaling, the MAC-CE signaling, or the L1 signaling, or may expect that one of the above-described [Method 7-1] to [Method 7-3] is fixedly defined in the specification. For example, the UE may selectively be configured with one of the above-described [Method 7-1] and [Method 7-2] from the base station through the higher layer signaling. That is, the UE may use quasi-static closed loop power control indexes for each SRS resource set based on the above-described [Method 7-1] according to the specific higher layer signaling configuration, or may use the closed loop power control index by changing the closed loop power control index according to the value configured within the joint TCI state or the UL TCI state regardless of the configuration within each SRS resource set based on the above-described [Method 7-2].

The UE may report to the base station in the form of the UE capability whether it can support at least one combination of the above-described [Method 7-1] to [Method 7-3]. In this case, when the UE reports to the base station in the UE capability that it can support a combination of specific one or more methods, it may be considered that the UE has reported that it cannot support specific one or more other combinations of the methods. For example, the UE may report to the base station as to whether it can support the above-described [Method 7-1] or [Method 7-2]. For another example, the UE may report to the base station that it can support the above-described [Method 7-1], and the UE capability report may mean that the UE cannot support [Method 7-2]. This UE capability report may have a reporting unit of per feature set (FS), per band, per feature set per component carrier (FSPC), and per UE. When reporting the UE capabilities for each of the methods, the individual UE capability may be defined, and the UE may report the UE capabilities, including whether or not to support each method within a single UE capability.

### Eighth Embodiment: Method for Applying Dynamic Power Control Command to SRS

As an embodiment of the disclosure, a method for applying a dynamic power control command to an SRS will be described. The embodiment may be operated in combination with other embodiments of the disclosure.

A UE may be configured with up to one or two closed loop power control indexes not shared with a PUSCH for the SRS. For the SRS having the closed loop power control index not shared with the PUSCH, the UE may receive a separate TPC command for the SRS in addition to a TPC command for the PUSCH. In order to receive the TPC command for the SRS having the closed loop power control index not shared with the PUSCH, the UE may consider at least one combination of the following methods.

As an example, when considering at least one combination of the following methods, at least one combination of the following methods may be applied to only the case where the UE is configured with up to two closed loop power control indexes not shared with the PUSCH for the SRS.

As another example, when considering at least one combination of the following methods, at least one combination of the following methods may be applied to all the cases where the UE is configured with up to one or two closed loop power control indexes not shared with the PUSCH for the SRS.

### [Method 8-1]

A UE may receive a DCI format 2_3 from a base station. The corresponding DCI format 2_3 is group common DCI that a plurality of UEs may commonly receive. The UE may monitor the corresponding DCI format 2_3 within a control resource set connected to a common search space. The UE may receive the TPC command for the SRS having the closed loop power control index not shared with the PUSCH through the DCI format 2_3.

The UE may be configured with the SRS-TPC-CommandConfig and the SRS-CarrierSwitching, which are the higher layer signalings including information about the method for receiving and interpreting DCI format 2_3. When the UE is configured with the higher layer signaling called the srs-TPC-PDCCH-Group within the SRS-CarrierSwitching, which is the higher layer signaling, as the typeA, the UE may receive the TPC command for the SRS having the closed loop power control index not shared with the PUSCH. This operation may be performed only when the SRS-CarrierSwitching or/and the srs-TPC-PDCCH-Group and individual higher layer signaling are configured.

### [Method 8-2]

A UE may receive a DCI format 2_3 from a base station. The corresponding DCI format 2_3 is group common DCI that a plurality of UEs may commonly receive. The UE may monitor the corresponding DCI format 2_3 within a control resource set connected to a common search space. The UE may receive the TPC command for the SRS having the closed loop power control index not shared with the PUSCH through the DCI format 2_3.

The UE may be configured with the SRS-TPC-CommandConfig and the SRS-CarrierSwitching, which are the higher layer signalings including information about a method for receiving and interpreting a DCI format 2_3. When the UE is configured with the higher layer signaling called the srs-TPC-PDCCH-Group within the SRS-CarrierSwitching, which is the higher layer signaling, as the typeB, the UE may receive the TPC command for the SRS having the closed loop power control index not shared with the PUSCH. This operation may be performed only when the SRS-CarrierSwitching or/and the srs-TPC-PDCCH-Group and the individual higher layer signaling are configured.

### [Method 8-3]

A UE may receive a DCI format 2_3 from a base station. The corresponding DCI format 2_3 is group common DCI that a plurality of UEs may commonly receive. The UE may monitor the corresponding DCI format 2_3 within a control resource set connected to a common search space. The UE may receive the TPC command for the SRS having the closed loop power control index not shared with the PUSCH through the DCI format 2_3.

The UE may be configured with the SRS-TPC-CommandConfig and the SRS-CarrierSwitching, which are the higher layer signalings including information about a method for receiving and interpreting a DCI format 2_3. When the UE is configured with the higher layer signaling called the srs-TPC-PDCCH-Group within the SRS-CarrierSwitching, which is the higher layer signaling, as the typeA or the typeB, the UE may receive the TPC command for the SRS having the closed loop power control index not shared with the PUSCH. This operation may be performed only when the SRS-CarrierSwitching or/and the srs-TPC-PDCCH-Group and the individual higher layer signaling are configured.

### [Method 8-4]

A UE may receive a DCI format 2_3 from a base station. The corresponding DCI format 2_3 is group common DCI that a plurality of UEs may commonly receive. The UE may monitor the corresponding DCI format 2_3 within a control resource set connected to a common search space. The UE may receive the TPC command for the SRS having the closed loop power control index not shared with the PUSCH through the DCI format 2_3.

The UE may be configured with the SRS-TPC-CommandConfig and the SRS-CarrierSwitching, which are the higher layer signalings including information about a method for receiving and interpreting a DCI format 2_3. When the UE is configured with the higher layer signaling called the srs-TPC-PDCCH-Group within the SRS-CarrierSwitching that is the higher layer signaling as a type (e.g., typeC may be possible, and the name typeC is only an example and may not be limited thereto) other than the typeA or the typeB, the UE may receive the TPC command for the SRS having the closed loop power control index not shared with the PUSCH. Alternatively, the UE may not be configured with a specific type through the srs-TPC-PDCCH-Group, but may receive configurations for other types through separate higher layer signaling. Such separate higher layer signaling may be included in the SRS-CarrierSwitching, or may be configured per cell group, per serving cell, per bandwidth part, per PUSCH-related higher layer signaling, or per SRS-related higher layer signaling. In addition, this operation may be performed only when the SRS-CarrierSwitching or/and the srs-TPC-PDCCH-Group and the individual higher layer signaling are configured.

### [Method 8-5]

A UE may receive a DCI format 2_3 from a base station. The corresponding DCI format 2_3 is group common DCI that a plurality of UEs may commonly receive. The UE may monitor the corresponding DCI format 2_3 within a control resource set connected to a common search space. The UE may receive the TPC command for the SRS having the closed loop power control index not shared with the PUSCH through the DCI format 2_3.

The UE may consider at least one combination of the above-described [Method 8-1] to [Method 8-3] when receiving the higher layer signaling including the information about the method for receiving and interpreting a DCI format 2_3. The UE may consider a new RNTI value when receiving the DCI format 2_3. The corresponding value may be a parameter such as the TPC-SRS-RNTI with which the UE may be configured within the PhysicalCellGroupConfig and an individual configuration parameter (e.g., a configuration parameter such as the TPC-SRS-RNTI-r19 may be newly defined, and the name of the corresponding parameter is an example and may not be limited thereto). When the UE is configured with the specific higher layer signaling, the UE may receive and decode the DCI format 2_3 including the scrambled CRC using the new RNTI value described above.

### [Method 8-6]

The UE may receive a new DCI format indicating the TPC command for the SRS from the base station. The corresponding DCI format may be the group common DCI format, and may be, for example, DCI format 2_X or 2_10 (2_X or 2_10, which is the index of the DCI format, is an example and may not be limited thereto). The UE may be configured with the higher layer signaling for this, and the corresponding new DCI format may include at least one combination of at least one TPC command field, a closed loop power control index indication field, and a TPC command field corresponding to a second closed loop power control index. In addition, since the corresponding new DCI format may be the group common DCI format, the UE may be configured with higher layer signaling for decoding the corresponding new DCI format and notifying of a location for the information indicated to the corresponding UE. The corresponding new DCI format may match bit lengths of DCI formats 1_0 and 0_0. The corresponding new DCI format can be monitored in a group the common search space, and higher layer signaling may be configured in the UE so that only the corresponding new DCI format may be monitored in a specific search space, or may be configured so that the monitoring may be possible together with other DCI formats. In another method, the corresponding new DCI format may be defined as a UE-specific DCI format.

### [Method 8-7]

A UE may receive an indication of a TPC command for an SRS from a base station through a new field within a conventional UE-specific DCI format. The conventional UE-specific DCI format may be at least one of DCI formats 1_0, 1_1, 1_2, 1_3, 0_0, 0_1, 0_2, and 0_3. When there is one closed loop power control index not shared with a PUSCH, there may be one new field indicating the TPC command for the SRS. When there are two closed loop power control indexes not shared with the PUSCH, there may be two new fields indicating the TPC command for the SRS, or there may be one new field indicating the TPC command for the SRS and one field indicating the closed loop power control index for the SRS.

When the UE does not schedule the PUSCH through the DCI format 0_0, 0_1, 0_2, or 0_3, for example, when the UE requests aperiodic or semi-persistent CSI reporting with a CSI request field or/and triggers an aperiodic SRS transmission through the SRS request field, the UE may interpret the TPC command field for the PUSCH within the corresponding DCI format as the TPC command indication for the SRS.
When one TPC command field for the PUSCH exists within the corresponding DCI format and when there is one closed loop power control index for the SRS, the TPC command indicated to the corresponding one closed loop power control index may be applied. When there is one TPC command field for the PUSCH within the corresponding DCI format and when there are two closed loop power control indexes for the SRS, the TPC command indicated to the first closed loop power control index may be applied or the TPC command may be applied to a specific index among the first or second closed loop power control indexes through the higher layer signaling configured by the base station. Alternatively, when there are two closed loop power control indexes for the SRS and when there is one TPC command field for the PUSCH within the corresponding DCI format, the UE may expect that one field indicating the closed loop power control index for the SRS is included within the corresponding DCI format, and may be indicated with which of the closed loop power control indexes for the SRS the value indicated through the TPC command field for the PUSCH within the corresponding DCI format is applied to.
When two TPC command fields for the PUSCH exist within the corresponding DCI format (e.g., when the UE is configured with SecondTPCFieldDCI-0-1 or SecondTPCFieldDCI-0-2 that is the higher layer signaling), the UE may receive the TPC command to be applied to the closed loop power control index for the corresponding SRS through the first TPC command field for the PUSCH when there is one closed loop power control index for the SRS, and the UE may receive the TPC command to be applied to each of the first and second closed loop power control indexes for the SRS through the first TPC command field and the second TPC command field for the PUSCH when there are two closed loop power control indexes for the SRS.
When the UE is capable of PUSCH scheduling for multi-TRP through the DCI format 0_0, 0_1, 0_2, or 0_3 (e.g., when two SRS resource sets having usage configured as codebook or noncodebook are configured), the UE may expect that the SRS resource set indicator field exists within the corresponding DCI format. In this case, the UE may perform the following operations in interpreting the TPC command field according to the indication value of the SRS resource set indicator field. The following operations may be performed only when the UE receives from the base station at least one combined notification of the specific higher layer signaling, the MAC-CE signaling, and the L1 signaling having the meaning that the UE may apply the TPC command field for the PUSCH to the closed loop power control index for the SRS. In addition, the case where the UE receives the specific higher layer signaling and two TPC command fields for the PUSCH exist within the corresponding DCI format may be considered.
When the UE is indicated with “00” (transmit the PUSCH corresponding to the first SRS resource set in a single TRP transmission manner) through the SRS resource set indicator field, the UE may apply the first TPC command field for the PUSCH to the scheduled PUSCH through the corresponding DCI, apply a value indicated by the second TPC command field for the PUSCH to the corresponding closed loop power control index when there is one closed loop power control index for the SRS, apply the value indicated by the second TPC command field to the first or second closed loop power control index for the SRS according to the rule fixed in the standard or the higher layer signaling configuration when there are two closed loop power control indexes for the SRS, include a new field indicating the closed loop power control index for the SRS in the corresponding DCI format, and may be indicated, through the new field, with which specific closed loop power control index for the SRS the value indicated by the second TPC command field is applied to.
When the UE is indicated with “01” (transmit the PUSCH corresponding to the second SRS resource set in a single TRP transmission manner) through the SRS resource set indicator field, the UE may apply the second TPC command field for the PUSCH to the scheduled PUSCH through the corresponding DCI, apply a value indicated by the first TPC command field for the PUSCH to the corresponding closed loop power control index when there is one closed loop power control index for the SRS, apply the value indicated by the first TPC command field to the first or second closed loop power control index for the SRS according to the rule fixed in the standard or the higher layer signaling configuration when there are two closed loop power control indexes for the SRS, include a new field indicating the closed loop power control index for the SRS in the corresponding DCI format, and may be indicated, through the new field, with which specific closed loop power control index for the SRS the value indicated by the second TPC command field is applied to.

The UE may similarly apply the matters for the above-described DCI formats 0_0, 0_1, 0_2, or 0_3 to the DCI formats 1_0, 1_1, 1_2, or 1_3.

The UE may be notified of one of the above-described [Method 8-1] to [Method 8-7] from the base station through at least one combination of the higher layer signaling, the MAC-CE signaling, or the L1 signaling, or may expect that one of the above-described [Method 8-1] to [Method 8-7] is fixedly defined in the specification. For example, the UE may expect that [Method 8-7] is fixedly defined in the standard. For example, the UE may selectively be configured with one of the above-described [Method 8-3] and [Method 8-4] from the base station through the higher layer signaling.

Through at least one combination of the above-described [Method 8-1] to [Method 8-7], the UE may be indicated with the TPC command for the SRS. In this case, the field indicating the TPC command for the SRS may have 2 bits or bits more than or equal to 2 bits. When the TPC command for the SRS has bits more than 2 bits, (i) when the UE operates in TPC accumulation, the TPC command (e.g., values such as −7, −5, −3, 5, and 7 can be indicated, but these values are only one example and may not be limited thereto) with smaller or larger values other than −1, 0, 1, or 3 dB value may be indicated through the corresponding field, and (ii) when the UE operates in absolute TPC, the TPC command (e.g., values such as −13, −10, −7, 7, 10, and 13 can be indicated, but these values are only one example and may not be limited thereto) with smaller or larger values than −4, −1, 1, or 4 dB value may be indicated through the corresponding field.

The UE may report to the base station in the form of the UE capability whether it can support at least one combination of the above-described [Method 8-1] to [Method 8-7]. In this case, when the UE reports to the base station in the UE capability that it can support a combination of specific one or more methods, it may be considered that the UE has reported that it cannot support specific one or more other combinations of the methods. For example, the UE may report to the base station as to whether it can support the above-described [Method 8-3] or [Method 8-4]. For another example, the UE may report to the base station that it can support the above-described [Method 8-7], and the UE capability report may mean that the UE cannot support [Method 8-3]. This UE capability report may have a reporting unit of per feature set (FS), per band, per feature set per component carrier (FSPC), and per UE. When reporting the UE capabilities for each of the methods, the individual UE capability may be defined, and the UE may report the UE capabilities, including whether or not to support each method within a single UE capability.

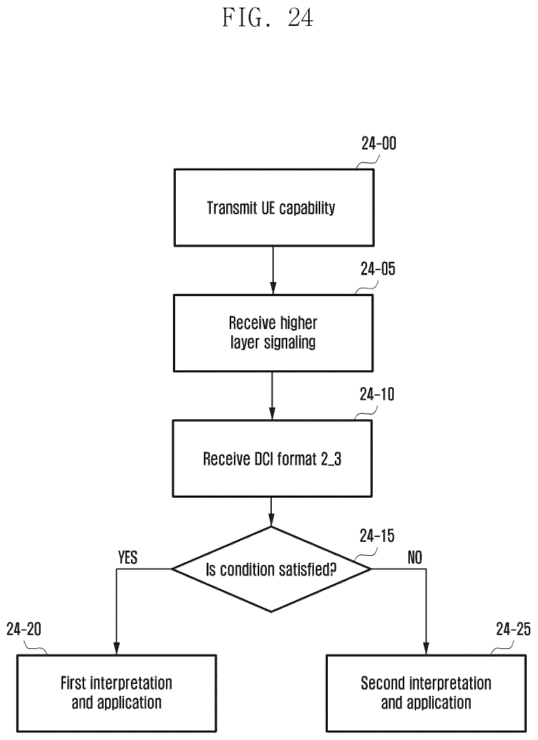

FIG. 24 is a diagram illustrating an operation of a UE for the transmission power control of SRS, according to one embodiment of the disclosure.

Referring to FIG. 24, in operation 24-00, the UE may transmit the UE capability to the base station. In this case, the UE capability signaling that may be reported may be at least one combination of the PUSCH, PUCCH, SRS transmission, and transmission power parameter-related UE capabilities, the integrated TCI state operation-related UE capability, the above-described [Method 1-1], [Method 1-2], [Method 2-1] and [Method 2-2], [Method 3-1] to [Method 3-5], the SRS carrier switching-related UE capability, the group common DCI format 2_3 and the TPC command reception-related UE capabilities, UE capabilities corresponding to the above-described [Method 5-1] to [Method 5-5], UE capabilities corresponding to the above-described [Method 6-1] to [Method 6-2], UE capabilities corresponding to the above-described [Method 7-1] to [Method 7-3], and UE capabilities corresponding to the above-described [Method 8-1] to [Method 8-7]. The operation 24-00 can also be omitted.

In operation 24-05, the UE may receive the higher layer signaling (e.g., RRC signaling) from the base station according to the reported UE capabilities. In this case, the UE may define higher layer parameters for at least one combination of the PUSCH, PUCCH, SRS transmission, and transmission power parameter-related higher layer signaling, the integrated TCI state operation-related higher layer signaling, the above-described [Method 1-1], [Method 1-2], [Method 2-1] and [Method 2-2], [Method 3-1] to [Method 3-5] support-related higher layer signaling, the SRS carrier switching support-related higher layer signaling, the group common DCI format 2_3 and TPC command reception support-related higher layer signaling, the above-described [Method 5-1] to [Method 5-5] support-related higher layer signaling, and use one of the defined higher layer parameters. For example, the UE may receive higher layer signaling of [Method 6-1] to [Method 6-2] from the base station. For example, the UE may receive higher layer signaling of [Method 7-1] to [Method 7-3] from the base station. For example, the UE may receive higher layer signaling of [Method 8-1] to [Method 8-7] from the base station.

In operation 24-10, the UE may receive a DCI format from the base station. For example, the DCI format may be the DCI format 2_3. The DCI format 2_3 may include one or more blocks. For example, the UE may interpret the DCI format 2_3 based on [Method 6-1] or [Method 6-2]. For example, the UE may receive a TPC command for SRS through the DCI format 2_3 based on at least one of the [Method 8-1] to [Method 8-7].

In operation 24-15, the UE may identify whether specific conditions are satisfied. The specific conditions may be at least one combination of the following matters.
When the UE is configured with up to two PUSCHs and individual closed loop power control indexes for the SRS,
When the UE is configured with the path loss difference value as the higher layer signaling,
When the UE is configured with the specific higher layer signaling meaning that the UE operates while connected to the above-described UL only TRP, or
When the UE assumes that the information within the DCI format 2_3 may be interpreted through at least one combination of the above-described [Method 5-1] to [Method 5-5].

When the condition of operation 24-15 is satisfied, the UE may perform a first interpretation and application on the information identified through the DCI format 2_3 (24-20). In this case, the first interpretation and application may mean that, when the DCI format 2_3 is configured based on the above-described [Method 5-1] to [Method 5-5], that is, when the TPC command information for up to two closed loop power control indexes is indicated to the UE through the DCI format 2_3, the UE applies each TPC command information indicated for each closed loop power control index to each cell.

When the condition of operation 24-15 is not satisfied, the UE may perform a second interpretation and application on the information identified through the DCI format 2_3 (24-25). In this case, the second interpretation and application may mean that, when the UE has one PUSCH and individual closed loop power control index for the SRS as described in the fourth embodiment, the UE applies the TPC command information indicated to the UE through the DCI format 2_3 to the corresponding one closed loop power control index and each cell.

The UE may determine the transmission power for SRS transmission based on the TPC command in DCI format 2_3. The UE may transmit the SRS to the base station based on the determined transmission power.

The above-described flowchart illustrates a method that may be implemented according to the principles of the disclosure, and various changes may be made to the method illustrated in the flowchart in this specification. For example, although illustrated as a series of steps, various steps in each drawing may overlap, occur in parallel, occur in different orders, or occur multiple times. In other examples, steps may be omitted or replaced with other steps.

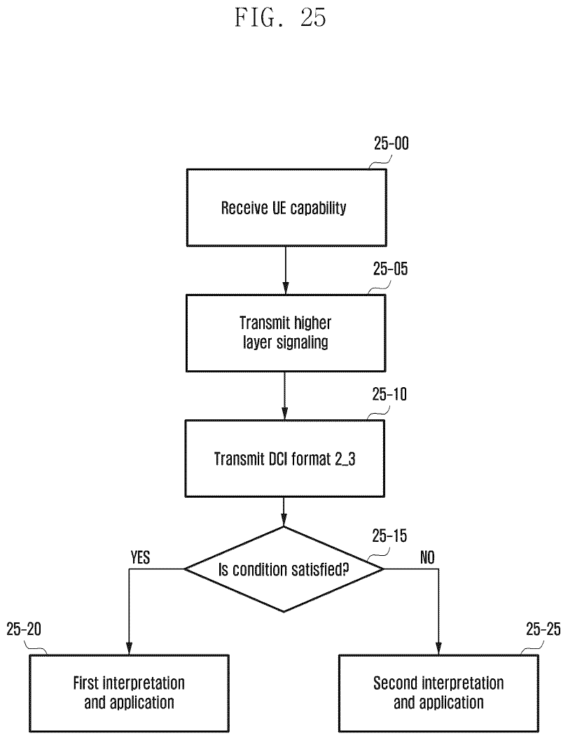

FIG. 25 is a diagram illustrating an operation of the base station for the transmission power control of the SRS, according to an embodiment of the disclosure.

Referring to FIG. 25, in operation 25-00, the base station may receive the UE capabilities from the UE. In this case, the UE capability signaling that may be reported may be at least one combination of the PUSCH, PUCCH, SRS transmission, and transmission power parameter-related UE capabilities, the integrated TCI state operation-related UE capability, the above-described [Method 1-1], [Method 1-2], [Method 2-1] and [Method 2-2], [Method 3-1] to [Method 3-5], the SRS carrier switching-related UE capability, the group common DCI format 2_3 and the TPC command reception-related UE capabilities, UE capabilities corresponding to the above-described [Method 5-1] to [Method 5-5], UE capabilities corresponding to the above-described [Method 6-1] to [Method 6-2], UE capabilities corresponding to the above-described [Method 7-1] to [Method 7-3], and UE capabilities corresponding to the above-described [Method 8-1] to [Method 8-7]. The operation 25-00 can also be omitted.

In operation 25-05, the base station may transmit the higher layer signaling (e.g., RRC signaling) to the UE according to the UE capabilities reported by the UE. In this case, the base station may define higher layer parameters for at least one combination of the PUSCH, PUCCH, SRS transmission, and transmission power parameter-related higher layer signaling, the integrated TCI state operation-related higher layer signaling, the above-described [Method 1-1], [Method 1-2], [Method 2-1] and [Method 2-2], [Method 3-1] to [Method 3-5] support-related higher layer signaling, the SRS carrier switching support-related higher layer signaling, the group common DCI format 2_3 and TPC command reception support-related higher layer signaling, the above-described [Method 5-1] to [Method 5-5] support-related higher layer signaling, and transmit one of the defined higher layer parameters to the UE. For example, the base station may transmit higher layer signaling of [Method 6-1] to [Method 6-2] to the UE. For example, the base station may transmit higher layer signaling of [Method 7-1] to [Method 7-3] to the UE. For example, the base station may transmit higher layer signaling of [Method 8-1] to [Method 8-7] to the UE.

In operation 25-10, the base station may transmit a DCI format to the UE. For example, the DCI format may be the DCI format 2_3. The DCI format 2_3 may include one or more blocks. For example, the DCI format 2_3 may be interpreted based on [Method 6-1] or [Method 6-2]. For example, the base station may transmit a TPC command for SRS through the DCI format 2_3 based on at least one of the [Method 8-1] to [Method 8-7].

In operation 25-15, the base station may assume whether the UE satisfies the specific conditions. The corresponding specific conditions may be at least one combination of the following matters.
When the UE is configured with up to two PUSCHs and individual closed loop power control indexes for the SRS,
When the UE is configured with the path loss difference value as the higher layer signaling,
When the UE is configured with the specific higher layer signaling meaning that the UE operates while connected to the above-described UL only TRP, or
When the UE assumes that the information within the DCI format 2_3 may be interpreted through at least one combination of the above-described [Method 5-1] to [Method 5-5].

When the condition of operation 25-15 is satisfied, the base station may assume that the UE performs the first interpretation and application on the information identified through the DCI format 2_3 (25-20). In this case, the first interpretation and application may mean that, when the DCI format 2_3 is configured based on the above-described [Method 5-1] to [Method 5-5], that is, when the TPC command information for up to two closed loop power control indexes is indicated to the UE through the DCI format 2_3, the UE applies each TPC command information indicated for each closed loop power control index to each cell.

When the condition of operation 25-15 is not satisfied, the base station may assume that the UE performs the second interpretation and application on the information identified through the DCI format 2_3 (25-25). In this case, the second interpretation and application may mean that, when the UE has one PUSCH and individual closed loop power control index for the SRS as described in the fourth embodiment, the UE applies the TPC command information indicated to the UE through the DCI format 2_3 to the corresponding one closed loop power control index and each cell.

The base station may receive SRS from the UE based on the transmission power. The transmission power for the SRS may be determined based on the TPC command in DCI format 2_3.

The above-described flowchart illustrates a method that may be implemented according to the principles of the disclosure, and various changes may be made to the method illustrated in the flowchart in this specification. For example, although illustrated as a series of steps, various steps in each drawing may overlap, occur in parallel, occur in different orders, or occur multiple times. In other examples, steps may be omitted or replaced with other steps.

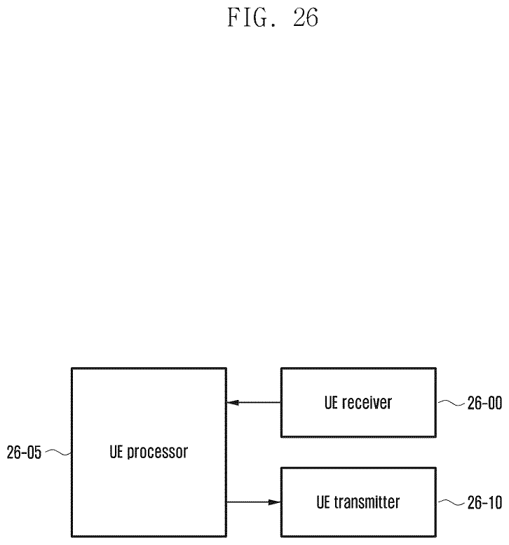

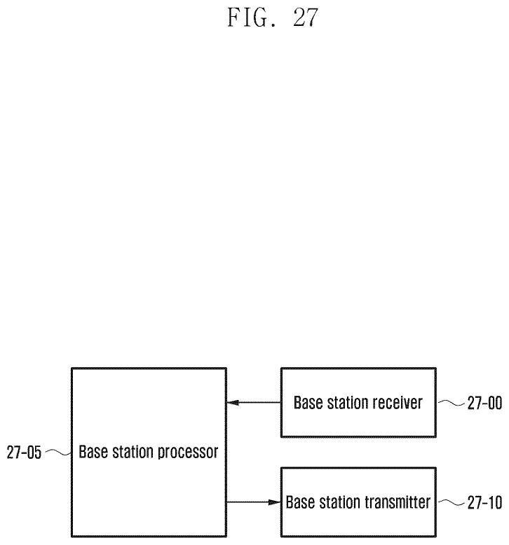

The embodiments and/or methods of the disclosure described above can be performed by the UE of FIG. 26 and the base station of FIG. 27.

FIG. 26 illustrates a structure of a UE in a wireless communication system according to an embodiment of the disclosure.

Referring to FIG. 26, the UE may include a transceiver including a UE receiver 26-00 and a UE transmitter 26-10, memory (not shown), and a UE processor 26-05 (or a UE controller or a processor). The transceiver 26-00 and 26-10 of the UE, the memory, and the UE processor 26-05 may operate according to the above-described communication method of the UE. However, the elements of the UE are not limited to the above example. For example, the UE may include more or fewer elements than the above elements. Also, the transceiver 26-10, the memory, and the processor may 26-05 be implemented in the form of a single chip.

The transceiver 26-10 may transmit and receive a signal to and from the BS. The signal may include control information and data. To this end, the transceiver 26-10 may include an RF transmitter for up-converting and amplifying a frequency of the transmitted signal and an RF receiver for low-noise amplifying the received signal and down-converting the frequency. However, this is only an example of the transceiver 26-10, and elements of the transceiver are not limited to the RF transmitter and the RF receiver.

The transceiver 26-10 may receive a signal through a radio channel, output the signal to the processor, and transmit the signal output from the processor through the radio channel.

The memory may store a program and data required for the operation of the UE. Further, the memory may store control information or data included in the signal transmitted and received by the UE. The memory may be configured by storage media such as ROM, RAM, hard disc, CD-ROM, and DVD, or a combination of the storage media. The number of memories may be plural.

The processor 26-05 may control a series of processes to allow the UE to operate according to the above embodiment. For example, the processor 26-05 may control elements of the UE to receive DCI including two layers and simultaneously receive a plurality of PDSCHs. For example, the processor may be configured to receive information indicating a start bit position of a block within the DCI for group transmission of TPC commands for an SRS, receive the DCI, identify a TPC command within the block corresponding to the start bit position, determine transmit power for the SRS based on the identified TPC command, and transmit the SRS based on the determined transmit power. The number of processors 26-05 may be plural, and the processor 26-05 may perform an operation of controlling the elements of the UE by executing the program stored in the memory.

FIG. 27 illustrates a structure of a BS in a wireless communication system according to an embodiment of the disclosure.

Referring to FIG. 27, the BS may include a transceiver including a BS receiver 27-00 and a BS transmitter 27-10, memory (not shown), and a BS processor 27-05 (or a BS controller or a processor). The transceiver 27-00 and 27-10 of the BS, the memory, and the BS processor 27-05 may operate according to the communication method of the BS. However, the elements of the BS are not limited to the above example. For example, the BS may include more or fewer elements than the above-described elements. Also, the transceiver 27-10, the memory, and the processor 27-05 may be implemented in the form of a single chip.

The transceiver 27-10 may transmit and receive a signal to/from the UE. The signal may include control information and data. To this end, the transceiver 27-10 may include an RF transmitter for up-converting and amplifying a frequency of the transmitted signal and an RF receiver for low-noise amplifying the received signal and down-converting the frequency. However, this is only an example of the transceiver 27-10, and elements of the transceiver are not limited to the RF transmitter and the RF receiver.

The transceiver 27-10 may receive a signal through a radio channel, output the signal to the processor 27-05, and transmit the signal output from the processor through the radio channel.

The memory may store a program and data required for the operation of the BS. The memory may store control information or data included in a signal transmitted and received by the BS. The memory may be configured by storage media such as ROM, RAM, hard disc, CD-ROM, and DVD, or a combination of the storage media. The number of memories may be plural.

The processor 27-05 may control a series of processes to allow the BS to operate according to the embodiment of the disclosure. For example, the processor 27-05 may configure DCI of two layers including allocation information of a plurality of PDSCHs and control each element of the BS to transmit the DCI. For example, the processor may be configured to transmit to the UE information indicating the start bit position of a block within the DCI for group transmission of TPC commands for an SRS, transmit the DCI, and receive an SRS from the UE. The number of processors 27-05 may be plural, and the processor 27-05 may perform an operation of controlling the elements of the BS by executing the program stored in the memory.

The methods according to various embodiments described in the claims or the specification of the disclosure may be implemented by hardware, software, or a combination of hardware and software.

When the methods are implemented by software, a non-transitory computer-readable storage medium for storing one or more programs (software modules) may be provided. The one or more programs stored in the non-transitory computer-readable storage medium may be configured for execution by one or more processors individually or collectively within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings have been presented to easily explain the technical contents of the disclosure and help understanding of the disclosure, and are not intended to limit the scope of the disclosure. That is, it will be apparent to those skilled in the art that other modifications and changes may be made thereto on the basis of the technical idea of the disclosure. Further, the above respective embodiments may be employed in combination, as necessary. For example, one embodiment of the disclosure may be partially combined with other embodiments to operate a base station and a terminal. As an example, embodiment 1 and 2 of the disclosure may be combined with each other to operate a base station and a terminal. Further, although the above embodiments have been described on the basis of the FDD LTE system, other variants based on the technical idea of the embodiments may also be implemented in other communication systems such as TDD LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Further, in methods of the disclosure, some or all of the contents of each embodiment may be combined without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, first information indicating a starting bit position of a block within downlink control information (DCI) for a transmission of a group of transmit power control (TPC) commands for a sounding reference signal (SRS), the first information indicating one of integers from 1 to 45;
receiving, from the base station, the DCI;
identifying a TPC command in the block corresponding to the starting bit position;
determining a transmission power for the SRS based on the identified TPC command; and
transmitting, to the base station, the SRS based on the transmission power.

2. The method of claim 1, further comprising:
transmitting, to the base station, capability information including second information indicating whether the terminal supports to be configured to the first information with up to 45.

3. The method of claim 1, further comprising:
receiving, from the base station, third information via radio resource control (RRC) signaling; and
in case that separate power control adjustment states between SRS transmissions and physical uplink shared channel (PUSCH) transmissions are configured, identifying that two closed loop power control indexes are configured for the SRS based on the third information.

4. The method of claim 3, further comprising:
receiving, from the base station, fourth information on a transmission configuration indicator (TCI) state,
wherein the fourth information includes fifth information indicating one of the two closed loop power control indexes.

5. The method of claim 1,
wherein the DCI includes one or more blocks, and each of one or more blocks in the DCI includes a closed loop indicator field, and
wherein in case that the closed loop indicator field includes 1 bit, the closed loop indicator field indicates one of an index associated with a SRS power control adjustment state for the transmission power.

6. A method performed by a base station in a wireless communication system, the method comprising:
transmitting, to a terminal, first information indicating a starting bit position of a block within downlink control information (DCI) for a transmission of a group of transmit power control (TPC) commands for a sounding reference signal (SRS), the first information indicating one of integers from 1 to 45;
transmitting, to the terminal, the DCI; and
receiving, from the terminal, the SRS based on a transmission power,
wherein the transmission power for the SRS is based on a TPC command in the block corresponding to the starting bit position.

7. The method of claim 6, further comprising:
receiving, from the terminal, capability information including second information indicating whether the terminal supports to be configured to the first information with up to 45.

8. The method of claim 6, further comprising:
transmitting, to the terminal, third information via radio resource control (RRC) signaling,
wherein, in case that separate power control adjustment states between SRS transmissions and physical uplink shared channel (PUSCH) transmissions are configured, the third information indicates that two closed loop power control indexes are configured for the SRS.

9. The method of claim 8, further comprising:
transmitting, to the terminal, fourth information on a transmission configuration indicator (TCI) state,
wherein the fourth information includes fifth information indicating one of the two closed loop power control indexes.

10. The method of claim 6,
wherein the DCI includes one or more blocks, and each of one or more blocks in the DCI includes a closed loop indicator field, and
wherein in case that the closed loop indicator field includes 1 bit, the closed loop indicator field indicates one of an index associated with a SRS power control adjustment state for the transmission power.

11. A terminal in a wireless communication system, the terminal comprising:
a transceiver; and
a controller operably connected to the transceiver and configured to:
receive, from a base station, first information indicating a starting bit position of a block within downlink control information (DCI) for a transmission of a group of transmit power control (TPC) commands for a sounding reference signal (SRS), the first information indicating one of integers from 1 to 45,
receive, from the base station, the DCI,
identify a TPC command in the block corresponding to the starting bit position,
determine a transmission power for the SRS based on the identified TPC command, and
transmit, to the base station, the SRS based on the transmission power.

12. The terminal of claim 11, wherein the controller is further configured to:
transmit, to the base station, capability information including second information indicating whether the terminal supports to be configured to the first information with up to 45.

13. The terminal of claim 11, wherein the controller is further configured to:
receive, from the base station, third information via radio resource control (RRC) signaling, and
in case that separate power control adjustment states between SRS transmissions and physical uplink shared channel (PUSCH) transmissions are configured, identify that two closed loop power control indexes are configured for the SRS based on the third information.

14. The terminal of claim 13,
wherein the controller is further configured to:
receive, from the base station, fourth information on a transmission configuration indicator (TCI) state, and
wherein the fourth information includes fifth information indicating one of the two closed loop power control indexes.

15. The terminal of claim 11,
wherein the DCI includes one or more blocks, and each of one or more blocks in the DCI includes a closed loop indicator field, and
wherein in case that the closed loop indicator field includes 1 bit, the closed loop indicator field indicates one of an index associated with a SRS power control adjustment state for the transmission power.

16. A base station in a wireless communication system, the base station comprising:
a transceiver; and
a controller operably connected to the transceiver and configured to:
transmit, to a terminal, first information indicating a starting bit position of a block within downlink control information (DCI) for a transmission of a group of transmit power control (TPC) commands for a sounding reference signal (SRS), the first information indicating one of integers from 1 to 45,
transmit, to the terminal, the DCI, and
receive, from the terminal, the SRS based on a transmission power,
wherein the transmission power for the SRS is based on a TPC command in the block corresponding to the starting bit position.

17. The base station of claim 16, wherein the controller is further configured to:
receive, from the terminal, capability information including second information indicating whether the terminal supports to be configured to the first information with up to 45.

18. The base station of claim 16, wherein the controller is further configured to:
transmit, to the terminal, third information via radio resource control (RRC) signaling,
wherein, in case that separate power control adjustment states between SRS transmissions and physical uplink shared channel (PUSCH) transmissions are configured, the third information indicates that two closed loop power control indexes are configured for the SRS.

19. The base station of claim 18,
wherein the controller is further configured to:
transmit, to the terminal, fourth information on a transmission configuration indicator (TCI) state, and
wherein the fourth information includes fifth information indicating one of the two closed loop power control indexes.

20. The base station of claim 16,
wherein the DCI includes one or more blocks, and each of one or more blocks in the DCI includes a closed loop indicator field, and
wherein in case that the closed loop indicator field includes 1 bit, the closed loop indicator field indicates one of an index associated with a SRS power control adjustment state for the transmission power.
